(19) United States
(12) Patent Application Publication
(10) Pub. No.: US 2025/0205683 A1
(43) Pub. Date: Jun. 26, 2025

(54) LIFETIME IMPROVEMENT OF FUNCTIONALIZED MATERIALS

(71) Applicant: X Development LLC, Mountain View, CA (US)

(72) Inventors: Chaokun Gong, Sunnyvale, CA (US); Jeremy Aaron Willman, Redwood City, CA (US)

(21) Appl. No.: 19/000,613

(22) Filed: Dec. 23, 2024

Related U.S. Application Data
(60) Provisional application No. 63/614,837, filed on Dec. 26, 2023.

(51) Int. Cl. B01J 20/32; B01D 53/04; B01J 20/28; B01J 20/30

(52) U.S. Cl. CPC B01J 20/3219; B01D 53/0454; B01J 20/28004; B01J 20/28076; B01J 20/28083; B01J 20/3078; B01J 20/3272; B01D 2253/202; B01D 2253/308; B01D 2253/311; B01D 2257/504

(57) ABSTRACT

Functionalized materials that act as sorbent, as well as methods of making such materials and systems of using such materials, are provided. The disclosed processes, methods, and materials can be used for the separation of CO₂ from fluid streams. In one aspect, the disclosed materials are synthesized by forming coated particles through the introduction of porous particles, such as silica, to a first reagent comprising a polymer. Then the functionalized material is formed as functionalized coated particles by the introduction of a second reagent comprising at least one adsorbing moiety to the surfaces of the coated particles. Formation of the functionalized material is in the presence of a chelating agent, antioxidant, and/or crosslinker. In some instances, formation of the functionalized material is further in the presence of a third reagent comprising an interaction moiety that is incorporated into the functionalized coated particles.

### CROSS REFERENCE TO RELATED PATENT APPLICATIONS

This application claims priority to U.S. Provisional Patent Application No. 63/614,837, entitled “LIFETIME IMPROVEMENT OF FUNCTIONALIZED MATERIALS,” filed Dec. 26, 2023, which is hereby incorporated by reference.

### FIELD OF THE DISCLOSURE

The disclosure relates to a functionalized material, which may optionally be employed as a sorbent, as well as methods of making such materials and systems of using such materials. The processes, methods, and systems herein can be used for the separation of carbon dioxide from fluid streams.

### BACKGROUND

Atmospheric carbon concentrations have risen in correlation with industrialized activity for decades. Carbon dioxide is a primary contributor to the total carbon concentration. Concern over global climate warming has led to interest in capturing carbon dioxide emissions.

### SUMMARY

In general, the disclosure relates to functionalized materials, methods of making and using thereof, and systems that can be configured to use such materials. In particular embodiments, the functionalized material is used to capture and remove carbon dioxide from gaseous environments. In some embodiments, the functionalized material exhibits lifetime improvement. In some embodiments, the functionalized material includes an oxygen barrier, an antioxidant, a chelating agent, or a combination of any of these.

In general, an aspect disclosed herein is a method that comprises introducing a plurality of porous particles to an optional chelating agent and a first reagent including a polymer, thereby providing a plurality of coated particles, introducing an optional antioxidant, an optional crosslinker, a second reagent including at least one adsorbing moiety (e.g., a polyamine), and an optional third reagent including at least one interaction moiety (e.g., an aminosilane or a silane) to at least a portion of a surface of at least one of the plurality of coated particles, thereby providing a plurality of functionalized coated particles, where at least one of the optional chelating agent, the optional antioxidant, and the optional crosslinker is present.

For instance, in some embodiments of the present disclosure a plurality of coated particles is formed by A) introducing a plurality of porous particles to a first reagent comprising a polymer. Then the plurality of functionalized coated particles is formed by B) introducing a second reagent comprising at least one adsorbing moiety to at least a portion of a surface of each coated particle in at least a subset of the plurality of coated particles, where the introducing A) is in the presence of a chelating agent, the introducing B) is in the presence of an antioxidant that is incorporated into the plurality of functionalized coated particles, or the introducing B) is in the presence of a crosslinker that is incorporated into the plurality of functionalized coated particles. In some such embodiments the introducing B) is in the presence of a third reagent comprising at least one interaction moiety that is incorporated into the plurality of functionalized coated particles.

Alternatively, in some embodiments of the present disclosure a plurality of functionalized particles is formed by A) introducing a plurality of porous particles to a second reagent comprising at least one adsorbing moiety to at least a portion of a surface of each porous particle in at least a subset of the plurality of coated particles. Then, a plurality of functionalized coated particles is formed by introducing B) a first reagent comprising a polymer to at least a portion of a surface of each functionalized particle in at least a subset of the plurality of functionalized particles, where the introducing B) is in the presence of a chelating agent, the introducing A) is in the presence of an antioxidant that is incorporated into the plurality of functionalized particles, or the introducing A) is in the presence of a crosslinker that is incorporated into the plurality of functionalized particles. In some embodiments, introducing A) is in the presence of a third reagent comprising at least one interaction moiety that is incorporated into the plurality of functionalized particles.

Examples include one or more of the following features. In some embodiments the chelating agent is introduced at a ratio in a range of up to 5% (wt/wt) of the chelating agent to the plurality of porous particles. In some embodiments the antioxidant is introduced at a ratio in a range of up to 5% (wt/wt) of the antioxidant to the plurality of porous particles. In some embodiments the antioxidant is a cyclic antioxidant. In some embodiments the antioxidant is a hindered amine light stabilizer. In some embodiments the antioxidant is an organic sulfur-containing such as 2,2-thiodiethanol, 2-hydroxyethyl disulfide, 3,3′-dithiodipropionic acid, or mixtures thereof. In some embodiments the method further includes, before introducing the second reagent and the third reagent, drying the plurality of coated particles in a vacuum oven at 80° C. until a hydration threshold of less than 5% (wt/wt) of water to the plurality of coated particles is reached. In some embodiments the method includes, before introducing the first reagent, introducing the porous particles to an acidic sixth reagent. In some embodiments the method includes, before introducing the first reagent, raising the temperature of the plurality of porous particles to at least 300° C. for at least one hour. In some embodiments, the first reagent includes poly(vinyl alcohol). In some embodiments, the plurality of porous particles comprises a solvent at a ratio in a range between 1.5 wt/wt and 4:1 wt/wt of the solvent to the plurality of porous particles. In some embodiments the plurality of porous particles comprises a solvent at a ratio in a range of up to 20% (wt/wt) of the first reagent to the plurality of porous particles. In some embodiments, the reagent comprises a first solvent at a ratio in a range from 10% to 15% (wt/wt) of the first reagent to the plurality of porous particles. In some embodiments, the third reagent comprises a second solvent at a ratio from about 20% to 80% (wt/wt) of the third reagent to the plurality of porous particles. In some embodiments, the third reagent includes an aminosilane or a silane. In some embodiments, the aminosilane has a structure of and one of formulas I, Ia, Ib, Ic, Id, Ie, If, Ig, If, II, IIa, IIb, IIc, IId, IIIa, IIIb, and IV.

In some embodiments, the aminosilane includes at least one amino moiety and at least one silane moiety. In some embodiments, the at least one silane moiety is an alkoxysilane, a trihalosilane, a dihalosilane, a monohalosilane, a silanetriol, a dialkoxysilanol, a monoalkoxysilanol, or an aminosilane. In some embodiments, the silane has a structure of any one of formulas V and Va.

In some embodiments the second reagent is a polyamine. In some embodiments the second reagent is a linear or a branched polyamine. In some embodiments the polyamine has a structure of any one of formulas VIa, VIb, VIc, VId, VIe, VIf, VIg, VIh, and VIi.

In some embodiments, the second reagent and the third reagent are introduced to the porous particles before the first reagent is introduced. Introducing the second reagent and the third reagent in some such embodiments includes mixing the second reagent and the third reagent in a second solvent to form a mixture and spraying the mixture on at least a portion of the surface of at least a subset of the plurality of coated particles.

Another aspect disclosed herein is a composition that includes a plurality of coated particles modified according to any of the methods disclosed herein. Examples of such compositions include one or more of the following features. In some embodiments the second reagent is configured to adsorb carbon dioxide. In some embodiments, the composition includes a plurality of functionalized coated particles modified according to any aspect disclosed herein. In some embodiments, the composition adsorb CO₂ per dry kilogram in a range from 0.1 mol to 2.5 mol. In some embodiments, the composition desorbs in a temperature range between about 65° C. and about 90° C. In some embodiments, the composition adsorbs CO₂ at a relative humidity in a range between 5% and 95% relative humidity. In some embodiments, the composition has a 50% strain crush strength of at least 1.5 MPa. In some embodiments, the composition further incorporates a hydrophobic compound (component). In some embodiments, the incorporated hydrophobic compound is a hydrophobic silane compound or a hydrophobic polymer. In some embodiments, the incorporated hydrophobic compound is hydrophobic silane compound that includes a silane moiety and one, two, or three alkyl chains. In some embodiments, the incorporated hydrophobic compound is a hydrophobic polymer such as polydimethylsiloxane (PDMS), silicone oil, polyethylene, polytetrafluoroethylene, polyurethane, or mixtures thereof.

Another aspect of the present disclosure provides methods for using any of the composition disclosed herein to remove atmospheric CO₂ from air by direct air capture.

Another aspect of the present disclosure provides functionalized materials that include a plurality of porous particles a coating disposed on at least a portion of a surface of at least one of the plurality of porous particles, thereby forming at least one coated particle, where the coating includes a polymer and a chelating agent, and a surface modification layer disposed on at least a portion of a surface of the at least one porous particle and/or the at least one coated particle, where the surface modification layer includes an antioxidant, an optional crosslinker, and an adsorbing moiety including one or more amine moieties, where the material is configured to adsorb atmospheric CO₂ under a first condition and reversibly desorb adsorbed CO₂ under a second condition.

Another aspect of the present disclosure provides functionalized materials comprising a plurality of functionalized coated particles, where each functionalized coated particle in the plurality of functionalized coated particles comprises a substrate, a coating disposed on at least a portion of a surface of the substrate, where the coating comprises a polymer and a chelating agent and a surface modification layer disposed on the surface of the substrate and/or the coating, where the surface modification layer comprises an antioxidant and an adsorbing moiety comprising one or more amine moieties. In this aspect of the present disclosure the functionalized materials are configured to adsorb atmospheric CO₂ under a first condition and reversibly desorb adsorbed CO₂ under a second condition. Examples of this aspect of the present disclosure include one or more of the following features. In some embodiments, the surface modification layer further comprises a crosslinker. In some embodiments the substrate is a porous particle. In some embodiments, the substrate is made of silica, a metal-organic framework (MOF), or an ion-exchange resin. In some embodiments, the substrate is porous and made of silica or silicate, ceramic, a metal-organic composition, a polymer, a ceramic/metal oxide together with silica, alumina, or a resin. In some embodiments, the substrate is in a precipitated form, a sol-gel form, a fumed form, a calcined form, an agglomerated form, a granulated form, a powder, or a granule. In some embodiments, the plurality of functionalized coated particles have a sieve diameter between about 25 μm and 4 mm. In some embodiments, the plurality of functionalized coated particles include a plurality of pores that have a dimension from about 1 nm to 200 nm, an average pore size from about 30 nm to 80 nm, and/or a volume greater than 0.5 mL/g or from 0.1 mL/g to 5 mL/g. In some embodiments, the plurality of functionalized coated particles have: (i) a distribution of pore sizes from 10 nanometers to 200 nanometers, and (ii) a distribution of sieve diameters from 0.4 millimeters to 4 millimeters. In some embodiments, the plurality of functionalized coated particles have: (i) a distribution of pore sizes from 50 Angstroms to 300 Angstroms, and (ii) a distribution of sieve diameters from 0.4 millimeters to 4 millimeters. In some embodiments, the plurality of functionalized coated particles comprises a plurality of pores. In some embodiments, the plurality of functionalized coated particles include a greatest dimension of at least 25 μm, and the plurality of pores comprises a dimension of at least about 1 nm and a volume greater than about 0.5 mL/g. In some embodiments, the surface modification layer of the plurality of functionalized coated particles collectively comprises 5% (wt/wt) to 60% (wt/wt) of a polyamine; and/or the surface modification layer of the plurality of functionalized coated particles collectively comprises 5% (wt/wt) to 80% (wt/wt) of an aminosilane. In some embodiments, the plurality of functionalized coated particles comprises a total surface area greater than about 100 m² per dry gram. In some embodiments, the functionalized material adsorbs greater than about 0.8 mol of CO₂ per dry kilogram or from about 0.1 mol to 2.5 mol of CO₂ per dry kilogram. In some embodiments, the functionalized material adsorbs CO₂ at a relative humidity in a range from about 5% to 95%. In some embodiments, the surface modification layer comprises: (i) an amine moiety and a silane moiety, (ii) a plurality of amine moieties, or (iii) both (i) and (ii). In some embodiments, the surface modification layer comprises an aminosilane and/or a polyamine. In some embodiments, the surface modification layer comprises an aminosilane having a structure of any one of formulas I, Ia, Ib, Ic, Id, Ie, If, Ig, If, II, IIa, IIb, IIc, IId, IIIa, IIIb, or IV. In some embodiments, the surface modification layer comprises a polyamine having a structure of any one of formulas VIa, VIb, VIc, VId, VIe, VIf, VIg, VIh, or VIi. In some embodiments, the chelating agent comprises a phosphate-based chelator, a metal salt, or a phosphonate-based chelator. In some embodiments, the chelating agent comprises etidronic acid, K₃PO, trisodium 2-[2-(carboxymethylamino)ethyl-(carboxymethyl)amino]acetate (HEDTA), tetrasodium 2,2′,2″,2′″-(ethane-1,2-diyldinitrilo)tetraacetate (EDTA), or trisodium 2-[(carboxymethyl)(methyl)amino]acetate (MGDA), or a combination thereof. In some embodiments, the antioxidant is a cyclic antioxidant, a hindered amine light stabilizer, or an organic sulfur-containing compound. In some embodiments, the first condition comprises a first temperature range and the second condition comprises a second temperature range higher than the first temperature range. In some embodiments, the first condition comprises a first gas pressure and the second condition comprises a second gas pressure lower than the first gas pressure. In some embodiments, the first condition comprises a first CO₂ concentration and the second condition comprises a second CO₂ concentration lower than the first CO₂ concentration. In some embodiments, each functionalized coated particle in the plurality of coated particles further comprises an additive, a hydrophobic silane compound, and/or a hydrophobic polymer bound to the substrate. In some embodiments, the functionalized material comprises: 15% wt/wt poly(vinyl alcohol), 1% wt/wt etidronic acid, 10% wt/wt polyethyleneimine, 45% wt/wt N-2-aminoethyl-3-aminoproplytrimethoxysilane, 1% wt/wt hindered amine light stabilizer, and 1% wt/wt terephthalaldehyde.

In some embodiments, the functionalized material comprises: between 5% wt/wt and 25% wt/wt poly(vinyl alcohol), between 0.3% wt/wt and 2% wt/wt etidronic acid, between 5% wt/wt and 15% wt/wt polyethyleneimine, between 35% wt/wt and 55% wt/wt N-2-aminoethyl-3-aminoproplytrimethoxysilane, between 0.5% wt/wt and 2% wt/wt hindered amine light stabilizer, and between 0.5% wt/wt and 2% wt/wt terephthalaldehyde.

In any embodiment herein, the aminosilane is any described herein (e.g., such as in formulas I, Ia, Ib, Ic, Id, Ie, If, Ig, If, II, IIa, IIb, IIc, IId, IIIa, IIIb, or IV. In some embodiments, the aminosilane is present in an amount of about 5% to 80% (wt/wt) of the aminosilane to the plurality of porous particles (e.g., an amount of 5% to 70%, 5% to 60%, 5% to 50%, 5% to 40%, 5% to 30%, 10% to 80%, 10% to 70%, 10% to 60%, 10% to 50%, 10% to 40%, 10% to 30%, 20% to 80%, 20% to 70%, 20% to 60%, 20% to 50%, 20% to 40%, 20% to 30%, 30% to 80%, 30% to 70%, 30% to 60%, 30% to 50%, 40% to 80%, 40% to 70%, 40% to 60%, 50% to 80%, 50% to 70%, or 50% to 60% (wt/wt)).

In any embodiment herein, the silane is any described herein (e.g., such as in formulas V or Va. In some embodiments, the silane is present in an amount of about 5% to 80% (wt/wt) of the silane to the plurality of porous particles (e.g., an amount of 5% to 70%, 5% to 60%, 5% to 50%, 5% to 40%, 5% to 30%, 10% to 80%, 10% to 70%, 10% to 60%, 10% to 50%, 10% to 40%, 10% to 30%, 20% to 80%, 20% to 70%, 20% to 60%, 20% to 50%, 20% to 40%, 20% to 30%, 30% to 80%, 30% to 70%, 30% to 60%, 30% to 50%, 40% to 80%, 40% to 70%, 40% to 60%, 50% to 80%, 50% to 70%, or 50% to 60% (wt/wt)).

In any embodiment herein, the polyamine is any described herein (e.g., such as in formulas VIa, VIb, VIc, VId, VIe, VIf, VIg, VIh, or VIi). In some embodiments, the polyamine is present in an amount of about 5% to 60% (wt/wt) of the polyamine to the plurality of porous particles (e.g., an amount of 5% to 50%, 5% to 40%, 5% to 30%, 10% to 60%, 10% to 50%, 10% to 40%, 10% to 30%, 20% to 60%, 20% to 50%, 20% to 40%, 20% to 30%, 30% to 60%, 30% to 50%, 40% to 60%, or 50% to 60% (wt/wt)).

In any embodiment herein, the monoamine is any described herein (e.g., any compound or moiety having one amine group, such as —NR^{N1}R^{N2}, in which R^{N1} and R^{N2} is any described herein, and/or in which the amine group is attached to a linker (e.g., any described herein)). In some embodiments, the monoamine is present in an amount of about 5% to 60% (wt/wt) of the monoamine to the plurality of porous particles (e.g., an amount of 5% to 50%, 5% to 40%, 5% to 30%, 10% to 60%, 10% to 50%, 10% to 40%, 10% to 30%, 20% to 60%, 20% to 50%, 20% to 40%, 20% to 30%, 30% to 60%, 30% to 50%, 40% to 60%, or 50% to 60% (wt/wt)).

Particular implementations of the subject matter described in this specification can be implemented so as to realize one or more of the following technical advantages.

One method of making the compositions of the present disclosure is using a water-based, single-pot reaction at ambient pressures and temperatures in short time scales reducing the cost of production, reducing reliance on industrial solvents, and reducing the environmental impact of the product. In some embodiments, the compositions of the present disclosure exhibit an enhanced lifetime, as compared to an un-coated sorbents.

In some embodiments, the enhanced lifetime sorbent adsorbs CO₂ at concentrations similar to non-enhanced sorbents, enabling efficient capture at levels present in atmospheric conditions using stronger, longer-lasting products.

CO₂ is desorbed from the enhanced lifetime sorbent at laboratory temperatures, which reduces the energy required to remove captured CO₂, increases the applicability of the regenerated silica to more industries and environments, and increases the speed at which the CO₂ is desorbed.

The enhanced lifetime sorbent achieves high adsorption/desorption counts, which reduces operational costs in carbon capture systems.

The enhanced lifetime sorbent is produced using industrially available components, reducing the cost of and increasing the scalability of production.

In some embodiments, one or more chelating agents present in the compositions of the present disclosure bind to metal particles reducing the oxidation of amine groups present in the compositions of the present disclosure, thus increasing the useful lifespan of the compositions of the present disclosure.

In some embodiments, inclusion of one or more antioxidants increase the useful lifetime of the compositions of the present disclosure by reducing the oxidation of amine groups, thus increasing the useful lifespan of the sorbent.

The details of one or more embodiments are set forth in the accompanying drawings and the description below. Other features and advantages will be apparent from the description and drawings, and from the claims.

As used herein, the terms “top,” “bottom,” “upper,” “lower,” “above,” and “below” are used to provide a relative relationship between structures. The use of these terms does not indicate or require that a particular structure must be located at a particular location in the apparatus.

### DESCRIPTION OF DRAWINGS

FIGS. 1A-1C are non-limiting schematic illustrations of a functionalized material. Provided are functionalized materials having (A) a functional group 106A, (B) a functional group 106B, and (C) a functional group 106C, in accordance with some embodiments of the present disclosure.

FIGS. 2A-2K are chemical illustrations of non-limiting, exemplary compounds, amine moieties, and silane moieties. Provided are illustrations of (A) an aminosilane compound 206, (B, C) non-limiting amine moieties, (D-G) non-limiting aminosilane compounds, and (H-K) non-limiting polyamine compounds in accordance with some embodiments of the present disclosure.

FIGS. 2L-M are chemical illustrations of non-limiting, exemplary crosslinkers. Provided are illustrations of (L) a dihaloalkane, or (M) an epoxide compound in accordance with some embodiments of the present disclosure.

FIGS. 3A-3C are non-limiting flow chart diagrams showing the steps of producing enhanced particles, in accordance with some embodiments of the present disclosure.

FIGS. 4A-4B are schematic illustrations of (A) an example dip-coating method using a double cone mixing and drying system and (B) an example drying method using a double cone mixing and drying system in accordance with some embodiments of the present disclosure.

FIG. 5 is a schematic illustration of an example Nutsche filter mixing/filtration/drying system for producing functionalized particles from particles in accordance with some embodiments of the present disclosure.

FIG. 6 is a schematic illustration of an example bag dip-coating system for producing functionalized particles from particles in accordance with some embodiments of the present disclosure.

FIG. 7 is a schematic illustration of an example paddle dryer for producing functionalized particles from particles in accordance with some embodiments of the present disclosure.

FIG. 8 is a schematic illustration of an example ribbon dryer for producing functionalized particles from particles in accordance with some embodiments of the present disclosure.

FIGS. 9A-9B are schematic illustrations of (A) an example drying method using a conveyor dryer and (B) operation of an example drying method in continuous mode in accordance with some embodiments of the present disclosure.

FIGS. 10A-10B are schematic illustrations of (A) an exploded view and an assembled view of a non-limiting sample holder for testing sample CO₂ adsorption and (B) a non-limiting experimental setup for testing sample adsorption of CO₂ in accordance with some embodiments of the present disclosure.

FIGS. 11A-11B are schematic illustrations of non-limiting, exemplary implementations of a carbon dioxide extraction system in accordance with some embodiments of the present disclosure.

FIG. 12 is a schematic illustration of a non-limiting, exemplary implementation of an integrated power and carbon dioxide extraction system in accordance with some embodiments of the present disclosure.

FIGS. 13A and 13B illustrates exemplary aminosilanes, in accordance with some embodiments of the present disclosure.

FIG. 14 is a line chart depicting CO₂ uptake over a plurality of cycles by a non-limiting functionalized material including a silica substrate, in accordance with some embodiments of the present disclosure. Provided are the testing cycle number (x-axis) and uptake at each cycle (y-axis).

FIG. 15 is a schematic illustration of a compression strength test fixture for testing particle samples, in accordance with some embodiments of the present disclosure.

FIGS. 16A and 16B are schematic illustrations of an attrition and abrasion test fixture for testing particle samples, in accordance with some embodiments of the present disclosure.

FIG. 17 illustrates the cyclic testing results of various sorbents in accordance with some embodiments of the present disclosure.

In the figures, like references indicate like elements.

### DETAILED DESCRIPTION

Amorphous silica is used as a porous structure for functionalization to achieve carbon capture. Silica substrates with amine functionalization, e.g., one or more amine-containing groups covalently bonded on surfaces, achieve reversible capture of carbon dioxide from gaseous mixtures (e.g., the atmosphere). Other porous substrates are employed (e.g., MOFs, resins, or any described herein) to provide a functionalized material (e.g., a functionalized porous material) that has been functionalized with an adsorbing moiety (e.g., an amine moiety provided by a compound, such as an amine, an aminosilane, a polyamine, a monoamine, or a combination thereof) in some embodiments. In certain embodiments, the functionalized material is used as a sorbent.

Described herein is a functionalized material (e.g., a functionalized porous material) that has been functionalized with an adsorbing moiety (e.g., an amine moiety provided by a compound, such as an amine, an aminosilane, a polyamine, a monoamine, or a combination thereof). In some embodiments, functionalization further comprises an interaction moiety (e.g., a silane moiety provided by a compound, such as a silane, an aminosilane, and the like). Such moieties (e.g., amine moieties and/or silane moieties) encompass any single compound and any useful combination of two or more compounds with the appropriate functionality (e.g., one or more of amines, aminosilanes, polyamines, monoamines, or any combination of any of these). To enhance lifetime improvement, the adsorbing moiety and/or the interaction moiety is protected from oxidation by use of an oxygen barrier, an antioxidant, a chelating agent, or a combination of any of these.

Various factors affect the chemical lifetime and/or physical lifetime of sorbents. For example and without limitation, when an amine is employed as the adsorbing moiety, oxidation of such moieties reduced its adsorption capacity. Without wishing to be limited by mechanism, amine oxidation is generally a process in which the amine functional group (e.g., on exposed surfaces and in the pores of a substrate) can degrade due to oxidation with atmospheric oxygen and/or other reactive oxygen species (ROS), thereby forming a variety of non-functional products. Amine oxidation rates are reduced by process controls such as lowering the exposure of the amine-based sorbents to oxygen at elevated temperatures (e.g., >40° C.) and, as described herein, by use of chemical compounds that reduce amine oxidation.

For example and without limitation, amine oxidation is catalyzed by the presence of oxygen or other oxidative species (e.g., ROS, e.g., but not limited to, superoxide, ozone, hydroxyl radicals, hydroperoxyls). Without wishing to be limited by mechanism and theory, it has been discovered that a polymer (e.g., polyvinyl alcohol (PVA)) disposed on a surface of the substrate reduces oxidation of adsorbing species, such as an amine-containing functional group. In some embodiments, the polymer coating serves as an oxygen barrier. In some embodiments, other oxygen barriers are employed such as, but not limited to, ethylene vinyl alcohol, poly(vinylidene dichloride), and polyamides (e.g., nylon-6,6). The oxygen barrier is provided to be in proximity to the porous substrate of the functionalized material. Without wishing to be limited by mechanism or theory, an employed oxygen barrier extends chemical lifetime (e.g., by blocking oxygen or oxidative species from oxidizing adsorbing moieties) and/or extends physical lifetime (e.g., by forming a coating on a surface of the porous substrate, thereby enhancing its structural integrity).

In another non-limiting example, oxygen or other oxidative species is scavenged by using a chemical antioxidant. In some embodiments, either sacrificial antioxidants or cyclic antioxidants such as hindered amine light stabilizers (HALS) are added to the functionalized material to reduce the oxidation of the amines, thereby extending the chemical lifetime of the sorbent. In some embodiments the antioxidant is any useful component of the functionalized particle. For example and without limitation, in some embodiments the antioxidant is provided in proximity to the surface of the substrate, within the coating of a coated substrate (e.g., a coated particle), and/or in proximity to the functional portion (e.g., an adsorbing moiety, such as an amine) of a functionalized material.

In yet another non-limiting example, amine oxidation is catalyzed by transition metals, such as iron, copper, and the like. In one instance, silica substrates are contaminated with metals, e.g., transition metals, e.g., iron or copper, from the sand from which they are derived. In some examples, chelating agents are used to chelate or otherwise interact with metals, thereby reducing its oxidative action and extending the chemical lifetime of the sorbent. The chelating agent is provided in any useful component of the functionalized particle. For example and without limitation, in some embodiments the chelating agent is provided in proximity to the surface of the substrate, within the coating of a coated substrate (e.g., a coated particle), and/or in proximity to the functional portion (e.g., an adsorbing moiety, such as an amine) of a functionalized material.

In some embodiments, any useful combination of an oxygen barrier (e.g., provided by way of a polymer), an antioxidant, or a chelating agent is employed. For example and without limitation, in some embodiments an oxygen barrier is used alone or in combination with an antioxidant and/or a chelating agent. In another example, the antioxidant is used alone or in combination with an oxygen barrier and/or a chelating agent. In yet another example, the chelating agent is used alone or in combination with an oxygen barrier and/or an antioxidant. Furthermore, in some embodiments the oxygen barrier, antioxidant, and chelating agent are present in any useful component of the functionalized material, such as in proximity to the surface of the substrate and/or in proximity to the functional portion (e.g., including an adsorbing moiety of the functional portion).

### I. Functionalized Material

The present disclosure relates to a functionalized material having one or more functional groups. For example and without limitation, in some embodiments an initial material or substrate is functionalized to include one or more functional groups (e.g., one or more amine groups) configured to capture carbon dioxide (CO₂). In some non-limiting embodiments, the material has any useful structure (e.g., as a particle), any useful substructure (e.g., one or more pores), and any useful composition (e.g., silica or others described herein). In some non-limiting embodiments, amorphous silica is used as a porous substrate for functionalization to achieve carbon capture. Silica substrates with amine functionalization, e.g., one or more amine-containing moieties covalently bonded on a surface, achieve reversible capture of carbon dioxide from gaseous mixtures (e.g., the atmosphere). Other substrates and moieties are also described herein, which provide functionalized material for carbon capture.

Disclosed herein is a functionalized material (e.g., functionalized porous silica) having a protective polymer coating (e.g., as an oxygen barrier) and a method of producing such protected materials. In turn, the functionalized material is used for reversibly capturing (e.g., adsorbing) carbon dioxide (CO₂). In use, the functionalized material is provided in any useful format (e.g., as a layer of beads or powder) over or through which gaseous mixtures including CO₂ are flowed. Gas exiting the layer of functionalized material has a lower concentration of CO₂ than the entering gas. During carbon capture adsorption and desorption processes, the functionalized material experiences mechanical attrition through handling, use, and transport through the capture and regeneration processes. In some embodiments, providing a protective polymer coating on the functionalized material decreases friability and attrition of the sorbents, leading to longer product life and reduced production of fines. Furthermore, in some embodiments the protective polymer coating also serves as an oxygen barrier and the functionalized material has an extended chemical lifetime due to reduced oxidation by oxygen or other oxidative species.

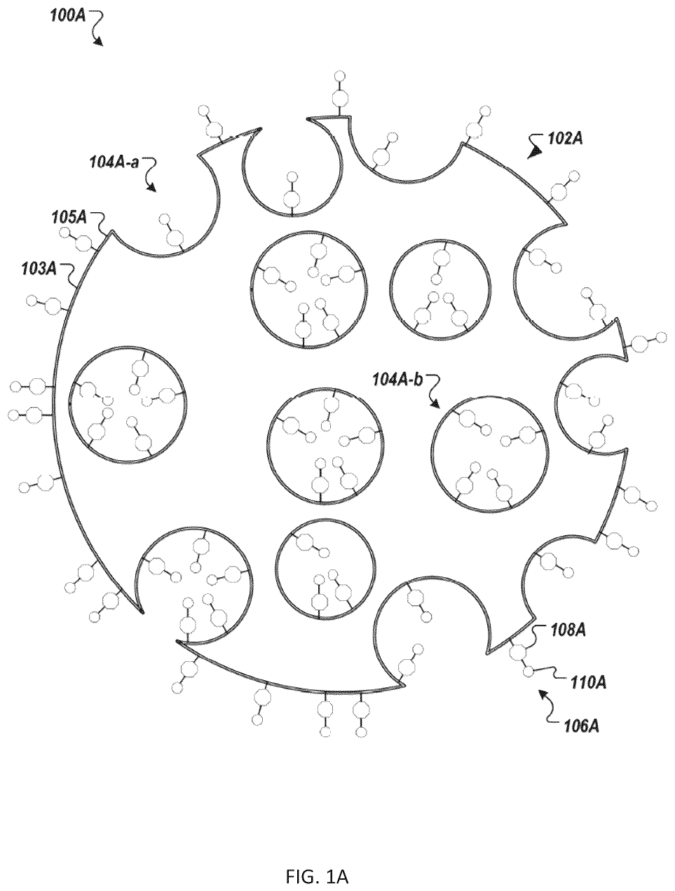

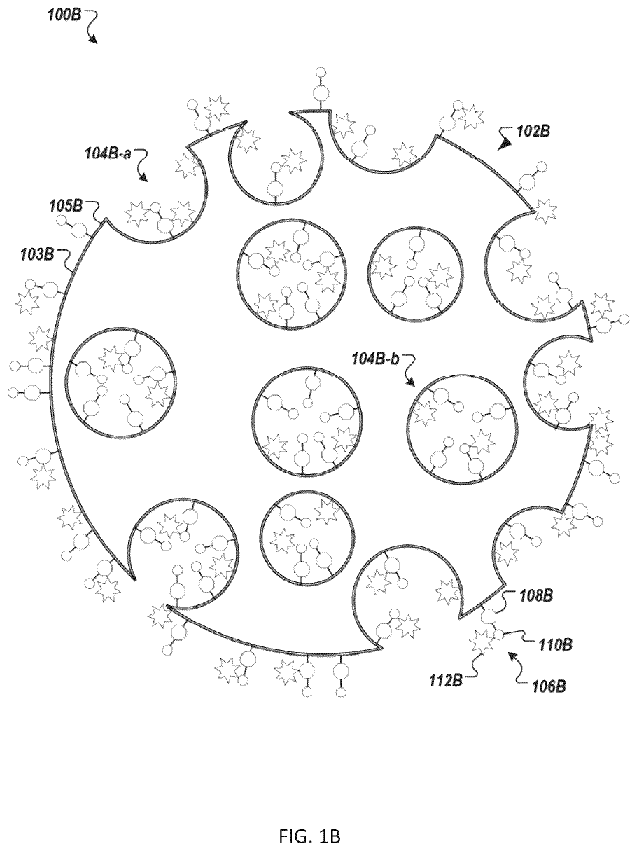

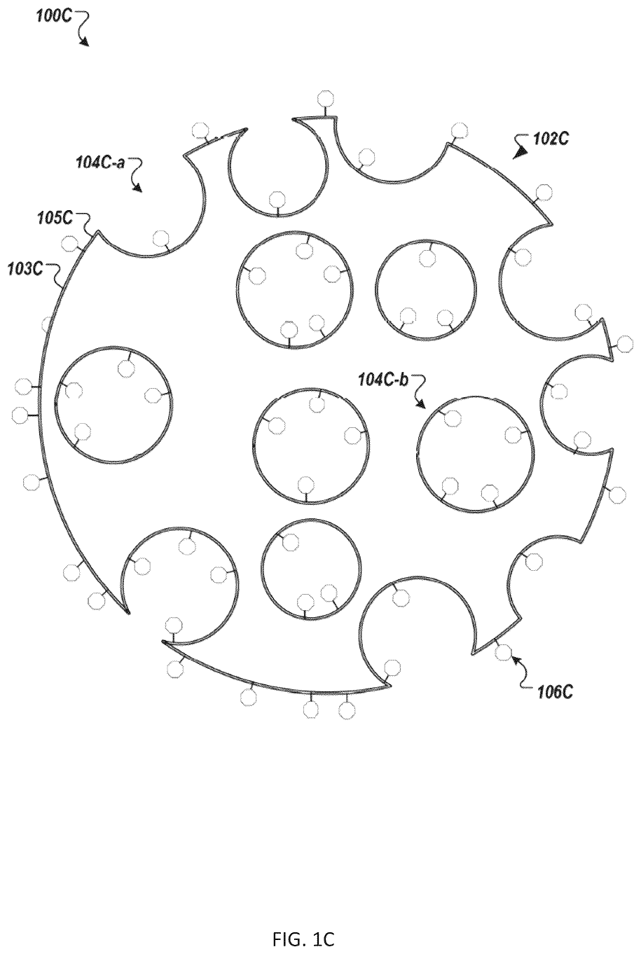

For example, FIG. 1A provides a non-limiting functionalized material 100A including a substrate 102A having a plurality of pores 104A-a, 104A-b. In turn, surface 103A of the substrate 102A includes a functional portion 106A that in turn includes, in some embodiments, an adsorbing moiety 110A (e.g., a CO₂ adsorbing moiety) and an interaction moiety 108A (e.g., a silane-containing interaction moiety). In some embodiments, the functional portion 106A further includes other moieties, groups, or molecules to provide an adsorbing material for use as a sorbent. In some embodiments, such moieties, groups, or molecules include an amine group (e.g., —NR^{N1}R^{N2}, as described herein, which present in the form of amines, aminosilanes, polyamines, and the like), polymers (e.g., hydrophobic polymers or polyamines), antioxidants, and the like. Furthermore, in some embodiments, such moieties, groups, or molecules form interactions (e.g., covalent and/or non-covalent interactions) between themselves or between itself and the substrate surface.

In some embodiments a surface modification layer is disposed on at least a portion of the surface 103A. The surface modification layer includes an adsorbing moiety having one or more amine moieties (e.g., any described herein). As illustrated in FIG. 1A, in some embodiments, the surface modification layer includes any useful combination of an adsorbing moiety 110A (e.g., a CO₂ adsorbing moiety) and an interaction moiety 108A. In some embodiments, the material is configured to adsorb atmospheric CO₂ under a first condition and reversibly desorb adsorbed CO₂ under a second condition. In some embodiments, the surface modification layer is disposed in proximity to the surface 103A of the substrate 102A and/or a polymer coating 105A on the surface of the substrate.

In some embodiments, a polymer coating 105A is disposed on the surface 103A. In some embodiments, the polymer, or mixture of polymers, of the polymer coating 105A increases the mechanical characteristics of the functionalized material 100A. One example of a polymer that makes up the polymer coating in some embodiments is polyvinyl alcohol (PVA), a water-soluble synthetic polymer having the formula [CH₂CH(OH)]n, where n is a positive integer. PVA is readily available from commercial sources and has low toxicity for safe handling during application. In some embodiments the PVA has a molecular weight (MW) in a range between 10,000 Daltons and 200,000 Daltons (e.g., in a range between 10,000 Daltons and 23,000 Daltons).

In general, the polymer coating 105A is illustratively depicted as a continuous layer on the surface 103A, though in practice there may exist one or more gaps, e.g., holes, in the polymer coating 105A that can facilitate the amines, antioxidants, or crosslinkers interacting with the surface 103A. Although the polymer coating 105A is a discontinuous layer in some embodiments, the coating 105A is effective at blocking oxygen by reducing the area of the surface 103A exposed to oxygen.

In various embodiments, PVA extends the lifetime of the functionalized material in various different ways. For example, in some embodiments the PVA provides an oxygen barrier, a chelator, and/or a sacrificial antioxidant. The sorbent is basic and OH groups of the PVA will be converted into alkoxides that can chelate iron present in the sorbent. In some embodiments the OH groups of the PVA are oxidized into ketones or the alpha positions adjacent the OH groups are oxidized, serving as a sacrificial antioxidant.

Additional nonlimiting examples of polymers that can be used for the polymer coating 105A in some embodiments include Pebax, Polyether block amide (PEBA), polysulfones, polyethersulfones, polyethers, polyamides, ethylcellulose, polyethylene glycol (PEG), cellulose acetate, polyurethanes, polystyrenes, polyesters, polyolefins, polyacrylamides, polyacrylates, and combinations, copolymers, and/or block copolymers of those listed herein.

In some embodiments the polymer is provided in a coating liquid that, in turn, includes the polymer and a solvent medium (e.g., any described herein). In general, the amount of polymer depends on the type of polymer, the molecular weight of the polymer, the number of amino moieties in the polymer, etc. In some embodiments, the amount of polymer is up to 20% (wt/wt) to the substrate (e.g., silica particles), such as, e.g., up to 15% (wt/wt), up to 10% (wt/wt), up to 8% (wt/wt), less than 12% (wt/wt), or less than 9% (wt/wt). In some embodiments, the amount of polymer(s) is from about 1% to 20% (wt/wt) to the substrate (e.g., from about 1% to 5%, 1% to 10%, 1% to 15%, 3% to 5%, 3% to 10%, 3% to 15%, 3% to 20%, 5% to 10%, 5% to 15%, 5% to 20%, 7% to 10%, 7% to 15%, 7% to 20%, 10% to 15%, 10% to 20%, 13% to 15%, 13% to 20%, or 15% to 20% (wt/wt)).

In some embodiments, the solvent medium includes water. In some embodiments, the solvent medium includes an organic solvent selected from toluene, hexane, cyclohexane, tetrahydrofuran, and any mixture thereof. In some embodiments, the solvent medium includes methanol, cyclohexane, hexane, ethanol, water, or any mixture thereof.

In some embodiments, the polymer coating is disposed on a surface of the substrate to achieve desirable outcomes for the functionalized material under mechanical stresses, such as abrasion. In some embodiments, the polymer coating decreases the attrition of the functionalized material according to one or more standardized testing requirements. Briefly, attrition is the propensity of a product to produce fines in the course of transportation, handling, and use. In some embodiments, the polymer coating reduces the attrition such that an attrition loss of the particles is 1% or less (e.g., 0.9% or less, 0.8% or less) as measured by ASTM D4058-96 or comparable standards by which attrition, or attrition loss, is quantified. In some embodiments in accordance with the present disclosure, the functionalized material is characterized by mechanical properties that include compressive strength. In some embodiments the functionalized material is durable, e.g., having a 50% strain crush strength of at least 1.5 megapascals (MPa) (e.g., at least 2 MPa, at least 3 MPa), .e.g., have a 50% strain crush strength in a range between 1.5 MPa and 3.5 MPa.

In some embodiments, the functionalized material includes one or more chelating agents. In some embodiments the chelating agent are e present in proximity to the surface 103A of the substrate 102A, the functional portion 106A, the adsorbing moiety 110A (e.g., a CO₂ adsorbing moiety), and/or the interaction moiety 108A. In some embodiments, the chelating agent is present within the polymer coating 105A. In some embodiments, the chelating agent interacts with metals present on the surface or pores of the substrate and reduces potential oxidation of the functionalized particles, thereby increasing the chemical lifetime of the functionalized particles to adsorb CO₂. Etidronic acid, K₃PO, trisodium 2-[2-(carboxymethylamino)ethyl-(carboxymethyl)amino]acetate (HEDTA), tetrasodium 2,2′,2″,2′″-(ethane-1,2-diyldinitrilo)tetraacetate (EDTA), and trisodium 2-[(carboxymethyl)(methyl)amino]acetate (MGDA) are example chelators.

In some embodiments the chelating agent is a phosphate-based chelating agents, such as potassium phosphate, or phosphonate-based chelating agent, such as etidronic acid or a salt thereof. Other examples of the chelating agents used in the present disclosure include metal salts including phosphate (e.g., alkali metal salts, such as sodium phosphate), non-nitrogenous bisphosphonate compounds (e.g., clodronic acid and the like), and nitrogenous biphosphonate compounds (e.g., alendronic acid and the like). In some embodiments, the chelating agent is a bisphosphonate compound including a nitrogen or lacking a nitrogen. Some examples of the chelating agent include aminopolycarboxylic acids, ethylenediaminetetraacetic acid (EDTA), Nitrilotriacetic acid, diethylenetriaminepentaacetic acid (DTPA), etidronic acid, tiludronic acid, pamidronic acid, alendronic acid, cyclam, aminotris(methylenephosphonic acid), diethylenetriamine penta(methylene phosphonic acid), and 2-Phosphonobutane-1,2,4,-tricarboxylic acid (PBTC).

In general, the amount of chelating agent(s) used is up to 2% (wt/wt) to the substrate (e.g., silica particles), such as, e.g., up to 0.3% (wt/wt), up to 0.4% (wt/wt), up to 0.6% (wt/wt), or up to 1% (wt/wt). In some embodiments, the amount of chelating agent(s) can be from about 0.1% to 5% (wt/wt) to the substrate (e.g., from about 0.1% to 1%, 0.1% to 2%, 0.1% to 3%, 0.1% to 4%, 0.2% to 1%, 0.2% to 2%, 0.2% to 3%, 0.2% to 4%, 0.2% to 5%, 0.5% to 1%, 0.5% to 2%, 0.5% to 3%, 0.5% to 4%, 0.5% to 5%, 1% to 2%, 1% to 3%, 1% to 4%, or 1% to 5% (wt/wt)).

In some embodiments, the chelating agent(s) is added during steps 302A-C, 304A-C, and/or 306C of the following synthesis procedure or afterward. In one example, the chelating agent is chelating agent/methanol mixture for 1 hour. In another example, the chelating agent is added to a solution including the polymer employed to form a coating.

In some implementations, the functionalized material includes one or more antioxidants. Without wishing to be limited by mechanism, the antioxidant prevents the degradation of amine functional groups by atmospheric oxygen and extends the cycling lifetime of the functionalized material in some embodiments. In some embodiments the antioxidant is present in proximity to the surface 103A of the substrate 102A, the functional portion 106A, the adsorbing moiety 110A (e.g., a CO₂ adsorbing moiety), and/or the interaction moiety 108A. In some embodiments, the antioxidant is present within the polymer coating 105A.

In some embodiments, the antioxidants of the present disclosure include sacrificial antioxidants and cyclic antioxidants. Sacrificial antioxidants are generally irreversibly consumed in an oxidation reaction while cyclic antioxidants are regenerable. In some embodiments, the amount of antioxidant(s) in the functionalized material is up to about 5% (wt/wt) to the substrate (e.g., silica particles), such as, e.g., up to 3% (wt/wt), 4% (wt/wt), 6% (wt/wt), or 8% (wt/wt). In some embodiments, the amount of antioxidant(s) can be from about 0.1% to 3% (wt/wt) to the substrate (e.g., from about 0.1% to 1%, 0.1% to 2%, 0.1% to 3%, 0.1% to 4%, 0.2% to 1%, 0.2% to 2%, 0.2% to 3%, 0.2% to 4%, 0.2% to 5%, 0.5% to 1%, 0.5% to 2%, 0.5% to 3%, 0.5% to 4%, 0.5% to 5%, 1% to 2%, 1% to 3%, 1% to 4%, or 1% to 5% (wt/wt)).

In some embodiments the antioxidant(s) is an organic sulfur-containing compound, such as 2,2-thiodiethanol, 2-hydroxyethyl disulfide, and 3,3′-dithiodipropionic acid.sulfur-containing compounds react sacrificially as oxygen or free-radical scavengers. In some embodiments, the antioxidant is a hindered amine light stabilizer (HALS) compound. HALS are antioxidant compounds containing an amine functional group and, in some non-limiting embodiments, constitute optionally substituted piperidine compounds. In some embodiments, HALS are used at low concentrations and neutralize many oxidizing radicals and are continually regenerated by heat from the air, CO₂ adsorption, desorber heat. In some embodiments, HALS extend the lifetime of the sorbent longer than sacrificial antioxidants.

In some embodiments, more than one antioxidant is used in the materials of the present disclosure. In some embodiments, the antioxidants introduced exhibit synergism, e.g., one antioxidant is regenerated by the second, one antioxidant protects the other by sacrificial oxidation, and/or when the antioxidants exhibit different antioxidant mechanisms.

In some embodiments, the antioxidant(s) are added during steps 302A-C, 304A-C, and/or 306C of the following synthesis procedure or afterward. In some embodiments, the antioxidant is added by dissolving the antioxidant in methanol and then soaking the substrate in the antioxidant/methanol mixture for 1 hour. In some embodiments, the chelating agent is added to a solution including a reagent (e.g., including an adsorbing moiety) that is employed to form a functionalized material.

In some embodiments, the polymer coating, chelating agent, and/or antioxidant is provided (e.g., as described herein) in a functionalized material having any useful combination and number of moieties to facilitate capture of CO₂. As seen in FIG. 1B, in some embodiments the surface modification layer includes any useful combination of a first adsorbing moiety 110B (e.g., a first CO₂ adsorbing moiety), a second adsorbing moiety 112B (e.g., a second CO₂ adsorbing moiety), and an interaction moiety 108B, in which the chelating agent and/or the antioxidant is associated with the surface modification layer. In some embodiments, the surface modification layer is disposed in proximity to the surface 103B of the substrate 102B and/or a polymer coating 105B.

For example, FIG. 1B provides a non-limiting functionalized material 100B including a substrate 102B having a plurality of pores 104B-a, 104B-b. In turn, the surface 103B of the substrate 102B includes a polymer coating 105B and a functional portion 106B. The functional portion 106B in turn, includes a combination of a first adsorbing moiety 110B (e.g., a first CO₂ adsorbing moiety), a second adsorbing moiety 112B (e.g., a second CO₂ adsorbing moiety), and an interaction moiety 108B (e.g., a silane-containing interaction moiety). In some embodiments a chelating agent and/or an antioxidant is present in proximity to the surface 103B of the substrate 102B, the functional portion 106B, the first adsorbing moiety 110B (e.g., a first CO₂ adsorbing moiety), the second adsorbing moiety 112B (e.g., a second CO₂ adsorbing moiety), and/or the interaction moiety 108A. In some embodiments, the chelating agent and/or the antioxidant is present within the polymer coating 105B.

In some embodiments, the moieties of the functionalized material are provided in any useful manner. In some embodiments, the substrate surface is functionalized by use of a first CO₂ adsorbing compound (e.g., including an aminosilane) and a second CO₂ adsorbing compound (e.g., a polyamine). In turn, in some embodiments, the first CO₂ adsorbing compound includes a first adsorbing moiety (e.g., moiety 110B in FIG. 1B), and the second CO₂ adsorbing compound includes a second adsorbing moiety (e.g., moiety 112B in FIG. 1B).

In some embodiments, when the first CO₂ adsorbing compound is an aminosilane, the aminosilane includes a silane moiety as a non-limiting interaction moiety (e.g., interaction moiety 108B in FIG. 1B) and an amine moiety as a non-limiting first adsorbing moiety (e.g., first adsorbing moiety 110B in FIG. 1B). In some embodiments, the aminosilane is covalently bonded to the exterior surface of the substrate (e.g., surface 102B in FIG. 1B) and within the pores (e.g., pores 104B-a, 104B-b in FIG. 1B). Other examples of adsorbing compounds include any compounds described herein (e.g., any aminosilanes or other compounds including one or more amine moieties). In some embodiments, together an aminosilane and a polyamine form a network and provide the stable CO₂ adsorbing function.

In some embodiments the second adsorbing moiety is provided by any useful second adsorbing compound. Examples of such adsorbing compounds include any compounds described herein (e.g., any compounds including one or more amine moieties). Any useful combination of second and first adsorbing compounds is employed in some embodiments, and such combinations of compounds interact in any useful manner to provide a functionalized network or coating disposed over a surface of a substrate. In turn, in some embodiments, such a network or coating are characterized by any useful combination of adsorbing moieties and interaction moieties.

In some embodiments, the second adsorbing moiety is provided with or without a second interaction moiety. In some embodiments, the second interaction moiety provides direct or indirect attachment to the substrate surface. For example and without limitation, in some embodiments, a polyamine include a plurality of amine moieties and at least one linker disposed between at least two amine moieties (e.g., —(R^{A}-L)ₙ-, in which R^{A} is an amine moiety, L is a linker, and n is an integer). In some embodiments, the amine moiety R^{A} acts as an adsorbing moiety. Depending on other components present in the functionalized material, either the amine moiety R^{A} or the linker L acts as an interaction moiety in some embodiments. For example, in some embodiments, the amine moiety R^{A} of a polyamine interact with other amine moieties or silane moieties by way of hydrogen bonding or ionic interactions.

In some embodiments, the second adsorbing compound is a polyamine that includes an amine moiety as a non-limiting second adsorbing moiety (e.g., second adsorbing moiety 112B in FIG. 1B). In some embodiments, the second adsorbing moiety is represented by a certain functional group (e.g., an amine group of —NR^{N1}R^{N2} or —NR^{N1}— as described herein) or a certain compound having certain functional groups (e.g., a compound including one or more amine groups of —NR^{N1}R^{N2} or —NR^{N1}— as described herein). Other examples of adsorbing compounds include any compounds described herein (e.g., any polyamines or other compounds including one, two, or more amine moieties).

In some embodiments, the second adsorbing moiety interacts with other functional groups, moieties, or compounds in the functionalization material in various ways. For example and without limitation, in some embodiments the second adsorbing moiety interacts with the first adsorbing moiety, the interaction moiety, the surface of the substrate, or another second adsorbing moiety. In some embodiments, such interactions include covalent and/or non-covalent bonding interactions (e.g., any described herein). In some embodiments, the second adsorbing moiety interacts with the first adsorbing moiety. In some embodiments, the second adsorbing moiety interacts with the interaction moiety.

In some embodiments, the second adsorbing moiety comprises a polyamine or amine moieties from a polyamine. In some embodiments, when the first adsorbing moiety is an aminosilane, the polyamine interacts with amine moieties of the aminosilane or interaction moieties of the aminosilane. In some embodiments, amine moieties of aminosilane and polyamine interact with silanol groups of aminosilane through hydrogen bonding and ionic interactions to form a functional group, thereby forming a complex network over the substrate surface. Using FIG. 1B as a reference, in some embodiments a functional group 106B includes amine moieties 110B of aminosilane and amine moieties 112B of polyamine that interact with silanol groups 108B of aminosilane.

FIG. 1C provides a non-limiting functionalized material 100C including a substrate 102C having a plurality of pores 104C-a, 104C-b in accordance with some embodiments of the present disclosure. In turn, surface 103C of the substrate 102C includes a polymer coating 105C and a functional portion 106C that, in turn, includes at least one adsorbing moiety (e.g., a first CO₂ adsorbing moiety). In some embodiments, the surface modification layer includes any useful adsorbing moiety (e.g., a first CO₂ adsorbing moiety) of the functional portion 106C, in which the chelating agent and/or the antioxidant is associated with the surface modification layer. In some embodiments, the surface modification layer is disposed in proximity to the surface 103C of the substrate 102C and/or a polymer coating 105C.

In some embodiments, the chelating agent and/or the antioxidant is present in proximity to the surface 103C of the substrate 102C, the functional portion 106C, and/or at least one adsorbing moiety of the functional portion. In some embodiments, the chelating agent and/or the antioxidant is present within the polymer coating 105C.

In some embodiments, a plurality of adsorbing moieties is provided for the functionalized material. For instance, a polyamine (e.g., such as poly(ethyleneimine) (PEI)) having a plurality of adsorbing moieties is reacted with the substrate in some embodiments. In some embodiments, the polyamine is characterized by a high interaction surface area that facilitates 1- or 2-D van der Waals interactions with the surfaces of the substrate. In some embodiments, the polyamine is introduced to the substrate and forms a surface modification layer for reversibly binding CO₂ from atmospheric gases. In some embodiments, a polyamine (e.g., PEI having a larger molecular weight such as, e.g., greater than about 800 Da or from about 800 Da to 1 MDa (or 1,000,000 Da)) is used (as compared to short chain amine functionalization) because it is less volatile overall (as compared to short chain amine functionalization).

In some embodiments, the plurality of adsorbing moieties is one or more oligomeric amines or small molecule polyamines or mixtures of any of these. In some embodiments, the oligomeric amine includes an oligomeric ethylene amine or a mixture including such oligomers (e.g., an ethylene amine/oligomer mixture). In some embodiments, the oligomer includes ethylene amine-containing molecules (e.g., molecules including a —CH₂CH₂NR^{N1}— group) or oligomers such as H₂N[CH₂CH₂NH]ₙH (e.g., in which n is 1, 2, 3, 4, 5, 6, 7, 8, 9, 10, or more and R^{N1} can be any described herein). Tetraethylenepentamine (TEPA) and triethylenetetramine (TETA) are non-limiting examples of oligomeric amines with low volatility used in some embodiments. In some embodiments, an oligomeric amine is used, such as a small molecule polyamine (e.g., having a molecular weight (MW) between 100 to 800 g/mol). Other examples of oligomers used are described herein.

In some embodiments, a small molecule amine mixture (e.g., such as Amix 1000) includes amine-containing molecules, such as 2-[(2-aminoethyl)amino]ethanol, (aminoethyl)piperazine, and/or (hydroxyethyl)piperazines as a commercially available mixture of amines are used

In some non-limiting embodiments, Amix 1000, TEPA, TETA, or a mixture of these or similar compounds are used to functionalize a substrate to form the functionalized material. In some embodiments, Amix 1000, TEPA, TETA, and similar compounds are a low-cost source of reactable amines facilitating low-cost functionalization and carbon capture from atmospheric gases.

In some embodiments, an oligomeric amine or a small molecule amine mixture is reacted with a porous substrate (e.g., silica) to form a functionalized substrate. In some embodiments, the oligomeric amine or the small molecule amine mixture is a compound bonded to a surface of the substrate and forms the surface modification layer on the surface through van der Waals interactions.

Using FIG. 1C as a reference, in some embodiments the functional group 106C includes a polyamine group. In some embodiments the polyamine group includes one or more primary, secondary, or tertiary amine groups; repeat units of ethylamine or propylamine; or more than one amine groups connected through various linkers (e.g., alkylene groups); or linear or branched polyamines. In some embodiments, the polyamine group has an increased interaction surface area compared to short chain amine-containing compounds due to the increased number of amine groups in the polymeric chain. In some embodiments, the polyamine group is bonded to the substrate 102C through van der Waals interactions, hydrogen bonding, and/or ionic interactions.

In some embodiments of any functional material herein, the functional portion includes an adsorbing moiety that captures CO₂ (e.g., as in a CO₂ adsorbing moiety). In some embodiments, the CO₂ adsorbing moiety includes one or more amine-containing moieties. Amine-containing moieties are provided by way of an aminosilane, an amine compound, a polyamine compound, or a combination of any of these. Additional details regarding CO₂ adsorbing moieties are described herein.

As also described herein, in some embodiments the functional portion includes an interaction moiety that interacts with at least a portion of the surface of a substrate. In some embodiments, the interaction moiety is selected based on the substrate to be functionalized. In some embodiments, the substrate to be functionalized includes silica, and the interaction moiety is configured to react with silica. In some embodiments, the interaction moiety comprises a silane moiety that reacts with the surface of the silica substrate. In other embodiments, the substrate to be functionalized includes a metal-organic framework (MOF) material, and the interaction moiety is configured to react with the MOF material. In some embodiments, the interaction moiety comprises a silane moiety that reacts with the surface of the MOF substrate. In other embodiments, the substrate to be functionalized includes a resin material, and the interaction moiety is configured to react with the resin material. In some embodiments, the interaction moiety comprises an amine moiety that reacts with the surface of the resin substrate. In some embodiments, the interaction moiety interacts with the substrate surface through covalent and/or non-covalent bonding interactions (e.g., as described herein). Additional details regarding interaction moieties and substrates are described herein.

Such moieties are introduced in any useful manner. For instance, in some embodiments such moieties are present in one or more compounds that, in turn, are provided within a suspension or a mixture (e.g., a functionalization mixture). In some embodiments, when substrate is also present, the compounds interact with the substrate to provide a functionalized material. Any useful compound(s) are employed. In one non-limiting instance, the amine moiety and silane moiety are provided by way of an aminosilane compound that, in turn, reacts with or interacts with the substrate surface to provide amine-containing groups. In another non-limiting instance, the amine moiety is provided by way of a polyamine compound that, in turn, reacts with or interacts with the substrate surface to provide amine-containing groups. In yet another non-limiting instance, both an aminosilane compound and a polyamine compound are employed to provide a functionalized surface. In some embodiments, such reactions result in covalent and/or non-covalent interactions, in which a linking group (e.g., by way of optionally substituted aliphatic, alkylene, alkenylene, alkynylene, heteroaliphatic, heteroalkylene, heteroalkenylene, heteroalkynylene, aromatic, arylene, heteroaromatic, heteroarylene, and the like) is present between a functional group (or a moiety) and the substrate surface. In some embodiments, an amine moiety is an amine functional group itself (e.g., —NR^{N1}R^{N2}, as described herein) or a portion of a compound including the amine functional group (e.g., -L-NR^{N1}R^{N2}, in which L, R^{N1}, and R^{N2} is any described herein). Additional details regarding compounds, suspensions, and mixtures to provide functional portions are described herein.

In use, in some embodiments, the functionalized material is provided as a layer (e.g., a layer of beads or powder) or a bed over which or through which a gaseous mixture including CO₂ is flowed. In some embodiments, such a material is considered a “sorbent” or “adsorbent,” in which these terms are used interchangeably unless otherwise specified. Gas exiting the sorbent has a lower concentration of CO₂ than the entering gas. In some embodiments, the functionalized material reversibly adsorbs CO₂ over a number of cycles, e.g., a number of adsorption and desorption steps, in which a cycle includes at least one adsorption step and at least one desorption step. In some embodiments, higher cycle counts are used to characterize materials having longer product lifetimes when used in CO₂ capture applications. In some non-limiting implementations, the functionalized material reversibly adsorbs CO₂ over 100 cycles (e.g., over 500 cycles, over 1000 cycles, over 2000 cycles, or over 3000 cycles). Here and throughout the specification, reference to a measurable value such as an amount, a temporal duration, and the like, the recitation of the value encompasses the precise value, approximately the value, and within ±10% of the value. For example, here 100 cycles include precisely 100 cycles, approximately 100 cycles, and within ±10% of 100 cycles.

In some embodiments, CO₂ adsorbed to the functionalized material is released (e.g., desorbed) under some conditions. As one example, reducing the gas pressure surrounding the functionalized material desorbs captured CO₂. As another example, reducing the partial pressure of CO₂ surrounding the functionalized material desorbs captured CO₂ (e.g., by purging with N₂ or another gas). One or more of these approaches facilitates recapture of the adsorbed CO₂ in a secondary environment. In some implementations, the functionalized material is exposed to a reduced gas pressure of less than 5 psi (e.g., less than 3 psi, 1.5 psi, 1 psi, or 0.1 psi).

As a second example, increasing the temperature of the functionalized material destabilizes bonding between an amine group and CO₂, thereby desorbing the CO₂ from the functionalized material. In some embodiments, the functionalized material desorbs CO₂ at temperatures above 60° C. (e.g., above 60° C., 70° C., 80° C., or 90° C.). In some embodiments, increasing the temperature and decreasing gas pressure concurrently increase the rate at which the CO₂ desorbs from the functionalized material.

Indeed, in some embodiments, release of gas from a sorbent includes any useful process. In one example, a swing process is employed. In some embodiments, such swing processes include application of temperature change, pressure change, and/or vacuum change to release the gas from the sorbent composition. In some embodiments, swing processes include Temperature Swing Adsorption (TSA), Pressure Swing Adsorption (PSA), and Vacuum Swing Adsorption (VSA), or any combination of these. In some embodiments, the released gas is provided as outputs, and such outputs are generated by exposing the sorbent to a temperature swing adsorption process, pressure swing adsorption, vacuum swing adsorption process, or any combination of any of these.

### i. Substrate

In some embodiments the functionalized material includes any useful substrate. In some embodiments the substrate is in the form of a plurality of porous particles. In some embodiments, the substrate has a porous surface upon which a functional portion is disposed. In some embodiments, the substrate comprises a porous substrate, such as a porous ceramic (e.g., a porous metal oxide, a porous metalloid oxide, or combinations thereof or mixed forms thereof), a porous metal-organic substrate, or a porous polymeric substrate. In some embodiments, the substrate comprises a porous ceramic/metal oxide together with porous silica (e.g., including porous alumina, calcium silicate, sodium aluminosilicate). Yet other non-limiting examples of substrates include porous silica or silicate (e.g., amorphous silica, calcium silicate, sodium aluminosilicate), porous alumina (e.g., including sodium aluminosilicate), metal-organic framework (MOF), or resin (e.g., as described herein). In some embodiments, the substrate is provided in any form (e.g., precipitated, sol-gel, fumed, calcined, agglomerated, or granulated forms, which in turn can be provided as a powder, a granule, and the like). In some embodiments the substrate is sourced from standard industrial sources or is synthesized. In some embodiments, the substrate is water-stable and/or resistant to corrosion and oxidation.

The dimension of the substrate can vary based on the application and/or the source. Depending on the shape of the substrate, a dimension of the substrate can include a length, width, height, cross-sectional dimension, circumference, radius (e.g., external or internal radius), diameter, or another metric to indicate a size of the substrate.

In some embodiments, the substrate comprises a plurality of porous particles, in which the plurality of porous particles is characterized by a certain effective average particle size and/or by a certain distribution of sizes. For example and without limitation, in some embodiments the plurality of porous particles has an effective average particle size in which at least 50% of the porous particles therein are of a specified size. For example and without limitation, in some embodiments the plurality of porous particles exhibits a distribution of sizes that is from about 25 micrometers (μm) to 3 millimeter (mm) or from 25 μm to 4 mm. Thus, in some embodiments where the plurality of porous particles exhibits a distribution of sizes, at least 60 percent, at least 70 percent, at least 80 percent, at least 90 percent, at least 95 percent, at least 99 percent, or all of the porous particles have a sieve diameter that is within the upper and lower bounds of the specified distribution.

In some embodiments, the plurality of porous particles exhibits a distribution of sieve diameters, with an average sieve diameter that is in a range from 25 μm to 4 mm (e.g., from 45 to 800 μm, 50 to 500 μm, 60 to 300 μm, 45 to 150 μm, 70 to 80 μm, 25 μm to 3 mm, 25 μm to 2 mm, 25 μm to 1 mm, 50 μm to 4 mm, 50 μm to 3 mm, 50 μm to 2 mm, 50 μm to 1 mm, 100 μm to 4 mm, 100 μm to 3 mm, 100 μm to 2 mm, 100 μm to 1 mm, 200 μm to 4 mm, 200 μm to 3 mm, 200 μm to 2 mm, 200 μm to 1 mm, 250 μm to 4 mm, 250 μm to 3 mm, 250 μm to 2 mm, 250 μm to 1 mm, 500 μm to 4 mm, 500 μm to 3 mm, 500 μm to 2 mm, 500 μm to 1.5 mm, 1 to 2 mm, 1 to 2.5 mm, 1 to 3 mm, or 1 to 4 mm). In some implementations, the average sieve diameter of the plurality of porous particles is less than 500 μm (e.g., less than 400 μm, less than 350 μm, less than 300 μm, less than 200 μm, or less than 100 μm). In some embodiments, the substrate (e.g., porous silica particles) has an average sieve diameter of at least 0.5 mm.

In some embodiments, the sieve diameter of the plurality of porous substrate particles is a measure of central tendency determined over the sieve diameter of the plurality of porous particles. As used herein, the term sieve diameter is the smallest mesh size through which a particle can pass. As used herein, the term “measure of central tendency” refers to a central or representative value for a distribution of values. Non-limiting examples of measures of central tendency include a mean, arithmetic mean, weighted mean, midrange, midhinge, trimean, geometric mean, geometric median, Winsorized mean, median, and mode of the distribution of values. For instance, in some embodiments, the sieve diameter of the plurality of porous particles is an average sieve diameter of the plurality of porous particles used for generating the functionalized crosslinked particles.

In some embodiments, the plurality of porous particles comprises a distribution of sieve diameters.

In some embodiments, the sieve diameter, or the measure of central tendency (e.g., mean) thereof, for the plurality of porous particles (substrate) is at least 0.2 millimeters (mm), at least 0.3 mm, at least 0.4 mm, at least 0.5 mm, at least 0.6 mm, at least 0.7 mm, at least 1 mm, at least 1.5 mm, at least 2 mm, at least 2.5 mm, at least 3 mm, at least 3.5 mm, at least 4 mm, or at least 5 mm. In some embodiments, the sieve diameter, or the measure of central tendency (e.g., mean) thereof, of the plurality of porous particles is no more than 10 mm, no more than 5 mm, no more than 4 mm, no more than 3.5 mm, no more than 3 mm, no more than 2.5 mm, no more than 2 mm, no more than 1.5 mm, no more than 1 mm, no more than 0.5 mm, or no more than 0.3 mm. In some embodiments, the sieve diameter, or the measure of central tendency (e.g., mean) thereof, for the plurality of porous particles is from 0.2 mm to 1 mm, from 0.5 mm to 2 mm, from 1 mm to 4 mm, from 0.4 mm to 4 mm, from 3 mm to 5 mm, or from 4 mm to 10 mm. In some embodiments, the sieve diameter, or the measure of central tendency (e.g., mean) thereof, for the plurality of porous particles falls within another range starting no lower than 0.2 mm and ending no higher than 10 mm.

In some embodiments, the sieve diameter of the porous particles (substrate) varies based on the application and/or the source. In some embodiments, the porous particles (substrate) have an average sieve diameter in the range from 0.25 mm to 4.0 mm (e.g., 0.25 mm to 1.5 mm, 0.5 mm to 1.5 mm, 0.5 mm to 1.0 mm, 1.0 mm to 2.0 mm, 1.5 to 2.0 mm, 0.5 mm to 4.0 mm, 1.0 mm to 4.0 mm, or 2.0 mm to 4.0 mm). In some embodiments, the porous particles have a distribution of sieve diameters having an average (e.g., mean) diameter ranging from 1 mm to 1.2 mm. In some embodiments, the distribution of sieve diameters for the plurality of porous particles comprises sieve diameters of from 0.2 mm to 1 mm, from 0.5 mm to 2 mm, from 1 mm to 4 mm, from 0.4 mm to 4 mm, from 3 mm to 5 mm, from 0.2 mm to 5 mm, from 1 mm to 8 mm, from 0.3 mm to 5 mm, from 0.2 mm to 10 mm, or from 4 mm to 10 mm. In some embodiments, the distribution of sieve diameters for the plurality of porous particles falls within another range starting no lower than 0.2 mm and ending no higher than 10 mm.

The width of the distribution around the average can affect adsorption performance of the substrate (e.g., plurality of porous particles). In some non-limiting implementations, the width of the distribution is in a range from 5 to 50 μm around the average (e.g., from 10 to 40 μm or 20 to 30 μm). In some examples, the width of the distribution is in a range from 50 μm to 2 mm around the average (e.g., from 75 μm to 1.5 mm, 100 μm to 1.25 mm, 200 μm to 1 mm, 300 to 800 μm, 500 μm to 2 mm, 500 μm to 1.5 mm, 500 μm to 1 mm, 1 to 2 mm, 1.2 to 1.8 mm, 1.4 to 2 mm, or 1.5 to 2 mm).

In some embodiments, the width of the distribution is alternatively described using D₉₀, D₅₀, and/or D₁₀ values. These values signify a percentage of the total distribution of sizes for material within a sample, up to and including the value. For example, a D₉₀ value of 500 μm indicates that 90% of the material (e.g., the plurality of porous particles) within a sample has a size of 500 μm or smaller. In some embodiments, the functionalized material (e.g., the plurality of functionalized crosslinked particles) has a D₁₀ value of 30 μm or a D₉₀ value of 150 μm. In some embodiments, the functionalized material has a D₁₀ value of 100 μm or a D₉₀ value of 500 μm, a D₁₀ value of 150 μm or a D₉₀ value of 1000 μm, a D₁₀ value of 400 μm or a D₉₀ value of 1500 μm, a D₁₀ value of 500 μm or a D₉₀ value of 2000 μm, or a D₁₀ value of 1000 μm or a D₉₀ value of 3000 μm. In some embodiments, the functionalized material has a D₅₀ value of 1000 μm, 1100 μm, 1200 μm, 1300 μm, 1400 μm, or 1500 μm.

In general and without wishing to be bound by theory, a smaller particle size with high porosity or high pore volume and BET surface area can facilitate better functionalized material synthesis results, which in turn can enable higher CO₂ capture capacity due to relatively higher surface area leading to higher amine coating concentrations. Such types of smaller particles could permit faster adsorption inside of the particle as the gas diffusion path may be shorter. If gas diffusion to the particle surface rate is not limited, then a smaller particle size may be beneficial to gas adsorption. Smaller particle size (e.g., having a small average diameter, radius, or width) could reduce the adsorption process energy cost for a fluidization process.

Yet other particle effects for smaller particle sizes can include smaller interparticle volume, slower interparticle gas kinetics (e.g., due to longer interparticle diffusion length), faster intraparticle gas kinetics (e.g., due to shorter intraparticle diffusion length), higher packed bed back pressure, higher packing density, and/or higher external surface area. Particle effects for larger particle sizes can include larger interparticle volume, faster interparticle gas kinetics (e.g., due to shorter interparticle diffusion length), slower intraparticle gas kinetics (e.g., due to longer intraparticle diffusion length), lower packed bed back pressure, lower packing density, and/or lower external surface area. A skilled artisan could adapt such sizes and effects to provide a certain adsorbent for particular uses.

In some embodiments the substrate (e.g., plurality of porous particles) is characterized by the presence of one or more pores. As seen in FIG. 1A, pores 104 can be considered openings that extend from the exterior surface of the substrate into the interior of the particles. In some embodiments, the presence of such pores increase the surface area of the substrate. Pore dimension varies from pore to pore, and can vary within an individual pore, see, e.g., pores 104A-a, 104A-b. Furthermore, depending on pore shape, a pore dimension can be a length, width, height, cross-sectional dimension, circumference, radius (e.g., external or internal radius), diameter, or another metric to indicate pore size.

In some embodiments, the pore size of the pores is in a range from 60 angstroms (Å) to 700 angstroms (Å) (e.g., from 60 to 400 Å, 60 to 300 Å, 80 to 300 Å, 100 to 700 Å, 100 to 500 Å, 100 to 200 Å, 150 to 250 Å, 200 to 700 Å, 300 to 700 Å, 300 to 500 Å, or 500 to 700 Å). In some embodiments, the pore have an average pore size or a mane pore size that is from about 60 Å 100 to about 400 Å. In some implementations, the dimension (e.g., a diameter, cross-sectional length, etc.) of the pore(s) is greater than 90 Å (e.g., greater than 100 Å, 120 Å, or 150 Å). Without wishing to be limited by theory, a larger diameter of the pore could increase adsorption and desorption rates and could facilitate higher filling of the pores with amine moieties without pore-clogging, which in turn could reduce adsorption and desorption efficiency.

In some embodiments, the substrate is characterized by a porosity of 1 to 200 nm and/or an average pore size of 30 to 80 nm. In some embodiments, a dimension (e.g., a diameter, a cross-sectional length, etc.) of the pore(s) is in a range from 1 to 200 nm (e.g., 1 to 180 nm, 1 to 160 nm, 1 to 120 nm, 1 to 100 nm, 1 to 70 nm, 1 to 30 nm, 1 to 20 nm, 10 to 200 nm, 10 to 180 nm, 10 to 160 nm, 10 to 120 nm, 10 to 100 nm, 10 to 70 nm, 10 to 50 nm, 30 to 200 nm, 30 to 180 nm, 30 to 160 nm, 30 to 120 nm, 30 to 100 nm, 30 to 90 nm, 30 to 70 nm, 70 to 200 nm, 70 to 180 nm, 70 to 160 nm, or 70 to 120 nm). In some embodiments, an average dimension (e.g., an average diameter) of the pore(s) is in a range from 30 to 80 nm, 20 to 100 nm, or 20 to 70 nm).

In some embodiments, the substrate (e.g., the plurality of porous particles) is characterized by a plurality of pores of different sizes. For example and without limitation, smaller pores in the range of 1 to 30 nm can contribute to relatively higher surface areas, which can allow for more surface anchoring with amine moieties to improve stability of the coating or surface functionalization layer. Larger pores in the range of 30 to 90 nm can contribute to relatively larger pore volumes that allow for larger volumes of active amine moieties to be contained within the pores to improve the CO₂ uptake. The largest pores in the range of 70 to 200 nm can provide open channels that contribute to relatively higher gas diffusion rates for improved CO₂ adsorption kinetics. Without wishing to be limited by mechanism, a substrate (e.g., a silica substrate) that possesses significant porosity in these three ranges may be employed as substrates for amine-coated sorbents. In some non-limiting embodiments, a substrate having reduced porosity in one or two of these ranges may suffer from relatively decreased performance in the corresponding function but may still function as substrates for amine-coated sorbents.

In some embodiments, a substrate (e.g., plurality of porous particles) is characterized by a plurality of pores, where each pore is characterized by a pore dimension, where at least one pore dimension is in a first range of about 1 to 30 nm, a second range of about 30 to 90 nm, and/or a third range of about 70 to 200 nm. Such ranges can be any other ranges of pore dimensions described herein.

Pores can have any useful shape (e.g., cylindrical, spherical, tubular, and the like), configuration, distribution, and arrangement (e.g., hexagonal, cubic, and the like). In some embodiments, the pores have an irregularly round cross-sectional shape, or a hexagonal cross-sectional shape, though this is not limiting. Pores may also be characterized by pore size distributions, which can be determined in any useful manner (e.g., using mercury, nitrogen, argon, helium, etc. in porosimetry or using Brunauer-Emmett-Teller (BET) analysis with appropriate methods such as the Barrett Joyner Halenda (BJH) or Non-Local Density Functional Theory (NLDFT) models).

Pore size distribution profiles can include those for non-limiting sorbents with only narrow pores having high surface areas but relatively lower pore volumes and gas kinetics, non-limiting sorbents with only moderately sized pores having high pore volumes and moderate surface areas and gas kinetics, non-limiting sorbents with only large pores having fast gas kinetics and high pore volumes but relatively lower surface areas, and non-limiting sorbents with pores in a plurality of ranges having high surface areas, pore volumes, and channels for gas diffusion allowing for stable surface coating, relatively higher concentrations of active amines, and fast gas kinetics.

The pores can have any useful configuration. In some embodiments, pores may be provided on a surface of the substrate. Such pores may or may not be interconnected. For example and without limitation, pores could extend into the central volume of the substrate and form interconnected channels. Without wishing to be limited by theory, the pores can create a volume within the substrate in which gases may flow for enhanced capture of such gases. Furthermore, such pores may create additional (e.g., and accessible) surface area for functionalization.

In some embodiments, pores are characterized by pore volume, total surface area, accessible surface area, porosity, and the like. In some embodiments, the volume of the pores is greater than 0.1 mL/g, (e.g., greater than 0.5 mL/g, greater than 0.8 mL/g, greater than 1 mL/g, greater than 1.2 mL/g, greater than 1.5 mL/g, or greater than 1.8 mL/g). In some embodiments, the volume of the pores is from 0.1 to 5 mL/g (e.g., from 0.1 to 4.5 mL/g, 0.1 to 4 mL/g, 0.1 to 3 mL/g, 0.1 to 3.5 mL/g, 0.1 to 3 mL/g, 0.1 to 2.5 mL/g, 0.1 to 2 mL/g, 0.1 to 1.5 mL/g, 0.1 to 1.2 mL/g, 0.1 to 1 mL/g, 0.5 to 5 mL/g, 0.5 to 4.5 mL/g, 0.5 to 4 mL/g, 0.5 to 3.5 mL/g, 0.5 to 3 mL/g, 0.5 to 2.5 mL/g, 0.5 to 2 mL/g, 0.5 to 1.5 mL/g, 0.5 to 1 mL/g, 1 to 5 mL/g, 1 to 4.5 mL/g, 1 to 4 mL/g, 1 to 3.5 mL/g, 1 to 3 mL/g, 1 to 2.5 mL/g, 1 to 2 mL/g, 1.5 to 5 mL/g, 1.5 to 4.5 mL/g, 2.5 to 5 mL/g, 2.5 to 4.5 mL/g, 3.5 to 5 mL/g, 3.5 to 4.5 mL/g, 1.5 to 3.5 mL/g, 1 to 3 mL/g, 1 to 1.5 mL/g, 1 to 1.2 mL/g, or 1.5 to 2.5 mL/g). Without wishing to be limited theory, increased total volume of the pores could allow more amine moieties to be grafted or into the pores and, thus increase the adsorption potential of the functionalized material.

Total surface area can be used to characterize the substrate. The total surface area of the substrate includes the surface area of not only the outer surface but also the surface area within the pores. In some embodiments, the total surface area is greater than 100 m² per dry gram (m²/g) of substrate. In some implementations, the total surface area is greater than 300 m²/g (e.g., greater than 200 m²/g, 400 m²/g, 500 m²/g, or 800 m²/g). In some implementations, the total surface area is greater than 1200 m²/g (e.g., greater than 200 m²/g, 400 m²/g, 500 m²/g, or 800 m²/g). In some implementations, the total surface area is greater than 2000 m²/g (e.g., greater than 2500 m²/g, 3000 m²/g, 4000 m²/g, 5000 m²/g, or 6000 m²/g). In some examples, the total surface area is in a range from 100 to 1200 m²/g (e.g., from 200 to 1200 m²/g, 400 to 1200 m²/g, 500 to 1200 m²/g, 700 to 1200 m²/g, 800 to 1200 m²/g, 1000 to 1200 m²/g, 100 to 1000 m²/g, 100 to 800 m²/g, 100 to 500 m²/g, 100 to 400 m²/g, 100 to 900 m²/g, 200 to 900 m²/g, 400 to 900 m²/g, 500 to 1000 m²/g, or 500 to 800 m²/g). In some examples, the total surface area is in a range from 1000 to 12000 m²/g (e.g., from 1000 to 11000 m²/g, 1000 to 10000 m²/g, 1000 to 9000 m²/g, 1000 to 8000 m²/g, 1000 to 7000 m²/g, 1000 to 6000 m²/g, 1000 to 5000 m²/g, 1000 to 4000 m²/g, 2000 to 12000 m²/g, 2000 to 11000 m²/g, 2000 to 10000 m²/g, 2000 to 9000 m²/g, 2000 to 8000 m²/g, 2000 to 7000 m²/g, 2000 to 6000 m²/g, 2000 to 5000 m²/g, 2000 to 4000 m²/g, 3000 to 12000 m²/g, 3000 to 11000 m²/g, 3000 to 10000 m²/g, 3000 to 9000 m²/g, 3000 to 8000 m²/g, 3000 to 7000 m²/g, 3000 to 6000 m²/g, 3000 to 5000 m²/g, 3000 to 4000 m²/g, 4000 to 12000 m²/g, 4000 to 11000 m²/g, 4000 to 10000 m²/g, 4000 to 9000 m²/g, 4000 to 8000 m²/g, 4000 to 7000 m²/g, 4000 to 6000 m²/g, or 4000 to 5000 m²/g). In some examples, the total surface area is in a range from 100 to 12000 m²/g (e.g., including ranges therebetween, such as any described herein).

Without wishing to be limited by theory, higher total surface area could increase the available area for functionalization (e.g., by way of interactions between a silane moiety and a surface of the substrate) and/or increase the adsorption potential of the functionalized material. Surface area can be determined in any useful manner, e.g., by using the BET model or other methodologies described herein.

Any useful combination of features may be present in a substrate. In some embodiments, the substrate comprises a greatest dimension (e.g., an average greatest dimension) of at least 70 μm and a plurality of pores, where the plurality of pores is characterized by a volume that is greater than 0.8 mL/g and by a size (e.g., an average size) of at least 90 Å. In some embodiments, the substrate comprises a greatest dimension (e.g., an average greatest dimension) in a range from 0.5 to 2 mm and a plurality of pores, where the plurality of pores is characterized by a volume greater than 0.5 ml/g and a size in a range from 20 to 1000 Å. Other combinations of features are possible.

a. Silica

In some embodiments, the substrate comprises silica (e.g., silicon dioxide). Any methods or compounds herein can be used to functionalize a silica substrate to provide a functionalized silica. For example and without limitation, in some embodiments the functionalized silica has amine moieties that are bound to the silica surface (e.g., by way of siloxane bonds, other covalent bonds, or even non-covalent bonds).

In some embodiments the silica is in any useful form, such as beads (e.g., microbeads, nanobeads, or combinations thereof), powders (e.g., micropowders, nanopowders, or combinations thereof; or from micrometer size to millimeter size), particles (e.g., microparticles, nanoparticles, or combinations thereof), and the like. Furthermore, in some embodiments the silica includes any useful type, such as amorphous or non-crystalline silica (e.g., precipitated, sol-gel, fumed, calcined, agglomerated, or other forms of silica) or silicates (e.g., calcium silicate, sodium aluminosilicate, and the like). In some embodiments, the silica includes one or more pores (e.g., as in porous silica). Furthermore, within such a substrate, pores can have any useful shape, configuration, distribution, and arrangement (e.g., hexagonal arrangement of pores in MCM-41, which in turn can be spherical or any other shape). In some embodiments, the substrate can be bead-shaped, though this is not limiting. Silica can be obtained or provided in any useful manner, such as by employing synthetic methods or by sourcing from standard industrial sources.

In some non-limiting embodiments, the substrate 102A, 102B, 102C is a silica substrate. In some non-limiting embodiments, the substrate 102A, 102B, 102C is composed of amorphous silica, e.g., non-crystalline silica.

b. Metal-Organic Framework (MOF)

Metal organic frameworks (MOFs) are a class of compounds including metal ions or clusters coordinated to organic ligands to form one-, two-, or three-dimensional structures (e.g., porous three-dimensional structures). Various kinds of MOF are synthesized with different combinations of metal ions and organic ligands (e.g., as described herein) and all such MOFs are within the scope of the present disclosure. In some embodiments, MOF substrates are used as a porous structure for functionalization to achieve carbon capture.

In some embodiments, the substrate comprises a MOF. Any methods or compounds herein are used to functionalize a MOF substrate to provide a functionalized MOF. Without wishing to be limited by theory, a functionalized MOF features surface areas larger than alternative substrates (e.g., zeolite, silica, etc.) for increased functionalization (e.g., >2000 m²/g). For example and without limitation, in some embodiments a functionalized MOF features amine moieties that are bound to hydroxy functional side groups present on the surface, thereby allowing for CO₂ uptake. The amine moiety is provided by any compound described herein (e.g., an aminosilane compound) for increased carbon capture (e.g., >2 mol CO₂/kg).

In some embodiments MOFs are provided in any useful manner. In some embodiments, MOFs are produced using reactor-based, solvothermal (e.g., hydrothermal) synthesis methods in which a metal source (e.g., a metallic substrate or a metal-containing salt), an organic ligand, and an optional competing agent/additive are reacted together to produce MOF crystals of 10 μm to 1 mm in size (e.g., in diameter), including ranges therebetween (e.g., from 10 to 500 μm, 10 to 300 μm, 50 to 300 μm, or 50 to 100 μm in size). In some embodiments, the crystals are extruded, pelletized, and functionalized with adsorbing moieties to provide a functional group disposed on a surface of the MOF, thereby providing a functionalized MOF.

In some embodiments, MOFs are synthesized by providing a metal source and an organic ligand. Under certain conditions, metal-containing centers form nodes, and organic ligands form bridges between the nodes to provide self-assembled, networked structures. By selecting certain metals and ligands with certain reaction conditions, various structural characteristics (e.g., topology, pore structure, pore size, and the like) of the MOF material are controlled in some embodiments.

Any useful metal source can be employed. Non-limiting examples include metal sources comprising aluminum (Al), chromium (Cr), copper (Cu), iron (Fe), titanium (Ti), vanadium (V), zinc (Zn), zirconium (Zr), as well as salts thereof (e.g., halide salts, nitrate salts, or others described herein), combinations thereof, and mixtures thereof. In some embodiments, the metal source is an aluminum-based metal source, an iron-based metal source, a titanium-based metal source, a zinc-based metal source, or a zirconium-based metal source. In some embodiments, the metal ions selected for the MOF substrate include an economical, commercially available, cost-effective metal ion source, such as aluminum (Al), iron (Fe), titanium (Ti), zinc (Zn) (e.g., zinc nitrate (ZnNO₃)), zirconium (Zr) (e.g., zirconium tetrachloride (ZrCl₄)).

Any useful organic ligand is employed in some embodiments. Non-limiting ligands include, e.g., 3,3′,5,5′-azobenzenetetracarboxylate (ABTC⁴⁻); 1,4-benzenedicarboxylate (BDC²⁻); (X)-BDC²⁻ or (X)₂—BDC²⁻, where each X is, independently, alkyl, halo, hydroxy, nitro, amino, carboxyl, alkoxy, cycloalkoxy, aryloxy, or benzyloxy (e.g., 2-amino-1,4-benzenedicarboxylate (NH₂—BDC²⁻), 2-hydroxy-1,4-benzenedicarboxylate (OH-BDC²⁻), 2,5-diamino-1,4-benzenedicarboxylate ((NH₂)₂-BDC²⁻), 2,5-dihydroxy-1,4-benzenedicarboxylate ((OH)₂—BDC²⁻ or DHBDC²⁻), 2,3-dihydroxy-1,4-benzenedicarboxylate, or 2,6-dihydroxy-1,4-benzenedicarboxylate); 1,1′-biphenyl-4,4′-dicarboxylate (BPDC²⁻); (X)-BPDC²⁻ or (X)₂—BPDC²⁻, where each X is, independently, alkyl, halo, hydroxy, nitro, amino, carboxyl, alkoxy, cycloalkoxy, aryloxy, or benzyloxy (e.g., 2-amino-1,1′-biphenyl-4,4′-dicarboxylate (NH₂—BPDC²⁻), 2-hydroxy-1,1′-biphenyl-4,4′-dicarboxylate (OH-BPDC²⁻), 2,2′-diamino-1,1′-biphenyl-4,4′-dicarboxylate ((NH₂)₂-BPDC²⁻), or 2,2′-dihydroxy-1,1′-biphenyl-4,4′-dicarboxylate ((OH)₂—BPDC²⁻)); 1,3,5-benzenetricarboxylate or 1,2,4-benzenetricarboxylate (BTC³⁻); 2,5-dihydroxy-1,4-benzenedicarboxylate (DHBDC²⁻); 2,5-dioxido-1,4-benzenedicarboxylate (DOBDC⁴⁻); 4,4′,4″-s-triazine-2,4,6-triyl-tribenzoate (TATB³⁻); 1,3,6,8-tetrakis(p-benzoate)pyrene (TBAPy⁴⁻); 1,1′-triphenyl-4,4′-dicarboxylate (TPDC²⁻); and (X)₂-TPDC²⁻ or (X)₄-TPDC²⁻, where each X is, independently, alkyl, halo, hydroxy, nitro, amino, carboxyl, alkoxy, cycloalkoxy, aryloxy, or benzyloxy (e.g., 2,2′-dihydroxy-1,1′-triphenyl-4,4′-dicarboxylate (di-OH-TPDC) or 2,2′,6,6′-tetrahydroxy-1,1′-triphenyl-4,4′-dicarboxylate (tetra-OH-TPDC)). In some embodiments, such ligands are provided as a compound in its protonated form to the metal source. In some embodiments, the ligand optionally includes one or more counterions (e.g., one or more counteranions or countercations), as well as a cation thereof, an anion thereof, a protonated form thereof, a salt thereof, or an ester thereof.

In some embodiments, the ligand includes hydroxy functional side groups. Without wishing to be limited by theory or mechanism, the presence of hydroxy functional side groups may facilitate post-synthetic functionalization of the MOF surface with adsorbing moieties (e.g., amine moieties).

In some embodiments, the hydroxy reacts with a silane moiety of an aminosilane compound to covalently bond the silane moiety to the hydroxy group of the organic ligand, while increasing the density of amine moieties on a surface of the MOF substrate, thereby increasing the CO₂ capture capacity of the MOF substrate. Non-limiting examples of aminosilanes suitable for bonding with the MOF substrate for carbon capture include methoxysilanes, chlorosilanes, ethoxysilanes, as well as others described herein.

In some embodiments, the organic ligand is provided by a compound that is 1,4-di-(4-carboxy-2,6-dihydroxyphenyl)benzene. Within the MOF, this compound provide sa 2,2′,6,6′-tetrahydroxy-1,1′-triphenyl-4,4′-dicarboxylate (tetra-OH-TPDC) ligand. In some embodiments, this compound is employed with a metal source that includes Zn(NO₃)₂·6H₂O.

In some embodiments, the organic ligand is 2-hydroxyterephthalic acid (e.g., to provide a 2-hydroxy-BDC ligand), 2,5-dihydroxyterephthalic acid (e.g., to provide a 2,5-dihydroxy-BDC ligand), 2,3-dihydroxyterephthalic acid (e.g., to provide a 2,3-dihydroxy-BDC ligand), 2,6-dihydroxyterephthalic acid (e.g., to provide a 2,6-dihydroxy-BDC ligand), or 2-boronobenzene-1,4-dicarboxylic acid (e.g., to provide a 2-borono-BDC ligand).

Any useful MOF can be employed. Non-limiting examples of MOF include, e.g., HCC-1 [Zn₄O(di-OH-TPDC)₃]; HCC-2 [Zn₄O(tetra-OH-TPDC)₃], HKUST-1 [Cu₃(BTC)₂ or Cu₃(BTC)₃(H₂O)₃], IRMOF-1 or MOF-5 [Zn₄O(BDC)₃], IRMOF-3 [Zn₄O(NH₂—BDC)₃], IRMOF-10 [Zn₄O(BPDC)₃], IRMOF-16 [Zn₄O(TPDC)₃], MIL-47 [VO(BDC)], MIL-101-Cr [Cr₃O(BDC)₃(H₂O)₂F or Cr₃O(BDC)₃(H₂O)₃], MIL-101-Fe [Fe₃O(BDC)₃(H₂O)₂X or Fe₃O(BDC)₃X, where X is a monoanion, such as OH⁻ or Cl⁻], NH₂-MIL-101-Fe [Fe₃O(NH₂—BDC)₃(H₂O)₂X or Fe₃O(NH₂—BDC)₃X, where X is a monoanion, such as OH⁻ or Cl⁻], NH₂-MIL-101-A1 [A130(NH₂—BDC)₆X₃ or A130(NH₂—BDC)₃(H₂O)₂X, where X is a monoanion, such as OH⁻ or Cl⁻], MIL-125 [Ti₈O₈(OH)₄ (BDC)₆], NH₂-MIL-125 [Ti₈O₈(OH)₄(NH₂—BDC)₆], MOF-2 [Zn₂(BDC)₂], MOF-74 [Zn₂(DHBDC)], MOF-808 [Zr₆O₄(μ₃-OH)₄(OH)₆(H₂O)₆(BTC)₂], NU-1000 [Zr6(μ3-O)₄(μ₃-OH)₄(OH)₄(H₂O)₄(TBAPy)₂], PCN-250 [Fe₃O(ABTC)₆ or (Fe₃O)₂(ABTC)₃ or (Fe₃O)₂(ABTC)₃—(OH)₂(H₂O)₄], PCN-777 [Zr₆O₄(μ₃-OH)₄(TATB)₂(OH)₆(H₂O)₆ or Zr³O₄(OH)(TATB)(H₂O)₆], UiO-66 [Zr₆(O)₄(OH)₄(BDC)₁₂], UiO-66 [Zr₆O₄(OH)₄(BDC)₆], UiO-66-DOBDC [Zr₆O₄(OH)₄(DOBC)₆], UiO-66-NH₂ [Zr₆O₄(OH)₄(NH₂—BDC)₆], UiO-66-OH [Zr₆O₄(OH)₄(OH-BDC)₆], or UiO-67 [Zr₆O₄(OH)₄(BPDC)₆]. In some embodiments, any of these is modified to include one or more hydroxy groups or additional hydroxy groups (e.g., if a hydroxy group is already present). In some embodiments, the hydroxy group is provided on the organic ligand.

In some embodiments, MOFs are provided in any useful form, e.g., particles, crystals, powders, and the like. In some embodiments, the MOF particles include MIL-101-Fe, MIL-101-Al, MIL-125-Ti, PCN-250, UiO-66, UiO-67, or any combination or mixture thereof. In some embodiments, the MOF particles are water-stable.

In some embodiments MOF substrates are processed under a variety of synthetic conditions to yield different pore sizes and porosities. In some embodiments, the MOF substrate is a mesoporous or a macroporous MOF material. In general and without wishing to be bound by theory, higher pore opening size facilitate increased surface area, increasing the number of exposed active sites on which post-synthetic modification can occur. Increased exposed active sites facilitates higher concentrations of the adsorbing moiety on the MOF substrate, which in turn enables higher CO₂ capture capacity in some embodiments.

In some embodiments, the MOF substrate includes pores, which are openings that extend into the interior volume of the MOF substrate. The pores increase the surface area of the MOF substrate. The dimensions of the pores vary, and can vary within an individual pore. Mesoporous and macroporous MOF materials allow for a large volume of adsorbing moieties (e.g., amines moieties) to be incorporated into the porous matrix. In some embodiments, a mesoporous material includes pores having a greatest opening dimension (e.g., a diameter) in a range from 2 nanometers (nm) and 50 nm, and a macroporous material includes pores having a greatest opening dimension greater than 50 nm. In some embodiments, for a MOF substrate, pore dimension, pore volume, and/or total surface area are any described herein (e.g., a pore dimension from a range from 30 to 400 Å or greater than 90 Å; a pore volume from 0.5 to 5 mL/g; and/or a total surface area greater than 100 m²/g).

In some embodiments the MOF substrate is functionalized to provide a functional portion having an adsorbing moiety. In some embodiments, the adsorbing moiety is an amine moiety (e.g., a primary, secondary, or tertiary amine group, as described herein). In some embodiments, the amine moieties bind to the surface of the MOF from which the hydroxy functional side groups extend. In this example, the interaction moiety includes any that reacts with hydroxy groups present on the surface of the MOF. Non-limiting interaction moieties can be, e.g., a silane moiety (e.g., any described herein). By forming interactions between the interaction moiety and the surface, amine bonding stability and/or lifetime of the sorbent is improved in some embodiments. The functionalization methods herein can be applicable to all form factors of the MOF substrates.

In some embodiments, an aminosilane is on the MOF surface. In some embodiments, this aminosilane includes a silane moiety (e.g., a trimethoxysilane moiety, a triethoxysilane moiety, a dimethoxyethoxysilane moiety, a diethoxymethoxysilane moiety, and the like) and an amine moiety. In some embodiments, the aminosilane includes one, two, or three amine moieties (e.g., any described herein for R^{A}). In some embodiments, the aminosilane has a structure having formula [R^{A}]₃SiX, where each R^{A} is, independently, an amine moiety comprising at least one amine group (e.g., any described herein) and X is a side group, a reactive group, or a leaving group (e.g., any described herein). In some embodiments, the aminosilane includes a structure having formula [R^{N1}R^{N2}N]₃SiX, where each of R^{N1} and R^{N2} is, independently, any described herein (e.g., optionally substituted aliphatic, alkyl, aromatic, or aryl); and X is a side group, a reactive group, or a leaving group (e.g., any described herein, such as halo, hydroxy, and the like). In some embodiments, the aminosilane is or includes tris(ethylmethylamino)chlorosilane. Other examples of aminosilanes include any described herein (e.g., an aminosilane including a structure having formula I).

In some embodiments, the aminosilane is on the surface of the MOF, where the aminosilane interacts with a hydroxy group present on an organic ligand within the MOF. In some embodiments, the organic ligand interacts with (e.g., binds to) the metal center within the MOF, and the hydroxy group is unbound from the metal center. In particular embodiments, the silane moiety of the aminosilane interacts with (e.g., binds to or/reacts with) the hydroxy group present on the organic ligand.

In some non-limiting embodiments, the substrate 102A, 102B, 102C is a MOF substrate, and the pores 104A-a,b, 104B-a,b, 104C-a,b, represent pores provide by the MOF structure. In some non-limiting embodiments, the substrate 102A, 102B, 102C is composed of crystalline, nanoporous MOF.

c. Resin

Ion-exchange resins generally possess a porous structure that can provide a large surface area for the exchange of ionic compounds. In some embodiments, to provide a functionalized resin, functional portion-containing compounds are adsorbed within the pores and interact with reactive moieties present within such pores. Such interactions include ionic bonding interactions, hydrogen bonding interactions, and/or van der Waals force interactions, and the like. In some embodiments, this process is conducted with multiple types of ion-exchange resin having various types of reactive sites, such as polystyrene sulfonate (e.g., in which the sulfonic acid in the ion-exchange resin includes an acidic reactive site that forms ionic bonds with various amines through ionic bonding). In some embodiments, resin substrates are used as a porous structure for functionalization to achieve carbon capture. In particular embodiments, reactive sites present in the resin are employed during functionalization.

In some embodiments, the substrate comprises a resin (e.g., an ion-exchange resin). Any methods or compounds herein are used to functionalize a resin substrate to provide a functionalized resin. For example and without limitation, in some embodiments a functionalized resin features amine moieties that are bound to acidic reactive sites present on the surface, thereby allowing for CO₂ uptake. In some embodiments the amine moiety is provided by any compound described herein (e.g., a polyamine) for increased carbon capture (e.g., >1 mol CO₂/kg or from 1 to 3 mol CO₂/kg).

In some embodiments, the substrate comprises an ion-exchange resin (e.g., ion-exchange resin particles). In some embodiments, the ion-exchange resin is sufficiently cross-linked to retain porosity sufficient to facilitate gas diffusion and adsorption when dry.

In general, a resin substrate is a portion of an ion-exchange resin that is sourced from standard industrial sources. Non-limiting types of ion-exchange resins include a “weak base” functionalized resin, an “acid” functionalized resin such as those with carboxylic or sulfonic acid groups, and a neutral resin with no chemical functionalization.

In these types, different molecular interactions are used to retain the introduced amine moieties. In weak base resins, amine moieties are present in the resin and serve as reactive sites. In turn, these reactive sites interact (e.g., by way of hydrogen bonding) with adsorbing moieties that are introduced during functionalization (e.g., by introducing a polyamine, a monoamine, an aminosilane, and the like). In acidic resins, acidic moieties are present as reactive sites in the resin. In some embodiments, introduction of an amine (e.g., a polyamine, a monoamine, an aminosilane, etc.) to this resin results in acid-base reactions, which can form ionic bonds between the reactive sites and the amine. In neutral resins, van der Waals forces and entrapment of larger amines within resin pores are the primary interactions. Without wishing to be limited by theory, in some embodiments ionic bonding interactions with an acidic resin provides the highest bonding strength, relative to the other bonding modes; hydrogen bonding with a weak base rein has less strength than the ionic bonding; and van der Waals forces with neutral resins have the lowest bonding strength, relative to the other two bonding modes.

Ion-exchange resins are a class of porous polymers that includes polystyrene (e.g., optionally crosslinked with divinylbenzene), polyacrylate, polymethacrylate (e.g., optionally crosslinked with divinylbenzene), polyphenols/phenol-aldehyde resins (e.g., phenol-formaldehyde), melamine resins, agarose, cellulose, polyacrylamides, polycarbohydrates (e.g., dextrans), polyolefins, or similar resins and thermosets, as well as crosslinked forms of any of these or copolymers of any of these.

In some embodiments, resins include ionizable, chelating, ionic, acidic, or basic functional groups, which can interact with ions. In some embodiments, these functional groups include, but are not limited to, carboxylic acids, phosphonic acids, sulfonic acids, sulfoalkyl acids, thiols, iminodiacetic acid, thiourea, aminophosphonic acids, pyridines, phenols, picolylamines, primary amines, secondary amines, tertiary amines, quaternary amines, and alcohol amines.

Any useful resin is employed in some embodiments. Non-limiting examples of resin include a base-functionalized resin, an acid-functionalized resin, or a neutral resin including no chemical functionalization. In some embodiments, the acid-functionalized resin include carboxylic and/or sulfonic acid groups. In some embodiments, the resin is a porous polystyrene, polyacrylamide, or phenol-formaldehyde resin that retains its porosity when dry combined with a molecular alkyl amine. Non-limiting examples of porous ion-exchange resins include, but are not limited to, PUROLITE® A110 (polystyrenic macroporous, weak base anion resin, free base form, having a primary amine as a functional group), PUROLITE® A105 (polystyrenic macroporous, weak base anion resin, free base form, having a tertiary amine as a functional group), PUROLITE® C145H (polystyrenic macroporous, strong acid cation resin, hydrogen form, having sulfonic acid as a functional group), PUROLITE® C160H (polystyrenic macroporous, strong acid cation resin, hydrogen form, having sulfonic acid as a functional group), PUROLITE® MACRONET™ MN502 (hyper-crosslinked polystyrenic macroporous, adsorbent resin, strong acid functionality, hydrogen form, having sulfonic acid as a functional group), PUROLITE® C104Plus (polyacrylic porous, weak acid cation resin, hydrogen form, having carboxylic acid as a functional group), PUROSORB™ PAD900 (polydivinylbenzene macroporous, adsorbent resin, non-ionic form), AMBERLITE® IRA-402 (strongly basic anion exchanger, Cl⁻ form, having quaternary ammonium as a functional group), or DOWEX® 50W-X8 (strongly acidic cation exchanger, H⁺ form, having sulfonic acid as a functional group). Resins can be provided in any useful form, e.g., beads, granules, powders, membranes, fibers, particles, crystals, and the like.

In some embodiments, resins are sufficiently porous to facilitate diffusion of gaseous ions into and out of the polymeric matrices. Some resins are highly crosslinked and rigid and retain porosity in a dry state (e.g., a hydration of <15% (wt/wt) of water). The term “(wt/wt)” is in reference to a ratio of the weight (wt) of a first component to the weight of a second component. For example, 1 gram of a first substance and 10 grams of a second substance defines a 10% (wt/wt) ratio of the first substance to the second substance.

In some embodiments, the resin substrate is porous in the dry state. Without wishing to be limited by mechanism, such substrates can facilitate diffusion of gas containing CO₂ into the polymeric matrix for CO₂ capture. Ion-exchange resins can be polymerized under a variety of synthetic conditions to yield different pore sizes and porosities. Larger meso- and macro-pores can allow for a large volume of adsorbing groups to be incorporated into the porous matrices. In some embodiments, a mesoporous resin includes pores having a greatest opening dimension (e.g., diameter) in a range from 2 to 50 nm; and a macroporous resin includes pores having a greatest opening dimension greater than 50 nm.

In general and without wishing to be bound by theory, proper pore size (e.g., as in a sorbent with pores in any range herein) can be characterized by high surface areas, pore volumes, and channels for gas diffusion that allows for a stable coating or surface functionalization layer, relatively higher concentrations of adsorbing moieties (e.g., active amines), and/or fast gas kinetics. This, in turn, could enable higher CO₂ capture capacity. In some embodiments, higher porosity can reduce the adsorption process energy cost for a fluidization process.

In some embodiments, the resin substrate includes pores, which are openings that extend into the interior volume of the resin substrate. In some embodiments, the pores increase the surface area of the resin substrate. For a resin substrate, pore dimension, pore volume, and/or total surface area is any described herein (e.g., a pore dimension greater than 90 Å or in a range from 60 to 400 Å or 1 to 200 nm; an average pore size in a range from 30 to 80 nm; a pore volume greater than 0.5 mL/g or in a range from 0.1 to 5 mL/g, 0.1 to 4 mL/g, or 0.1 to 1.5 mL/g; and/or a total surface area greater than 100 m²/g, greater than 1200 m²/g, or in a range from a range from 100 to 1200 m²/g).

In some embodiments, the resin substrate is functionalized to provide a functional portion having an adsorbing moiety. In some embodiments, the adsorbing moiety is an amine moiety (e.g., a primary, secondary, or tertiary amine group, as described herein). In some embodiments, the amine moieties bind to the reactive sites of the resin. In some embodiments, the interaction moiety includes any that reacts with reactive sites present on the surface of the resin. Non-limiting interaction moieties are, e.g., an amine moiety (e.g., any described herein). In some embodiments, the resin includes a first amine moiety, and the reaction introduces a second amine moiety bonded to the first. By forming interactions between the interaction moiety and the surface, amine bonding stability and/or lifetime of the sorbent is improved in some embodiments. The functionalization methods herein can be applicable to all form factors of the ion-exchange resins.

### ii. Functional Portion

In some embodiments, the functional portion includes any combination of moieties, groups, or compounds to facilitate adsorption of desired gases by the sorbent. In some embodiments, the functional portion includes an adsorbing moiety and an interaction moiety. Whereas the adsorbing moiety is configured to adsorb a desired gas, the interaction moiety is configured to attach (directly or indirectly) the adsorbing moiety to the substrate surface. Optionally, the interaction moiety is further configured to stabilize the functional portion, such as by forming bonds with the adsorbing moiety and/or the substrate surface. In another optional embodiment, the interaction moiety further provides an additional adsorbing moiety to enhance adsorption of the sorbent. In some embodiments, the functional portion includes any useful combination of one or more adsorbing moieties (e.g., one or more amine moieties) with one or more interaction moieties (e.g., one or more silane moieties). In some embodiments, when a plurality of amine moieties is present (e.g., when a first amine moiety and a second amine moiety are present), such moieties react with or bind to carbon dioxide.

As seen in FIGS. 1A-1C, in some embodiments the surface 103A-C of the substrate 102A-C is functionalized to provide a functional portion 106A-C. In some embodiments (e.g., as in FIG. 1A), the functional portion 106A includes an interaction moiety 108A bonded to an adsorbing moiety 110A. In some embodiments (e.g., as in FIG. 1C), the functional portion 106B includes an interaction moiety 108B bonded to a first adsorbing moiety 110B and includes a second adsorbing moiety 112B associated with the interaction moiety 108B and/or the first adsorbing moiety 110B. In some embodiments (e.g., as in FIG. 1C), the functional portion 106C includes an adsorbing moiety.

In some embodiments, the functional portion includes an adsorbing moiety. In some embodiments, the adsorbing moiety includes one, two, three, or more amine moieties (e.g., any described herein). In some embodiments, the amine moiety includes one or more of the following: a primary amine (e.g., —NH₂), a secondary amine (e.g., —NHR^{N1}, in which R^{N1} can be any described herein that is not hydrogen), a tertiary amine (e.g., —NR^{N1}R^{N2}, in which each of R^{N1} and R^{N2} can be any described herein that is not hydrogen), an aminoalkyl group (e.g., -Ak-NR^{N1}R^{N2}), a terminal amine group (e.g., —NR^{N1}R^{N2}), an internal amine group (e.g., —NR^{N3}—, such as —NH—), a linked group (e.g., —N(-L¹-NR^{N1}R^{N2})—; —N(-L²-NR^{N3}-L-NR^{N1}R^{N2})—; —N[-L²-N(-L¹-NR^{N1}R^{N2})₂]—; -L¹-NR^{N1}R^{N2}; —NR^{N3}-L¹-NR^{N1}R^{N2}; -L²-NR^{N3}-L¹-NR^{N1}R^{N2}; NR^{N4}-L²-NR^{N3}-L¹-NR^{N1}R^{N2}; or -L³-NR^{N4}-L²-NR^{N3}-L¹-NR^{N1}R^{N2}), an aminoalkylamino group (e.g., —NR^{N3}-Ak-NR^{N1}R^{N2}) an aminoalkylaminoalkyl group (e.g., -Ak-NR^{N3}-Ak-NR^{N1}R^{N2} or -Ak-N(-Ak-NR^{N1}R^{N2})₂), a linked group including amino and silane groups (e.g., -L¹-SiR^{S1}R^{S2}—NR^{N1}R^{N2}, -L²-SiR^{S1}R^{S2}-L¹-NR^{N1}R^{N2}, and L³-SiR^{S1}R^{S2}-L²-NR^{N3}L¹-NR^{N1}R^{N2}), a nitrogen-containing heterocyclyl (e.g., optionally substituted piperazinyl, such as unsubstituted piperazinyl or piperazinyl substituted with optionally substituted alkyl, aminoalkyl, hydroxyalkyl, amino, etc.), and the like.

In other embodiments, the adsorbing moiety includes one or more R^{A} moieties described herein. In some embodiments, R^{A} is or includes —NH—, —NR^{N1}—, —N(-L¹-NR^{N1}R^{N2})—, —N(-L²-NR^{N3}-L¹-NR^{N1}R^{N2})—, —N[-L²-N(-L¹-NR^{N1}R^{N2})₂]—, —NH₂, —NR^{N1}R^{N2}—, -L1-NR^{N1}R^{N2}, —NR^{N3}-L¹-NR^{N1}R^{N2}, -L²-NR^{N3}-L¹-NR^{N1}R^{N2} or —NR^{N4}-L²-NR^{N3}-L¹-NR^{N1}R^{N2}.

The amine moiety includes any combination of linkers and R^{A} moieties. In some implementations, the amine moiety includes one or more of the following: -L¹-[R^{A1}-L²]ₙ₁-R^{A2}; NR^{N1}-[L¹-NR^{N2}]ₙ₁-L²-NR^{N3}R^{N4}; —NH-[L-NH]ₙ—H; -N[L-NH₂]₂; —NH[CH₂CH₂NH]ₙH; —[CH₂CH₂NH]ₙR^{N1}; —[CH₂CH₂NH]ₙ—; —[CH₂CH₂NR^{A}]ₙR^{N1}; —[CH₂CH₂NR^{A}]ₙ—; and the like.

In some non-limiting embodiments for any amine moiety herein, each of R^{A}, R^{A1} or R^{A2} is or includes any described herein for R^{A}; each of R^{N1} and R^{N2} can be any described herein; each of R^{N3}, R^{N4}, and R^{N5} can be any described herein for R^{N1} and R^{N2}; each of R^{S1} and R^{S2} can be any described herein; each of L, L¹, L², or L³ is independently a linker; each Ak is independently optionally substituted alkylene; and each of n and n1 is independently an integer (e.g., an integer of 1 or more, such as from 1-25000, 1-24000, 1-23000, 1-22000, 1-21000, 1-20000, 1-19000, 1-18000, 1-17000, 1-16000, 1-15000, 1-14000, 1-13000, 1-12000, 1-11000, 1-10000, 1-7500, 1-5000, 1-4000, 1-3000, 1-2000, 1-1000, 1-500, 1-100, 1-50, 1-20, 1-10, 1-5, 2-25000, 2-24000, 2-23000, 2-22000, 2-21000, 2-20000, 2-19000, 2-18000, 2-17000, 2-16000, 2-15000, 2-14000, 2-13000, 2-12000, 2-11000, 2-10000, 2-7500, 2-5000, 2-4000, 2-3000, 2-2000, 2-1000, 2-500, 2-100, 2-50, 2-20, 2-10, 2-5, 5-25000, 5-24000, 5-23000, 5-22000, 5-21000, 5-20000, 5-19000, 5-18000, 5-17000, 5-16000, 5-15000, 5-14000, 5-13000, 5-12000, 5-11000, 5-10000, 5-7500, 5-5000, 5-4000, 5-3000, 5-2000, 5-1000, 5-500, 5-100, 5-50, 5-20, 5-10, as well as ranges therebetween).

In some embodiments, R^{A}, R^{A1}, or R^{A2} is or includes —NH—, —NR^{N1}—, —N(-L¹-NR^{N1}R^{N2}), —N(-L²-NR^{N3}-L¹-NR^{N1}R^{N2})—, —N[-L²-N(-L¹-NR^{N1}R^{N2})₂]—, —NH₂, —NR^{N1}R^{N2}, -L¹-NR^{N1}R^{N2} —, —NR^{N3}-L¹-NR^{N1}R^{N2}, -L²-NR^{N3}-L¹-NR^{N1}R^{N2}, or —NR^{N4}-L²-NR^{N3}-L¹-NR^{N1}R^{N2}.

In some embodiments, each of R^{N1}, R^{N2}, R^{N3}, R^{N4}, and R^{N5} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, R^{N3}, R^{N4}, R^{N5}, and R is, independently, H, optionally substituted aliphatic, optionally substituted heteroaliphatic, optionally substituted aromatic, or optionally substituted heteroaromatic.

In some embodiments, each of R^{S1} and R^{S2} is, independently, a side group (e.g., any described herein), a leaving group (e.g., halo, acyl, acyloxy, and the like), a reactive group (e.g., hydroxy, halo, alkoxy, and the like), hydrogen (H), optionally substituted alkyl, optionally substituted heteroalkyl, optionally substituted aryl, optionally substituted amine, or an R^{A} moiety (e.g., any described herein); or R^{S1} and R^{S2}, taken together with the silicon atom to which each are attached, form a heterocyclyl group. In some embodiments, each of R^{S1} and R^{S2} is independently hydrogen (H), optionally substituted aliphatic, optionally substituted heteroaliphatic, optionally substituted aromatic, or optionally substituted heteroaromatic.

In some embodiments, the linker includes, for example, a covalent bond, an atom (e.g., carbonyl, oxy, thio, imino, and the like), optionally substituted alkylene, optionally substituted heteroalkylene, optionally substituted arylene, or optionally substituted heteroarylene.

In some embodiments, the functional portion includes an interaction moiety. In some embodiments, the interaction moiety includes one, two, three, or more silane moieties (e.g., any described herein). In some embodiments, the interaction moiety comprises one or more Si—O bonds.

In some embodiments, the silane moiety includes an alkoxysilane group (e.g., —Si(OAk)_{d}(X)_{3-d} or —Si(OAk)_{d1}(X)_{2-d1}— or —Si(OAk)_{d}(X)_{2-d}R^{A}); a trialkoxysilane group (e.g., —SiR^{S1}R^{S2}R^{S3}, in which each of R^{S1}, R^{S2}, and R^{S3} is, independently, alkoxy; such as trimethoxysilane or triethoxysilane); a dialkoxysilane group (e.g., e.g., —SiR^{S1}R^{S2}R^{S3} or —SiR^{S1}R^{S2}—, in which each of R^{S1} and R^{S2} is, independently, alkoxy, and a R^{S3} is a side group, a leaving group, a reactive group, or any described herein); a monoalkoxysilane group (e.g., —SiR^{S1}R^{S2}R^{S3} or —SiR^{S1}R^{S2}—, in which R^{S1} is alkoxy, and each of R^{S2} and R^{S3} is independently a side group, a leaving group, a reactive group, or any described herein); a dialkoxysilanol group (e.g., —Si(OR)₂OH, in which each R is independently alkyl); a monoalkoxysilanol group (e.g., —Si(OR)(R^{S1})OH, in which each R is independently alkyl and R^{S1} is a side group, a leaving group, a reactive group, or any described herein); a hydrosilane group (e.g., —SiH₃ or —SiH₂—); a monoalkylsilane group (e.g., —SiR^{S1}R^{S2}R^{S3} or —SiR^{S1}R^{S2}—, in which R^{S1} is alkyl, and each of R^{S2} and R^{S3} is independently a side group, a leaving group, a reactive group, or any described herein; in which non-limiting examples of monoalkylsilane is alkyldialkoxysilane or alkyldihalosilane); a dialkylsilane group (e.g., —SiR^{S1}R^{S2}R^{S3} or —SiR^{S1}R^{S2}—, in which each of R^{S1} and R^{S2} is independently alkyl, and R^{S3} is a side group, a leaving group, a reactive group, or any described herein; in which non-limiting examples of dialkylsilane includes dialkylalkoxysilane or dialkylhalosilane); a trihalosilane group (e.g., —SiZ₃, in which each Z is independently halo, such as trichlorosilane); a dihalosilane group (e.g., —SiZ₂R^{S1}, in which each Z is independently halo and each of R^{S1} is a side group, a leaving group, a reactive group, or any described herein); a monohalosilane group (e.g., —SiZR^{S1}R^{S2}, in which Z is halo and each of R^{S1} and R^{S2} is independently a side group, a leaving group, a reactive group, or any described herein); a silanetriol group (e.g., —Si(OH)₃); or a hydroxysilane group (e.g., —Si(OH)R^{S1}—, —Si(OH)₂—, or —Si(OH)₃).

In some non-limiting embodiments for any silane moiety herein, Ak is optionally substituted aliphatic, alkyl, or alkylene; each X is, independently, a side group, a reactive group, or a leaving group, as any described herein; d is an integer of 1, 2, or 3; and d1 is an integer of 1 or 2. In some embodiments, each of R^{S1}, R^{S2}, and R^{S3} is, independently, a side group (e.g., any described herein), a leaving group (e.g., halo, acyl, acyloxy, and the like), a reactive group (e.g., hydroxy, halo, alkoxy, and the like), hydrogen (H), optionally substituted alkyl, optionally substituted heteroalkyl, optionally substituted aryl, optionally substituted amine, or an R^{A} moiety (e.g., any described herein); or R^{S1} and R^{S2}, taken together with the silicon atom to which each are attached, form a heterocyclyl group. In some embodiments, each of R^{S1} and R^{S2} is independently hydrogen (H), optionally substituted aliphatic, optionally substituted heteroaliphatic, optionally substituted aromatic, or optionally substituted heteroaromatic.

In some embodiments, any useful combination of moieties is present. For example, in some embodiments, the functional portion includes a combination of one or more adsorbing moieties, a combination of one or more interaction moieties, a combination of an adsorbing moiety with an interaction moiety, and a combination of one or more adsorbing moieties with one or more interaction moieties.

In some embodiments, the functional portion is provided in any useful manner. For example, in some embodiments, a compound having both the adsorbing moiety and the interaction moiety is provided to a substrate. A non-limiting example of such a compound includes an aminosilane comprising an amino moiety (e.g., as the adsorbing moiety) and a silane moiety (e.g., as the interaction moiety). In some embodiments, the compound has a long-chain multi-amine containing moiety. In some embodiments, the compound has a silane moiety, which is chemically bonded to a surface of each of the particles (e.g., porous silica particles) serving as the substrate.

In another example, a plurality of compounds is used to provide the one or more adsorbing moieties and one or more interaction moieties. For instance, in some embodiments, a first compound includes both an adsorbing moiety and an interaction moiety, and a second compound includes one or more adsorbing moieties. A non-limiting example includes a first compound that is an aminosilane comprising an amino moiety (e.g., as the adsorbing moiety) and a silane moiety (e.g., as the interaction moiety) that is used in combination with a second compound that is a polyamine comprising a plurality of amino moieties (e.g., as the adsorbing moieties). In some embodiments, the first compound is attached to a surface of the substrate (e.g., by way of one or more covalent bonds or non-covalent bonds), and the second compound is or is not attached to the substrate. In some embodiments, the second compound interacts with the first compound (or a portion thereof). In some embodiments, the second compound interacts with the first compound (or a portion thereof) and with the substrate surface. In some embodiments, such attachments and interactions include covalent and/or non-covalent bonding interactions. Non-covalent bonding interactions include, without limitation, hydrogen bonding, ionic interactions, halogen bonding, electrostatic interactions, η bond interactions, hydrophobic interactions, inclusion complexes, clathration, van der Waals interactions, and combinations thereof.

Upon providing one or more compounds to a substrate, reactions can occur to provide covalent and/or non-covalent bonding interactions, thereby providing a functional portion disposed on the substrate surface. Non-limiting examples of compounds for providing a functional portion include amines, aminosilanes, polymers, polyamines, as well as others described herein.

a. Aminosilanes

In some embodiments, the compound is an aminosilane. For example and without limitation, the substrate surface (e.g., a silica substrate surface) is functionalized with an aminosilane compound including a silane moiety bonded to an amine moiety. In turn, in some embodiments, the surface includes a functional group having the silane moiety and the amine moiety. As used herein, such moieties also include reacted forms of these moieties (e.g., a reacted form of a silane moiety upon reacting with a surface of the substrate) that may be present upon forming one or more bonds, as would be understood by a skilled artisan.

In some embodiments, the aminosilane include at least one silane moiety (e.g., one, two, three, or more silane moieties) and at least one amine moiety (e.g., one, two, three, or more amine moieties). Non-limiting examples of aminosilane compounds, silane moieties, and amine moieties are described herein.

In some embodiments, the aminosilane compound includes one, two, three, or more silane moieties. In some embodiments, the silane moiety includes a trialkoxysilane (e.g., —SiR^{S1}R^{S2}R^{S3}, in which each of R^{S1}, R^{S2}, and R^{S3} is, independently, alkoxy; such as trimethoxysilane or triethoxysilane), a dialkoxysilane (e.g., —SiR^{S1}R^{S2}R^{S3}, in which each of R^{S1} and R^{S2} is, independently, alkoxy, and R^{S3} is a leaving group or a reactive group, such as any described herein), a dialkoxysilanol group (e.g., —Si(OR)₂OH, in which each R is independently alkyl), a hydrosilane group (e.g., —SiH₃), a monoalkylsilane group (e.g., —SiR^{S1}R^{S2}R^{S3}, in which R^{S1} is alkyl, and each of R^{S2} and R^{S3} is independently a leaving group or a reactive group, such as any described herein; in which non-limiting examples of monoalkylsilane is alkyldialkoxysilane or alkyldihalosilane), a dialkylsilane group (e.g., —SiR^{S1}R^{S2}R^{S3}, in which each of R^{S1} and R^{S2} is independently alkyl, and R^{S3} is a reactive group or a leaving group, such as any described herein; in which non-limiting examples of dialkylsilane includes dialkylalkoxysilane or dialkylhalosilane), a trihalosilane group (e.g., —SiZ₃, in which each Z is independently halo, such as trichlorosilane), or a silanetriol (e.g., —Si(OH)₃). In some embodiments, higher numbers (e.g., three or more) of silane moieties in the aminosilane compound increase the covalent bond stability with the substrate as higher numbers of siloxane bonds between the silane moieties and the substrate surface can increase. Additionally, in some embodiments, a silane group forms up to three siloxane bonds (Si—O—Si) to the surface, which increases stability. In some embodiments, the number of siloxane bonds that are formed by silane moiety depends on the composition of the side groups (e.g., one or more of X¹, X², and/or X³) capable of forming siloxane bonds (e.g., —OMe, —OEt, —Cl, —OH, or a combination of any of these).

In some embodiments, the aminosilane compound includes one, two, three, or more amine moieties. In some embodiments, the amine moiety includes a primary amine (e.g., —NH₂), a secondary amine (e.g., —NHRN¹, in which R^{N1} is any R^{S1} described herein that is not hydrogen), a tertiary amine (e.g., —NR^{N1}R^{N2}, in which each of R^{N1} and R^{N2} is respectively any R^{S1} and R^{S2} described herein that is not hydrogen), or an aminoalkyl group (e.g., -Ak-NR^{N1}R^{N2}, in which Ak is optionally substituted alkylene and each of R^{N1} and R^{N2} is respectively any R^{S1} and R^{S2} described herein). In some embodiments, each of R^{N1} and R^{N2} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety includes more than one amine group connected through various linkers (e.g., any described herein for L). For instance, in some embodiments, the amine moiety includes a terminal amine group (e.g., —NR^{N1}R^{N2}), one or more internal amine groups (e.g., —NR^{N3}—), and a linker (e.g., -L-) disposed between the terminal and internal amine groups, where R^{N1}, R^{N2}, and R^{N3} are respectively any R^{S1}, R^{S2}, and R^{S3} described herein. Non-limiting examples of amine moieties include an aminoalkylamino group (e.g., —NR^{N3}-Ak-NR^{N1}R^{N2}, in which Ak is optionally substituted alkylene and each of R^{N1}, R^{N2}, and R^{N3} is respectively any R^{S1}, R^{S2}, and R^{S3} described herein) or an aminoalkylaminoalkyl group (e.g., -Ak-NR^{N3}-Ak-NR^{N1}R^{N2}, in which each Ak is independently optionally substituted alkylene and each of R^{N1}, R^{N2}, and R^{N3} is respectively any R^{S1}, R^{S2}, and R^{S3} described herein described herein). In some embodiments, each of R^{N1}, R^{N2}, and R^{N3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR³, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, R^{N3} and R is, independently, H, optionally substituted aliphatic, optionally substituted heteroaliphatic, optionally substituted aromatic, or optionally substituted heteroaromatic.

In some embodiments, higher numbers (e.g., three or more) of amine moieties in the aminosilane compound increase the adsorption ability of a sorbent. In some embodiments, amine moieties interact with other moieties and groups to stabilize stability of the functional group.

In some embodiments, an amine moiety (e.g., amine groups) of one aminosilane interacts with a neighboring aminosilane (e.g., with silane moieties or side groups within a silane moiety of the neighboring aminosilane). Alternatively, an amine moiety of one aminosilane does not interact with a neighboring aminosilane (e.g., does not interact with silane moieties or side groups within a silane moiety of the neighboring aminosilane). In yet another embodiment, an amine moiety of one aminosilane interacts with other groups, moieties, or compounds (e.g., present in another compound, such as a polyamine or another type of aminosilane). In some embodiments, an amine moiety (e.g., which can be an amine group) of the aminosilane interacts with a polyamine (e.g., an amine moiety of a polyamine).

In some embodiments, the aminosilane compound has any useful structure. In one non-limiting example, the aminosilane includes a structure having formula (I):

[R^{A}]ₙSi[X]₄₋ₐ (I),

where each R^{A} is, independently, an amine moiety comprising at least one amine group, each X is, independently, a side group, a reactive group, or a leaving group, and a is an integer from 1 to 4.

In some embodiments, the amine moiety (e.g., R^{A}) includes one or more amine groups. In one instance, the amine group is —NR^{N1}R^{N2} or —NR^{N1}—, in which each of R^{N1} and R^{N2} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR³, in which each R is independently an optionally substituted alkyl), or trialkoxylsilyloxy (e.g., —OSi[OR]₃, in which each R is independently an optionally substituted alkyl). In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety (e.g., R^{A}) includes one, two, three, or more amine groups. In other embodiments, the amine moiety includes a terminal amine group (e.g., as —NR^{N1}R^{N2}) and/or an internal amine group (e.g., as —NR^{N1}—).

Non-limiting examples of amine moieties (e.g., R^{A}) include —NR^{N1}R^{N2}, -L-NR^{N1}R^{N2}, —NR^{N3}-L-NR^{N1}R^{N2}, -L²-NR^{N3}-L¹-NR^{N1}R^{N2}, -L³-NR^{N4}-L²-NR^{N3}-L¹-NR^{N1}R^{N2}, -L²-SiR^{S1}R^{S2}-L¹-NR^{N1}R^{N2} and -L³-SiR^{S1}R^{S2}-L²-NR^{N3}-L¹-NR^{N1}R^{N2}, in which each of R^{N1}, R^{N2}, R^{S1}, and R^{S2} are described herein; in which each of R^{N3} and R^{N4} are described herein for R^{N1} and R^{N2}; and in which each L, L¹, L², or L³ is independently a linker. Non-limiting examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{N1}, R^{N2}, R^{N3}, R^{N4}, R^{S1}, and R^{S2} is, independently, H, optionally substituted aliphatic, or optionally substituted alkyl. Other examples of R^{N1}R^{N2}, and R^{N3} are described herein.

In some embodiments, the aminosilane includes a reactive group, a leaving group, or another group (e.g., X). Non-limiting examples of such groups include H, halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), or optionally substituted alkanoyloxy. In some embodiments, X is, independently, H, optionally substituted aliphatic, optionally substituted heteroaliphatic, optionally substituted aromatic, or optionally substituted heteroaromatic.

In one non-limiting example, the aminosilane includes a structure having formula (Ia):

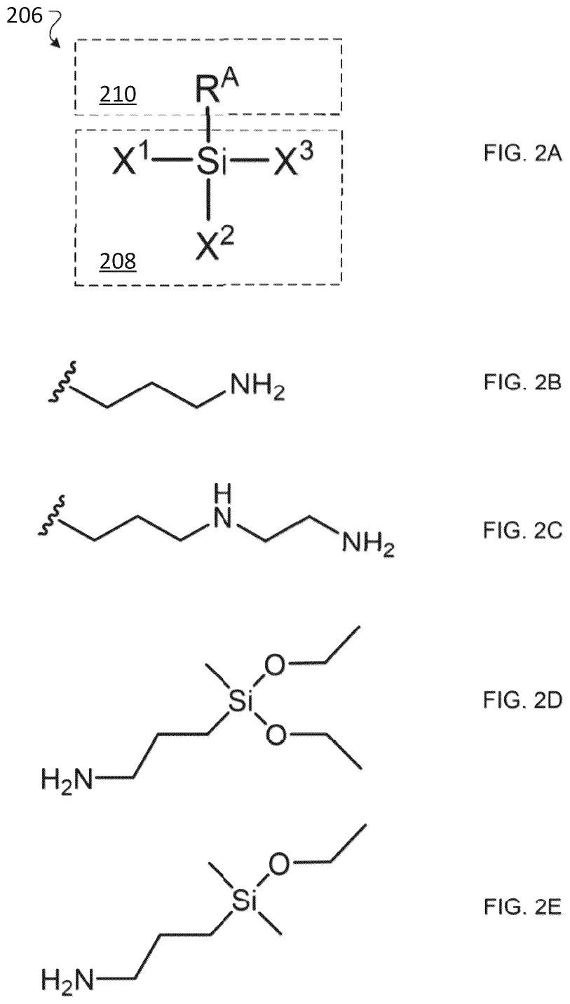

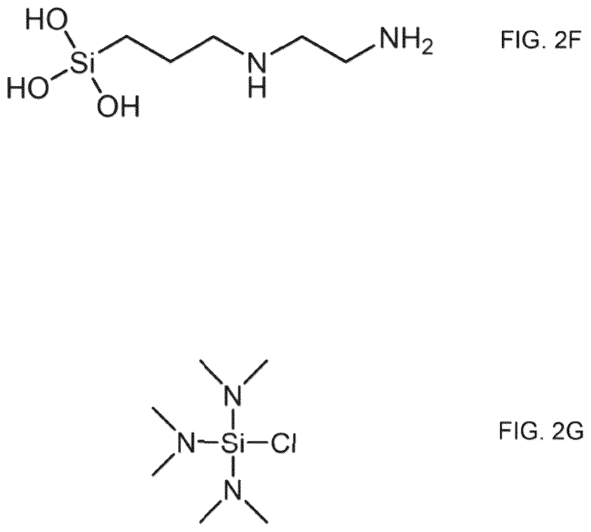

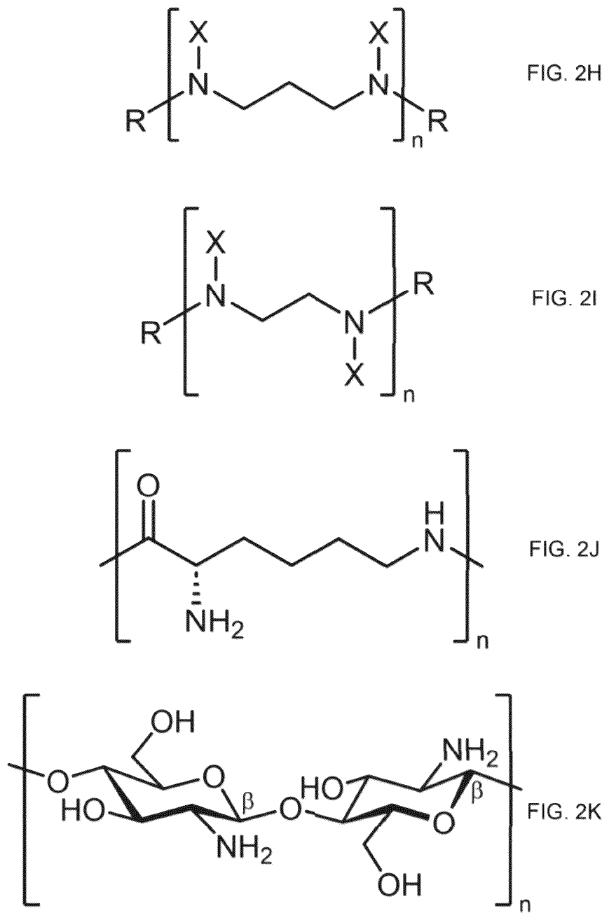

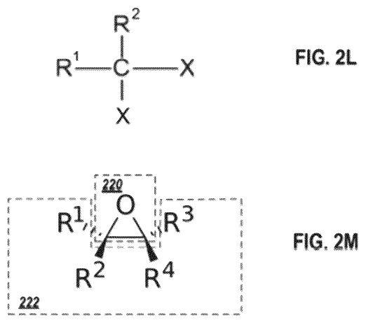

R^{A1}SiX¹X²X³ (Ia),

where R^{A1} is an amine moiety comprising at least one amine group; and each of X¹, X², and X³ is, independently, a side group, a reactive group, or a leaving group. Each of R^{A1}, X¹, X², and X³ is any described herein for R^{A} and X, respectively. An example of formula IA is shown in FIG. 2A (where the terms R^{A1} and R^{A} are interchangeable).

In another non-limiting example, the aminosilane includes a structure having formula Ib, Ic, Id, or Ie:

R^{A1}-L¹-SiX¹X²X³ (Ib),

R^{N1}R^{N2}N-L¹-SiX¹X²X³3 (Ic),

R^{A1}-L¹-R^{A2}-L²-SiX¹X²X³ (Id), or

R^{N1}R^{N2}N-L¹-N(R^{N3})-L²-SiX¹X²X³ (Ie),

where N stands for Nitrogen, each R^{A1} or R^{A2} is, independently, an amine moiety comprising at least one amine group, each of R^{N1}, R^{N2}, and R^{N3} is any described herein, each of X¹, X², and X³ is, independently, a side group, a reactive group, or a leaving group, and each of L¹ and L² is a linker. In some embodiments, each of R^{A1}, R^{A2}, X¹, X², X³, L¹, and L² is any described herein for R^{A}, X, and L, respectively. In some embodiments, each of X¹, X², and X³ is, independently, H, halo, optionally substituted alkyl (e.g., optionally substituted C₁₋₃ alkyl), or optionally substituted alkoxy (e.g., optionally substituted C₁₋₃ alkoxy). In other embodiments, each of X¹, X², and X³ is, independently, optionally substituted alkoxy (e.g., optionally substituted C₁₋₃ alkoxy). In yet other embodiments, L is optionally substituted alkylene (e.g., optionally substituted C₁₋₁₂, C₁₋₁₀, C₁₋₈, or C₁₋₆ alkylene).

In yet another non-limiting example, the aminosilane has the structure of formula If:

R^{A1}R^{A2}R^{A3}SiX¹ (If),

where each R^{A1}, R^{A2}, or R^{A3} is, independently, an amine moiety comprising at least one amine group; and X¹ is a side group, a reactive group, or a leaving group. In some embodiments, each of R^{A1}, R^{A2}, R^{A3}, and X¹ is any described herein for R^{A} and X, respectively.

In some embodiments, the aminosilane has the structure of formula II:

[R^{B}]_{b}N[Y]_{3-b} (II),
where each R^{B} is, independently, a silane moiety comprising at least one silane group, N is nitrogen, each Y is, independently, H, optionally substituted alkyl, or optionally substituted aryl, and b is an integer from 1 to 3. In some embodiments, each Y is, independently, H, optionally substituted aliphatic, optionally substituted heteroaliphatic, optionally substituted aromatic, or optionally substituted heteroaromatic. One example of formula II is illustrated in FIG. 2F. Another example of formula II is illustrated in FIG. 2G.

In some embodiments, the silane moiety (e.g., R^{B}) includes one or more silane groups. In some embodiments, the silane group is —SiR^{S1}R^{S2}R^{S3} or —SiR^{S1}R^{S2}—, in which each of R^{S1}, R^{S2}, and R^{S3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl). In some embodiments, each of R^{S1}, R^{S2}, R^{S3}, and R is, independently, H, optionally substituted aliphatic, optionally substituted heteroaliphatic, optionally substituted aromatic, or optionally substituted heteroaromatic.

In some embodiments, the silane moiety (e.g., R^{B}) includes one, two, three, or more silane groups. In other embodiments, the silane moiety includes a terminal silane group (e.g., as —SiR^{S1}R^{S2}R^{S3}) and an internal silane group (e.g., as —SiR^{S1}R^{S2}—).

Non-limiting examples of silane moieties (e.g., R^{B}) include —SiR^{S1}R^{S2}R^{S3}, —Si(OR^{S1})(R^{S2})(R^{S3}), —Si(OR^{S1})(OR^{S2})(R^{S3}), —Si(OR^{S1})(OR^{S2})(OR^{S3}), -L-SiR^{S1}R^{S2}R^{S3}, -L-Si(OR^{S1})(R^{S2})(R^{S3}), -L-Si(OR^{S1})(OR^{S2})(R^{S3}), -L-Si(OR^{S1})(OR^{S2})(OR^{S3}), —SiR^{S4}R^{S5}-L-SiR^{S1}R^{S2}R^{S3} and —SiR^{S1}R^{S2}—NR^{N1}R^{N2}, in which each of R^{S1}, R^{S2}, R^{S3}, R^{N1}, and R^{N2} is any described herein, in which each of R^{S4} and R^{S5} is any described herein for R^{S1}, R^{S2}, and R^{S3}; and in which L is a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{S1}, R^{S2}, R^{S3}, R^{S4}, R^{S5}, R^{N1} and R^{N2} is, independently, H, optionally substituted aliphatic, or optionally substituted alkyl.

In one non-limiting example, the aminosilane has the structure of formula IIa:

R^{B1}NY¹Y² (IIa),

where N is nitrogen, R^{B1} is a silane moiety comprising at least one silane group (e.g., any described herein for R^{B}) and each of Y¹ and Y² is any described herein for Y (e.g., a side group, a reactive group, or a leaving group).

In another non-limiting example, the aminosilane has the structure of formula IIb, IIc, or IId:

R^{B1}R^{B2}NY¹ (IIb),

[R^{S1}R^{S2}R^{S3}Si-L¹-]NY¹Y² (IIc), or

[R^{S1}R^{S2}R^{S3}Si-L¹-]NY¹[-L²-SiR^{S1}R^{S2}R^{S3}] (IId),

where N is nitrogen, each R^{B1} or R^{B2} is, independently, a silane moiety comprising at least one silane group, each of Y¹ and Y² is, independently, a side group, a reactive group, or a leaving group, each of R^{S1}, R^{S2}, and R^{S3} is any described herein; and each of L¹ and L² is a linker. Each of R^{B1}, R^{B2}, Y¹, Y², L¹, and L² is any described herein for R^{B}, Y, and L, respectively.

FIGS. 2A-2C depict an examples of an aminosilane 206 having an amine moiety 210 (denoted as R^{A}) and a non-limiting silane moiety 208 having three potential interaction sites or side groups (denoted as X¹, X², and X³). Side groups X¹—X³ are occupied by functional groups which include, but are not limited to, a methoxy group (—OMe), an ethoxy group (—OEt), a chloro (—Cl), a hydroxy group (—OH), a hydrogen (—H), or an alkyl group (e.g., a linear alkyl group such as —(CH₂)ₙ(CH₃), in which n is an integer from 0-10; or a branched alkyl group). Yet other examples of functional groups can include any reactive or leaving group described herein. Non-limiting examples of functional groups for X can include halo, as well as optionally substituted aliphatic, alkyl, alkoxy, alkanoyloxy, heteroaliphatic, heteroalkyl, aromatic, aryl, aryloxy, and the like.

In some embodiments, the amine moieties 210 (e.g., which can be amine groups) of one aminosilane interact with one or more of the side groups 208 of a neighboring aminosilane. In alternative embodiments, amine moieties 210 do not interact with other side groups. In yet other embodiments, the amine moieties 210 interact with other groups, moieties, or compounds (e.g., present in another compound, such as a polyamine or another type of aminosilane). In some embodiments, the amine moieties 210 (e.g., which can be amine groups) of aminosilane 208 interact with a polyamine.

Optionally, a further linker is present between the amine moiety and the silane moiety of the aminosilane compound. For example, in some embodiments a linker is present between the amine moiety 210 and the silane moiety 208. In some embodiments, the aminosilane includes R^{A}-L-SiX¹X²X³, in which R^{A} is an amine moiety (e.g., any described herein), L is a linker (e.g., any described herein), and each of X¹, X², and X³ is a side group, a reactive group, or a leaving group (e.g., any described herein).

In some embodiments, an aminosilane 206 has any combination of these functional groups, e.g., amine moiety 210 and side groups 208 (e.g., which can include side group X¹, side group X², or side group X³), and must have at least one amine moiety 210 and at least one side group 208 (e.g., —OMe, —OEt, —Cl, —OH, —H, alkyl, or others described herein) capable of forming a siloxane bond (e.g., an Si—O or Si—O—Si linkage). FIG. 2B is a non-limiting example of a 3-aminopropyl group which, in some examples, serves as one or more side groups 208 (e.g., one or more of X¹, X², and X³) or amine moiety 210. FIG. 2C is an example of an N-(2-aminoethyl)-3-aminopropyl group which, in some examples, serves as one or more amine moieties 210.

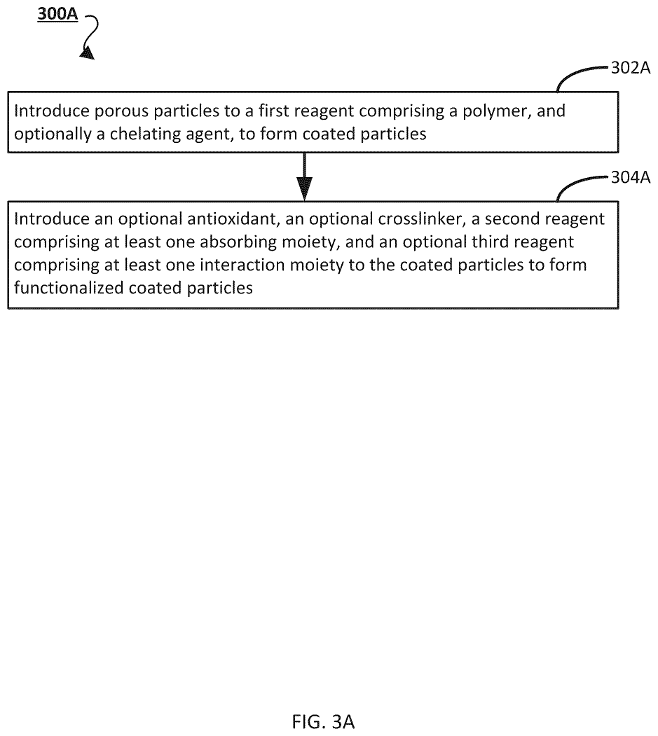

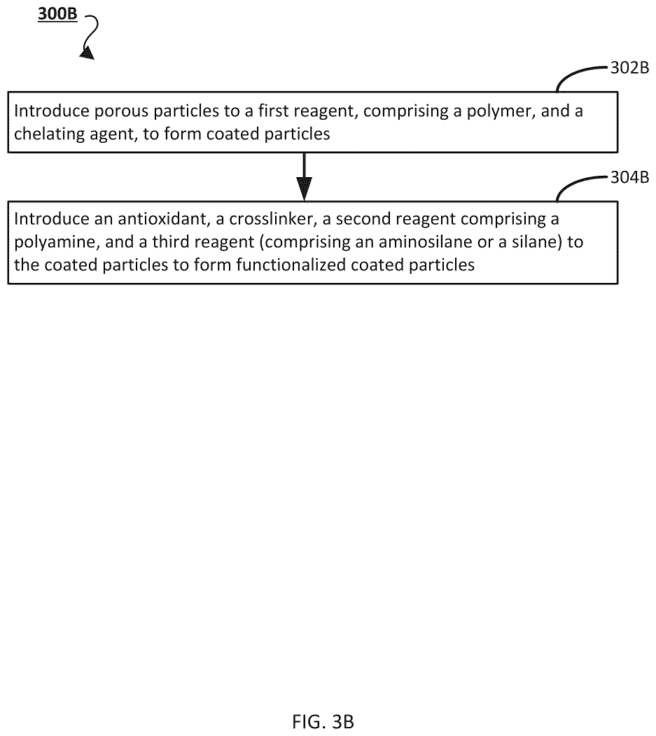

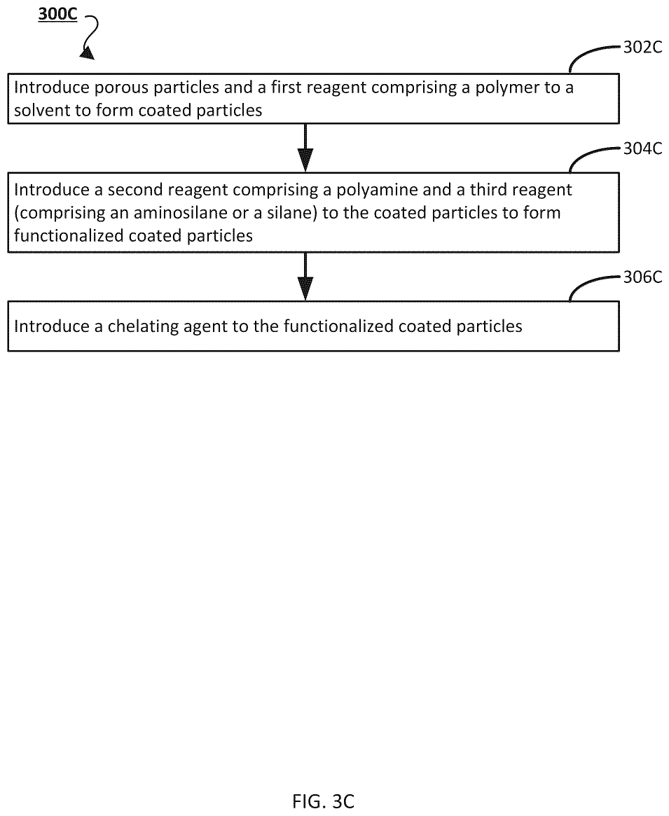

As non-limiting examples, FIGS. 2D-2G indicate examples of aminosilanes having side groups and amine moieties. In some embodiments, the aminosilane is an alkylalkoxyaminosilane having a formula of R^{A}(Ak)_{c}Si(OAk)_{d}, in which each of c and d is 1 or 2; R^{A} is an amine moiety (e.g., any described herein); and each of Ak is, independently, an optionally substituted alkyl. Non-limiting examples of alkylalkoxyaminosilane include 3-aminopropyl(diethoxy)methylsilane (FIG. 2D) and 3-(ethoxydimethylsilyl)propylamine (FIG. 2E).

In some embodiments, the aminosilane is an aminosilanetriol having the formula (HO)₃SiR^{A}, in which R^{A} is an amine moiety (e.g., any described herein). A non-limiting example of aminosilanetriol is (3-((2-aminoethyl)amino)propyl)silanetriol (FIG. 2F).

In some embodiments, the aminosilane is a haloaminosilane having the formula (R^{A})₃SiX, in which each R^{A} is, independently, an amine moiety (e.g., any described herein) and X is halo (e.g., any described herein). Non-limiting examples of haloaminosilane include tris(dimethylamino)chlorosilane (FIG. 2G), tris(ethylmethylamino)chlorosilane, and the like.

In some embodiments, the aminosilane 108 has the structure of formula IIIa:

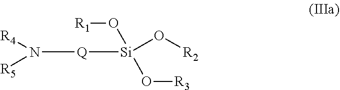

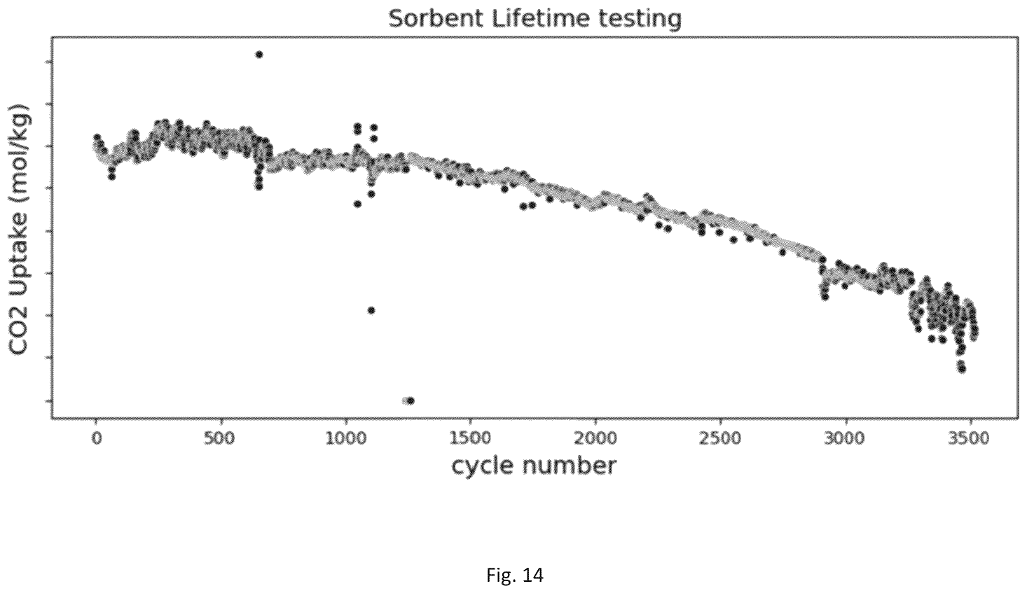

In formula IIIa, Q is —(CP₂)ₙ— where n is 2, 3, 4, or 5, and each P is independently a hydrogen, hydroxy, or halogen. In one embodiment, each P is halogen and n is 3: —CH₂—CH₂—CH₂— (e.g., compounds 1302, 1304, 1306, 1308, 1310, 1312, 1314, 1322, 1324, and 1326 of FIG. 14).

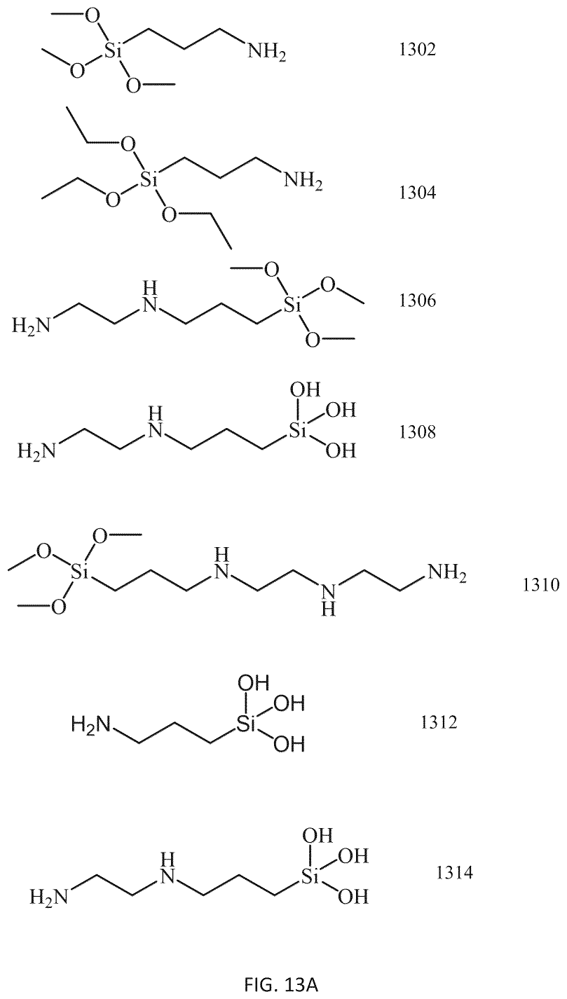

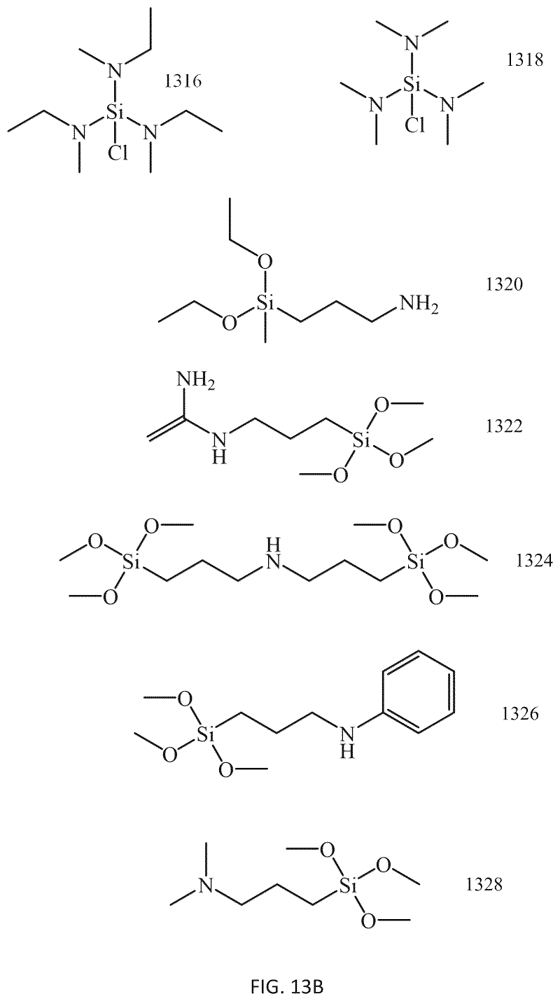

In formula IIIa, each R₁, R₂, and R₃ is independently hydrogen, alkyl, a substituted alkyl, an alkylene, or a substituted alkylene. In some embodiments, each R₁, R₂, and R₃ is —CH₃, —CH₂—CH₃, or —CH₂—CH₂—CH₃. In one embodiment, each R₁, R₂, and R₃ is hydrogen (e.g., compounds 1308, 1312 and 1314 of FIG. 13). In one embodiment, each R₁, R₂, and R₃ is —CH₂—CH₃ (e.g., compound 1304 of FIG. 13). In one embodiment, each R₁, R₂, and R₃ is —CH₃ (e.g., compounds 1302, 1306, 1322, 1324, 1326, and 1328 of FIG. 13).

In formula IIIa, each R₄ and R₅ is independently hydrogen, a substituted alkane, a substituted alkylene, an aryl, or a substituted aryl.

In some embodiments R₄ and R₅ are each methyl (e.g., compound 1328 of FIG. 13).

In one embodiment one of R₄ and R₅ is —(CH₂)ₘ—NH(R₅), where m is 1, 2, 3, 4 or 5, and R₅ is hydrogen or a substituted alkane, while the other of R₄ and R₅ is hydrogen.

In one embodiment R₄ is —(CH₂)ₘ—NH(R₆), where m is 1, 2, 3, 4 or 5, and R₆ is hydrogen or a substituted alkane, and R₄ is hydrogen. In some such embodiments, m is 2 and R₆ is hydrogen: —CH₂—CH₂—NH₂ (e.g., compounds 1306 and 1308 of FIG. 13). In other embodiments, R₆ is —(CH₂)ₚ—NH(R₇), where p is m is 1, 2, 3, 4 or 5, and R₇ is hydrogen or a substituted alkane. In one embodiment, R₇ is —(CH₂)—(CH₂)—NH₂ (e.g., compound 1314 of FIG. 13).

In some embodiments, the aminosilane 108 has the structure of formula IIIb:

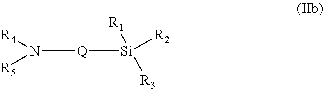

In formula IIIb, Q is —(CP₂)ₙ— where n is 2, 3, 4, or 5, and each P is independently a hydrogen, hydroxy, or halogen. In one embodiment, each P is halogen and n is 3: —CH₂—CH₂—CH₂— (e.g., compounds 1302, 1304, 1306, 1308, 1310, 1312, 1314, 1320, 1322, 1324, and 1326 of FIG. 13).

In formula IIIb, each R₁, R₂, and R₃ is independently hydrogen, alkyl, a substituted alkyl, an alkylene, a substituted alkylene, an alkoxy, or a substituted alkoxy. In some embodiments, R₁ and R₂ are each —OCH₂—CH₃, and R₃ is —CH3 (e.g., compound 1320 of FIG. 13).

In formula IIIa, each R₄ and R₅ is independently hydrogen, a substituted alkane, a substituted alkylene, an aryl, or a substituted aryl.

In some embodiments R₄ and R₅ are each methyl (e.g., compound 1328 of FIG. 13).

In some embodiments R₄ and R₅ are each hydrogen (e.g., compound 1320 of FIG. 13).

In some embodiments, one of R₄ and R₅ is —(CH₂)ₘ—NH(R₅), where m is 1, 2, 3, 4 or 5, and R₅ is hydrogen or a substituted alkane, while the other of R₄ and R₅ is hydrogen.

In some embodiments, R₄ is —(CH₂)ₘ—NH(R₆), where m is 1, 2, 3, 4 or 5, and R₆ is hydrogen or a substituted alkane, and R₅ is hydrogen. In some such embodiments, m is 2 and R₆ is hydrogen: —CH₂—CH₂—NH₂ (e.g., compounds 1306 and 1308 of FIG. 13). In other embodiments, R₆ is —(CH₂)ₚ—NH(R₇), where p is m is 1, 2, 3, 4 or 5, and R₇ is hydrogen or a substituted alkane. In one embodiment, R₇ is —(CH₂)—(CH₂)—NH₂ (e.g., compound 1314 of FIG. 13).

In some embodiments, the aminosilane 108 has the structure of formula IV:

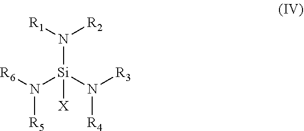

In formula IV, each R₁, R₂, R₃, R₄, R₅, and R₆ is independently hydrogen, alkyl, a substituted alkyl, an alkylene, or a substituted alkylene. In one embodiment, each R₁, R₂, R₃, R₄, R₅, and R₆ is —CH₃ (e.g., compound 1318 of FIG. 13). In one embodiment, each R₁, R₂, R₃, R₄, R₅, and R₆ is —CH₃ or —CH₂CH₃ (e.g., compound 1413 of FIG. 13). In formula IV, X is halogen. In one embodiment, X is Cl (e.g., compounds 1413 and 1413 of FIG. 13).

In some embodiments, the amine moieties of the aminosilane 108 interact with one or more of the X¹—X³ sites of neighboring aminosilanes 108 or interact with polymeric amines 110. In some embodiments, the amine moiety is or includes an amine group such as the amine groups of FIGS. 2B and 2C, which depict example aminopropyl, and N-(2-aminoethyl)-3-aminopropyl groups, respectively. In some implementations, the amine moiety is a primary, secondary, or tertiary amine. For example, in some embodiments, the amine moiety includes one or more aminopropyl or diethylenetriamine groups. In some implementations, the amine moiety includes more than one amine group connected through various alkyl groups. For instance, in some embodiments, the amine moiety includes a terminal amine group, an internal amine group, and a linker disposed between the terminal and internal amine group.

Optionally, in some embodiments, a further linker is present between the amine moiety and the silane moiety of the aminosilane compound.

Other non-limiting examples of aminosilanes include (3-aminopropyl) trimethoxysilane (compound 1302 in FIG. 13), (3-aminopropyl)triethoxysilane (compound 1304 in FIG. 13), [3-(2-aminoethylamino)propyl]trimethoxysilane (compound 1306 in FIG. 13), N-(2-aminoethyl)-3-aminopropyl silanetriol (compound 1308 in FIG. 13), N1-(3-trimethoxysilylpropyl) diethylenetriamine (compound 1310 in FIG. 13), 3-aminopropylsilanetriol (compound 1312 in FIG. 13), N-(2aminoethyl)-3-aminopropylsilanetriol (compound 1314 in FIG. 14), tris(ethylmethylamino)chlorosilane (compound 1316 in FIG. 14), tris(dimethylamino)chlorosilane (compound 1318 in FIG. 13), an aminosilane oligomer (e.g., such as VPS SIVO 280, a modified organofunctional polysiloxane from Evonik Industries AG, Essen, Germany), 3-aminopropyl(diethoxy)methylsilane (compound 1320 in FIG. 13), N-[3-(trimethoxysilyl)propyl]ethylenediamine (compound 1322 in FIG. 13), bis(3-(methylamino)propyl)-trimethoxysilane, bis[3-(trimethoxysilyl)propyl]amine (compound 1324 in FIG. 13), N-[3-(trimethoxysilyl)propyl]aniline (compound 1326 in FIG. 13), or (N,N-dimethylamino propyl)trimethoxysilane (compound 1328 in FIG. 13).

b. Silanes

In some embodiments, a silane compound includes any compound having a —SiR^{S1}R^{S2}R^{S3} moiety or a —SiR^{S1}R^{S2}— moiety, in which each of R^{S1}, R^{S2}, and R^{S3} is any described herein. In some embodiments, each of R^{S1}, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group. In some embodiments, each of R^{S1}, R^{S2}, and R^{S3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl).

In some embodiments, the silane includes one or more amino moieties, such as in an aminosilane compound (e.g., any described herein).

In some embodiments, the silane does not include an amino moiety. In one non-limiting example, the silane has formula (V):

[R^{C1}]ₐSi[X]₄₋ₐ (V),

where each R^{C1} does not comprise amino; each X is, independently, a side group, a reactive group, or a leaving group (e.g., any described herein); and a is an integer from 1 to 4.

In some embodiments, R^{C1} is optionally substituted aliphatic, heteroaliphatic, alkyl, aromatic, heteroaromatic, or aryl, where the optional substituent is not amino (e.g., as defined herein). In some embodiments, R^{C1} is a branched, optionally substituted aliphatic, heteroaliphatic, alkyl, aromatic, heteroaromatic, or aryl. In some embodiments, R^{C1} is a hydrophobic group (e.g., optionally substituted C₄₋₃₀ aliphatic, heteroaliphatic, alkyl, perfluoroalkyl, cycloalkyl, aromatic, heteroaromatic, or aryl). Non-limiting examples of hydrophobic groups include optionally substituted C₄₋₂₄, C₆₋₂₄, C₈₋₂₄, C₄₋₁₈, C₆₋₁₈, C₈₋₁₈ alkyl, haloalkyl, perfluoroalkyl, cycloalkyl, and the like (e.g., hexyl, octyl, nonyl, decyl, dodecyl, perfluorohexyl, perfluorooctyl, cyclohexyl, and cyclopentyl).

In some embodiments, the silane has formula (Va):

[X]₃Si-L-Si[X]₃ (Va),

where L is a linker (e.g., any described herein) and each X is, independently, a side group, a reactive group, or a leaving group (e.g., any described herein).

Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. Other examples of linkers include any described herein (e.g., described herein for L, L¹, L², and L³).

In some embodiments, the silane includes a reactive group, a leaving group, or another group (e.g., X). Non-limiting examples of such groups include hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), optionally substituted alkanoyloxy, trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl). In some embodiments, X is, independently, H, optionally substituted aliphatic, optionally substituted heteroaliphatic, optionally substituted aromatic, or optionally substituted heteroaromatic.

In some embodiments, a silane is employed as a crosslinker or as an additive for any composition or use herein (e.g., for any coating, surface functionalization layer, functionalization mixture, pre-functionalization mixture, and the like). Non-limiting examples of silanes include 1,2-bis(triethoxysilyl)ethane (BTESE) and 1,2-bis(trimethoxysilyl)ethane (BTME).

c. Polyamines

As described herein, in some embodiments the functional portion is provided by any useful compound or combination of compounds. In some embodiments, the compound is a polyamine. In some embodiments, the polyamine includes any compound or moiety having two or more amine moieties. In some embodiments, the polyamine is a non-polymeric compound, in which the polyamine does not include repeating units. In some embodiments, the polyamine is a polymeric compound (e.g., as in a polymeric polyamine). In other embodiments, the polyamine is an oligomeric compound (e.g., as in an oligomeric polyamine). Unless otherwise specified, discussion related to “polymeric” and “oligomeric” forms of compounds is applied interchangeably. In some embodiments, the polyamine includes dimeric, trimeric, tetrameric, pentameric, hexameric, and higher order amines. In some embodiments, the polyamine is a small molecule polyamine (e.g., having a molecular weight between 100 g/mol and 800 g/mol). In some embodiments, the polyamine is a large molecule polyamine (e.g., having a MW greater than 800 g/mol).

In some embodiments, a polyamine is used alone or with other compounds (e.g., any described herein, such as an aminosilane and the like). In some embodiments, the polyamine is used in the presence of aminosilane. In some embodiments, a first polyamine (e.g., having a high MW, such as any described herein) is used in the presence of a second polyamine (e.g., having a low MW, such as any described herein).

In some embodiments, a high molecular weight includes a weight-average molecular weight (M_{w}) or number-average molecular weight (Mₙ) of greater than 300 daltons (Da), 400 Da, 500 Da, or 600 Da or from a range of 300 to 1,000,000 Da (e.g., 300 to 900000 Da, 300 to 800000 Da, 300 to 700000 Da, 300 to 600000 Da, 300 to 500000 Da, 300 to 400000 Da, 300 to 300000 Da, 300 to 200000 Da, 300 to 100000 Da, 300 to 90000 Da, 300 to 80000 Da, 300 to 70000 Da, 300 to 60000 Da, 300 to 50000 Da, 300 to 40000 Da, 300 to 30000 Da, 300 to 20000 Da, 300 to 10000 Da, 300 to 9000 Da, 300 to 8000 Da, 300 to 7000 Da, 300 to 6000 Da, 300 to 5000 Da, 300 to 4000 Da, 300 to 3000 Da, 300 to 2000 Da, 300 to 1000 Da, 500 to 1000000 Da, 500 to 900000 Da, 500 to 800000 Da, 500 to 700000 Da, 500 to 600000 Da, 500 to 500000 Da, 500 to 400000 Da, 500 to 300000 Da, 500 to 200000 Da, 500 to 100000 Da, 500 to 90000 Da, 500 to 80000 Da, 500 to 70000 Da, 500 to 60000 Da, 500 to 50000 Da, 500 to 40000 Da, 500 to 30000 Da, 500 to 20000 Da, 500 to 10000 Da, 500 to 9000 Da, 500 to 8000 Da, 500 to 7000 Da, 500 to 6000 Da, 500 to 5000 Da, 500 to 4000 Da, 500 to 3000 Da, 500 to 2000 Da, 500 to 1000 Da, 700 to 1000000 Da, 700 to 900000 Da, 700 to 800000 Da, 700 to 700000 Da, 700 to 600000 Da, 700 to 500000 Da, 700 to 400000 Da, 700 to 300000 Da, 700 to 200000 Da, 700 to 100000 Da, 700 to 90000 Da, 700 to 80000 Da, 700 to 70000 Da, 700 to 60000 Da, 700 to 50000 Da, 700 to 40000 Da, 700 to 30000 Da, 700 to 20000 Da, 700 to 10000 Da, 700 to 9000 Da, 700 to 8000 Da, 700 to 7000 Da, 700 to 6000 Da, 700 to 5000 Da, 700 to 4000 Da, 700 to 3000 Da, 700 to 2000 Da, 700 to 1000 Da, 800 to 1000000 Da, 800 to 900000 Da, 800 to 800000 Da, 800 to 700000 Da, 800 to 600000 Da, 800 to 500000 Da, 800 to 400000 Da, 800 to 300000 Da, 800 to 200000 Da, 800 to 100000 Da, 800 to 90000 Da, 800 to 80000 Da, 800 to 70000 Da, 800 to 60000 Da, 800 to 50000 Da, 800 to 40000 Da, 800 to 30000 Da, 800 to 20000 Da, 800 to 10000 Da, 800 to 9000 Da, 800 to 8000 Da, 800 to 7000 Da, 800 to 6000 Da, 800 to 5000 Da, 800 to 4000 Da, 800 to 3000 Da, 800 to 2000 Da, or 800 to 1000 Da). In some embodiments, the high MW polyamine includes linear or branched forms. In some embodiments, the high MW polyamine includes a plurality of primary amine moieties and/or a plurality of secondary amine moieties. In some embodiments, the high molecular weight polyamine is provided in polymeric form.

In some embodiments, the low molecular weight includes a weight-average molecular weight (M_{w}) or number-average molecular weight (Mₙ) of less than 300 Da, from a range of 30 to 300 Da, from a range of 100 to 800 Da, or ranges therebetween (e.g., 30 Da to 800 Da, 30 Da to 700 Da, 30 Da to 500 Da, 30 Da to 200 Da, 30 Da to 100 Da, 50 Da to 800 Da, 50 Da to 700 Da, 50 Da to 600 Da, 50 Da to 500 Da, 100 Da to 700 Da, 100 Da to 600 Da, 100 Da to 500 Da, 100 Da to 400 Da, 100 Da to 300 Da, 150 Da to 800 Da, 150 Da to 700 Da, 150 Da to 600 Da, 150 Da to 500 Da, 150 Da to 400 Da, 150 Da to 300 Da, 200 Da to 800 Da, and 300 Da to 800 Da). In some embodiments, the low molecular weight polyamine (e.g., which can be considered to be an oligomeric amine) includes linear or branched forms. In some embodiments, the low MW polyamine includes a plurality of primary amine moieties and/or a plurality of secondary amine moieties. In some embodiments, the low molecular weight polyamine is provided in oligomeric form.

Without wishing to be limited by mechanism, in some embodiments high molecular weight (MW) amines are useful for their lower volatility (e.g., as compared to low MW amines). In some embodiments, higher MW polyamines are characterized by a higher viscosity, which makes handling more difficult. Higher MW polyamines are generally more expensive. In some non-limiting embodiments, polyamines with high relative concentrations of primary and secondary amine moieties are employed. In some non-limiting embodiments, tertiary amine moieties are characterized by lower performance for DAC applications and are less desired. Secondary amines have higher oxidation resistance equating to longer operational lifetimes. Primary amines have higher reactivity equating to higher performance at low CO₂ concentrations (DAC conditions).

The polyamine can have any useful structure. In one non-limiting example, the polyamine has the structure of any one of formula (VIa) to (VIi):

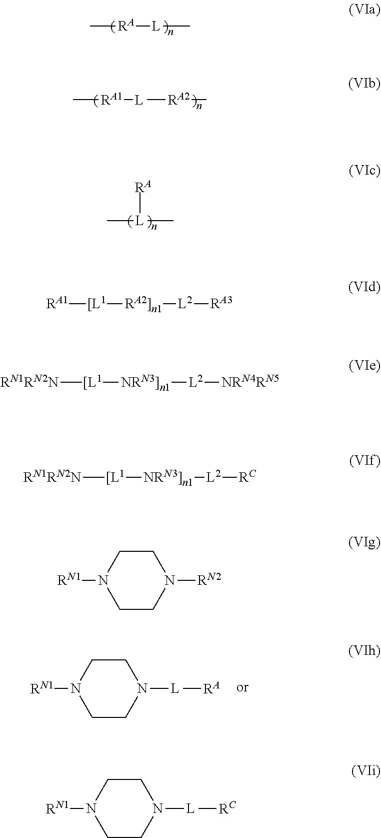

where N is nitrogen, each R^{A}, R^{A1}, R^{A2}, and R^{A3} is, independently, an amine moiety comprising at least one amine group, each L, L¹, or L² is, independently, a linker, each of R^{N1}, R^{N2}, R^{N3}, R^{N4}, and R^{N5} is any described herein, optionally where R^{N1} and R^{N2}, taken together with the nitrogen atom to which each are attached, can form a heterocyclyl group, as defined herein or optionally where R^{N4} and R^{N5}, taken together with the nitrogen atom to which each are attached, form a heterocyclyl group, as defined herein; R^{C} is hydrogen (H), halo, hydroxy, amino (e.g., —NR^{N1}R^{N2}), optionally substituted aliphatic, heteroaliphatic, alkyl, hydroxyalkyl, aromatic, heteroaromatic, or aryl; n is an integer greater than 1 (e.g., from 1-25000, 1-24000, 1-23000, 1-22000, 1-21000, 1-20000, 1-19000, 1-18000, 1-17000, 1-16000, 1-15000, 1-14000, 1-13000, 1-12000, 1-11000, 1-10000, 1-7500, 1-5000, 1-4000, 1-3000, 1-2000, 1-1000, 1-500, 1-100, 1-50, 1-20, 1-10, 1-5, 2-25000, 2-24000, 2-23000, 2-22000, 2-21000, 2-20000, 2-19000, 2-18000, 2-17000, 2-16000, 2-15000, 2-14000, 2-13000, 2-12000, 2-11000, 2-10000, 2-7500, 2-5000, 2-4000, 2-3000, 2-2000, 2-1000, 2-500, 2-100, 2-50, 2-20, 2-10, 2-5, 5-25000, 5-24000, 5-23000, 5-22000, 5-21000, 5-20000, 5-19000, 5-18000, 5-17000, 5-16000, 5-15000, 5-14000, 5-13000, 5-12000, 5-11000, 5-10000, 5-7500, 5-5000, 5-4000, 5-3000, 5-2000, 5-1000, 5-500, 5-100, 5-50, 5-20, 5-10, as well as ranges therebetween); and n1 is an integer of 1 or more (e.g., from 1-1000, 1-100, 1-50, 1-20, 1-10, 5-1000, 5-100, 5-50, 5-20, 5-10, as well as ranges therebetween). In some embodiments, R^{A}, R^{A1}, and R^{A2} is any amine moiety described herein, L, L¹, and L² is any linker described herein, and each of R^{N1}, R^{N2}, R^{N3}, R^{N4}, and R^{N5} is any described herein for R^{N1} or R^{N2}.

In some embodiments, R^{A}, R^{A1}, R^{A2}, or R^{A3} is or includes —NH—, —NR^{N1}—, , —N(-L¹-NR^{N1}R^{N2}), —N(-L²-NR^{N3}-L¹-NR^{N1}R^{N2})—, —N[-L²-N(-L¹-NR^{N1}R^{N2})₂]—, —NH₂, —NR^{N1}R^{N2}, -L¹-NR^{N1}R^{N2} —, —NR^{N3}-L¹-NR^{N1}R^{N2}—, -L²-NR^{N3}-L¹-NR^{N1}R^{N2} or —NR^{N4}-L²-NR^{N3}-L¹-NR^{N1}R^{N2}, in which each of R^{N1} and R^{N2} is any described herein, each of R^{N3} and R^{N4} is any described herein for R^{N1} and R^{N2}; and each of L¹ or L² is independently a linker.

Examples of linkers (e.g., for L¹, L², or L) include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some embodiments, the linker is a monomer or a polymer, which can be employed as a backbone to which an amine moiety R^{A} is attached. Alternatively, the backbone of the polymer itself can also include an amine moiety. Non-limiting examples of monomers include a saccharide (e.g., glucosamine, N-acetyl-glucosamine, glucose, and the like), an amino acid (e.g., lysine), an alkylene, an alkenylene, an arylene, and the like. Non-limiting examples of polymers include a polysaccharide (e.g., chitosan, chitin, and the like), a polypeptide (e.g., poly(lysine)), a vinyl polymer, and the like.

Further non-limiting examples of polyamines include poly(lysine) (e.g., poly(L-lysine), poly(D-lysine), or poly(LD-lysine)), poly(ethyleneimine), poly(propyleneimine), poly(vinylamine), poly(N-methylvinylamine), poly(allylamine), poly(N-isopropyl acrylamide), poly(4-aminostyrene), chitosan, spermidine, spermine, norspermine, putrescine, cadaverine, tetraethylenepentamine (TEPA), triethylenetetramine (TETA), an ethylene amine/oligomeric mix (e.g., Amix 1000 having CAS No. 68910-05-4), diethylenetriamine (DETA), 2-(2-aminoethylamino)ethanol, ethylenediamine, piperazine, 2-piperazin-1-ylethylamine, 2-piperazin-1-ylethanol, pentaethylenehexamine, tetramethylethylenediamine, as well as salts thereof and/or copolymers thereof and/or mixtures thereof. In some embodiments, the polyamine includes spermidine, spermine, norspermine, putrescine, cadaverine, tetraethylenepentamine (TEPA), triethylenetetramine (TETA), ethanolamine, diethylenetriamine (DETA), piperazine, 2-piperazin-1-ylethylamine, 2-piperazin-1-ylethanol, pentaethylenehexamine, tetramethylethylenediamine, as well as polymeric forms thereof. In some embodiments, the ethylene amine/oligomeric mix includes one or more of the following: 2-(2-aminoethylamino)ethanol, trientine or TETA, 2,2′-iminodi(ethylamine) or DETA, 2-aminoethanol, ethylenediamine, piperazine, 2-piperazin-1-ylethylamine, and 2-piperazin-1-ylethanol.

In some embodiments, the polyamine is or includes H₂N[CH₂CH₂NH]ₙH, in which n is an integer of 1 or more (e.g., 1, 2, 3, 4, 5, 6, 7, 8, 9, 10, or more). In some embodiments, the polyamine is or includes H₂N[-L-NH-]₁H or N[-L-NH₂]₃, in which each L is independently a linker (e.g., any described herein, such as optionally substituted alkylene) and n is an integer of 1 or more. In some embodiments, the polyamine is or includes H₂N[CH₂CH₂CH₂NH]ₙH, in which n is an integer of 1 or more (e.g., 1, 2, 3, 4, 5, 6, 7, 8, 9, 10, or more).

In some embodiments, the polyamine is or includes oligomeric or polymeric forms of ethyleneimine. In some embodiments, the polyamine is or includes —[CH₂CH₂NH]ₙ—, in which n is an integer of 1 or more (e.g., 1, 2, 3, 4, 5, 6, 7, 8, 9, 10, or more). In some embodiments, the polyamine is or includes —[CH₂CH₂NR^{A}]ₙ—, in which R^{A} is an amine moiety (e.g., any described herein) and n is an integer of 1 or more (e.g., 1, 2, 3, 4, 5, 6, 7, 8, 9, 10, or more). In some non-limiting embodiments, R^{A} is -Ak-NR^{N1}R^{N2} or -Ak-N(-Ak-NR^{N1}R^{N2}) or -Ak-NR^{N1}-Ak-NR^{N2}R^{N3}, in which N is nitrogen, Ak is optionally substituted alkylene and each of R^{N1}, R^{N2}, and R^{N3} is any described herein.

FIGS. 2H-2K provide non-limiting, general examples of polyamine chains that can serve as a polyamine of the present disclosure. The polyamines of FIGS. 2H and 2I include repeating units composed of amine groups (e.g., —NH—, —NR^{N1}—, —NH₂, or —NR^{N1}R^{N2}) and linkers. In some examples, the linker is a carbon aliphatic —(CH₂)ₙ— spacer groups, in which n is an integer greater than one (e.g., an integer from 1 to 20, 1 to 10, 1 to 12, 1 to 6, etc.). FIG. 2H shows an n-propylene (—CH₂CH₂CH₂—) (C₃H₆) spacer group. FIG. 2I shows an ethylene (—CH₂CH₂—) (C₂H₄) spacer group. The polyamine has a repeating chain portion (bracketed) having a length of n active groups in the chain portion of the polymer (e.g., if n=2, there are two repeating groups in the chain portion). Other linkers can be used, such as any described herein (e.g., optionally substituted alkylene, as described herein), as well as linkers having peptidic bonds (e.g., —C(O)NH—) or glycosidic linkages. Linkers can include peptides, polysaccharides, and the like. Furthermore, in some embodiments the polyamine includes linear or branched structures, such as those present in linear polymers, branched polymers, block polymers, or dendrimers.

FIGS. 2H-2I depict a polyamine having a length of n active groups in the repeating chain portion. FIGS. 2H-2I also depict the repeating chain portion including two non-limiting amine groups (—N(X)—), separated by either C₃ (FIG. 2H) or C₂ (FIG. 2I) spacer groups. In NX, X is any side group, reactive group, leaving group, or other group described herein. For example, in some embodiments X is H, optionally substituted aliphatic, heteroaliphatic, aromatic, and the like. Furthermore, in some embodiments X further includes an amine groups. Thus, in some non-limiting embodiments, X is any R^{A} group described herein (e.g., an aminoalkyl group, an alkylaminoalkyl group, and the like). FIG. 2I depicts the amine groups extending in different orientations from the carbon chain, whereas FIG. 2H depicts the amine groups extending in similar orientations.

In some embodiments the polyamine is derived from natural polymers having amine moieties. For example, FIG. 2J is an example of a poly(lysine), and FIG. 2K is an example of a natural chitosan.

In some embodiments, the amine moieties present in a polyamine interact with other moieties, groups, or compounds present in proximity to the substrate surface. In some embodiments, amine moieties of the polyamine interact with silane moieties (e.g., silanol groups or other groups) present in an aminosilane. In other embodiments, amine moieties of the polyamine interact with moieties of other polyamines, aminosilanes, or other groups present in proximity to the surface. Such interactions include covalent or non-covalent interactions (e.g., hydrogen bonding, ionic interactions, and/or others described herein) to form a network over the surface of the substrate.

In some embodiments, the polyamine is a polymeric/oligomeric amine or a mixture including polymeric/oligomeric amine, such as poly(ethyleneimine) (PEI), poly(propyleneimine) (PPI), or a multiple amine mixture (e.g., a mixture including a plurality of amines (e.g., polyamines and/or monoamines), such as Amix 1000, CAS No. 68910-05-4, as produced by BASF SE, Ludwigshafen, Germany). In some embodiments, the polyamine is a small molecule including amine moieties (e.g., small molecule amines), an oligomer including amine moieties (e.g., an oligomeric amine), or an oligomeric including ethylene amine moieties (e.g., an oligomeric ethylene amine), such as tetraethylenepentamine (TEPA), triethylenetetramine (TETA), diethylenetriamine (DETA), ethylenediamine, polymers or oligomers of monoethanolamine, polymers or oligomers of diethanolamine, polymers or oligomers of triethanolamine, 2-(2-aminoethylamino)ethanol, piperazine, 2-piperazin-1-ylethylamine, 2-piperazin-1-ylethanol, pentaethylenehexamine, tetramethylethylenediamine, or others described herein.

In some embodiments, the polyamine is a small molecule polyamine. In some embodiments, the small molecule polyamine is characterized by a boiling point being sufficiently high that the compounds are not lost due to a high volatility. In some embodiments, the small molecule polyamine has a boiling point of at least 170° C. In some examples, these compounds have reduced compound cost compared to alternatives.

In some embodiments, a mixture of one or more amines described herein (e.g., an aminosilane, a polyamine such as a high molecular weight polyamine or a small molecule polyamine, and/or a monoamine) is employed, in which the presence of such amines provides a polymer or an oligomer. In some embodiments, the mixture further includes an alcohol (e.g., ROH, in which R is optionally substituted aliphatic, alkyl, hydroxyalkyl, heteroaliphatic, heteroalkyl, aromatic, or aryl).

d. Monoamines

As described herein, the functional portion can be provided by any useful compound or combination of compounds. In some embodiments, the compound is a monoamine. In some embodiments the monoamine is any compound or moiety having one amine group (e.g., —NR^{N1}R^{N2}, in which R^{N1} and R^{N2} can be any described herein). In some embodiments the amine group is attached to a linker (e.g., any described herein).

In certain embodiments, the monoamine is provided to the substrate to act as an interaction moiety or an adsorbing moiety.

In some embodiments, the monoamine includes an aminosilane having one amine group. Other examples of monoamine compounds include an alkanolamine (e.g., HO-Ak-NR^{N1}R^{N2}, in which N is nitrogen, Ak is optionally substituted alkylene and each of R^{N1} and R^{N2} is any described herein, such as monoethanolamine) or an alkylamine (e.g., Ak-NR^{N1}R^{N2}, in which Ak is optionally substituted alkyl and each of R^{N1} and R^{N2} is any described herein, such as ethylamine or hexylamine), and the like. In some embodiments, the monoamine is a compound having a structure of formula R^{C1}N^{R1}R^{N2}, in which each of R^{N1} and R^{N2} is any described herein and R^{C1} is optionally substituted aliphatic, heteroaliphatic, alkyl, aromatic, heteroaromatic, or aryl, where the optional substituent is not amino, as defined herein, or where R^{C1} does not comprise amino, as defined herein.

e. Crosslinkers

In some embodiments, a crosslinker in accordance with the present disclosure has formula (VII):

R^{X1}-L-[R^{Xn}]ₙ (VII),

where each R^{X1} and R^{Xn} is, independently, a reactive group (e.g., any described herein), L is a linking moiety (e.g., any linker described herein, such as terephthalaldehyde (TALD)), and n is an integer from 0 to 5. Upon reacting the reactive moieties with one or more amine groups in a functional material, a linking moiety L is provided within the functional material. In some embodiments, one or more amine groups are present in the surface modification layer, and one or more linking moieties are bound (e.g., covalently bound) to at least one of the one or more amine groups.

Non-limiting examples of reactive groups include hydrogen (H), formyl (—C(O)H), halo (e.g., F, Cl, Br, or I), hydroxyl (e.g., —OH), carboxyl (e.g., —CO₂H), isocyanato (e.g., —NCO), optionally substituted alkanoyl, optionally substituted halocarbonyl, optionally substituted oxiranyl, optionally substituted heterocyclyl, optionally substituted cyclic anhydride, optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), optionally substituted alkanoyloxy, trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl).

In some embodiments, each of R^{X1} and R^{Xn} is, independently, H, optionally substituted aliphatic, optionally substituted heteroaliphatic, optionally substituted aromatic, or optionally substituted heteroaromatic.

Examples of linking moieties include e.g., a covalent bond, an atom (e.g., methylene, carbonyl, oxy, thio, imino, and the like), optionally substituted alkylene, optionally substituted heteroalkylene, optionally substituted arylene, or optionally substituted heteroarylene. Other examples of linking moieties include any described herein (e.g., described herein for L, L¹, L², and L³). The linker can be flexible or rigid.

In some embodiments, L is optionally substituted aliphatic, heteroaliphatic, alkyl, aromatic, heteroaromatic, or aryl.

In some embodiments, n is 2. In other embodiments, n is 3. In yet other embodiments, n is 4.

In some embodiments, R^{X1} and R^{Xn} are the same. In some embodiments, R^{X1} and R^{Xn} are different.

In some embodiments, each of R^{X1} and R^{Xn} is formyl; and n is 2, 3, or 4.

In some embodiments, each of R^{X1} and R^{Xn} is halo; and n is 2, 3, or 4.

In some embodiments, each of R^{X1} and R^{Xn} is isocyanato; and n is 2, 3, or 4.

In some embodiments, each of R^{X1} and R^{Xn} is optionally substituted halocarbonyl (e.g., in which X is Cl); and n is 2, 3, or 4.

In some embodiments, each of R^{X1} and R^{Xn} is optionally substituted oxiranyl; and n is 2, 3, or 4.

In some embodiments, each of R^{X1} and R^{Xn} is optionally substituted heterocyclyl; and n is 2, 3, or 4.

In some embodiments, each of R^{X1} and R^{Xn} is optionally substituted cyclic anhydride; and n is 2, 3, or 4.

An example of a crosslinker is a dialdehyde. A dialdehyde is an organic chemical compound with two aldehyde groups. In some embodiments, the dialdehyde has formula (VIIa) or (VIIb):

HC(O)-L-C(O)H (VIIa) or

HC(O)-L^{a}-Rⁿ¹ (VIIb),

where L is any described herein, Rⁿ¹ is any described herein; and L^{a} is optionally substituted with a formyl group. In some embodiments, L^{a} is optionally substituted with one or more formyl groups. Non-limiting examples of aldehyde groups include formaldehyde, terephthalaldehyde, glutaraldehyde, and glyoxal.

Examples of dialdehydes include

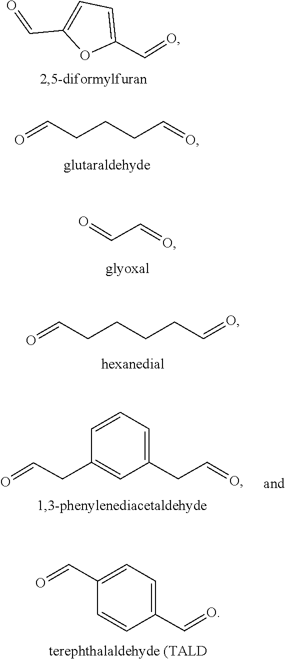

Another example of a crosslinker is a diisocyanate. A diisocyanate is an organic chemical compound with two isocyanate groups. In some embodiments, the diisocyanate has the formula (VIIc) or (VIId):

O═C═N-L-N═C═O (VIIc) or

OCN-L^{a}-Rⁿ¹ (VIId),

where L is any described herein; Rⁿ¹ is any described herein; and L^{a} is optionally substituted with an isocyanato group. In some embodiments, L^{a} is optionally substituted with one or more isocyanato groups. Non-limiting examples of diisocyanates include

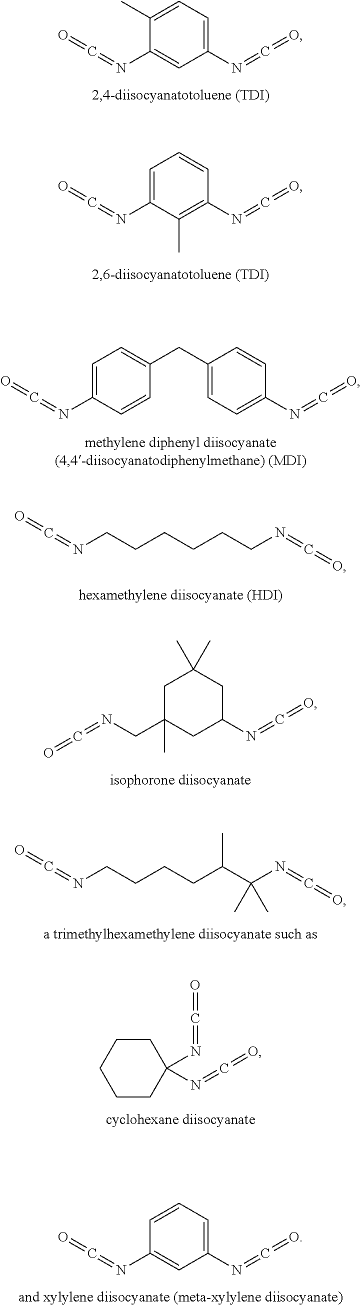

Another example of a crosslinker in accordance with the present disclosure is a dihaloalkane. A dihaloalkane is an organic chemical compound with two haloalkane groups. In some embodiments, the halo groups are provided at the terminus of the alkylene moiety. In some embodiments, the dihaloalkane has the structure of formula (VIIe) or (VIIf):

X-L-X (VIIe) or

X-L^{a}-Rⁿ¹ (VIII),

where L is any described herein, each X is, independently, halo (e.g., fluorine, chlorine, bromine, or iodine); Rⁿ¹ is any described herein; and L^{a} is optionally substituted with a halo groups. In some embodiments, L^{a} is optionally substituted with one or more halo groups. In some embodiments, L or L^{a} is optionally substituted alkylene. In some embodiments, L is unsubstituted alkylene. Non-limiting examples of dihaloalkanes include

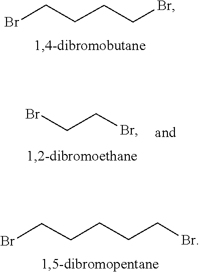

FIG. 2L depicts a non-limiting example of a dihaloalkane having two potential reactive groups (denoted as X) and two potential substituents (denoted as R¹ and R²).

Additional examples of dihaloalkanes are of the formula:

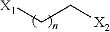

where X₁ and X₂ are each, independently, F, Cl, Br, I, and n is 1, 2, 3, 4, 5, 6, 7, 8, 9 or 10.

Another example of a crosslinker in accordance with the present disclosure is an epoxide, or a compound containing an optionally substituted oxiranyl functional group. An epoxide is a reactive cyclic ether. In some embodiments, the epoxide includes a structure having the formula (VIIg):

R¹R²C[O]CR³R⁴ (VIIg),

where each of R¹, R², R³, and R⁴ is, independently, any functional group described herein. In some embodiments, each of R¹, R², R³, and R⁴ is, independently, H, optionally substituted aliphatic, optionally substituted heteroaliphatic, optionally substituted aromatic, or optionally substituted heteroaromatic.

Another example of a crosslinker in accordance with the present disclosure is a diepoxide, or a compound containing two optionally substituted oxiranyl functional groups. In some embodiments, the diepoxide includes a structure having the formula (VIIh) or (VIIi):

R^{X1}-L-R^{X2} (VIIh) or

R^{X1}-L^{a}-Rⁿ¹ (VIIi),

where L is any described herein, each R^{X1} and R^{X2} is, optionally substituted oxiranyl, R^{a1} is any R described herein; and L^{a} is optionally substituted with an optionally substituted oxiranyl group. In some embodiments, L^{a} is optionally substituted with one or more optionally substituted oxiranyl groups. Non-limiting examples of epoxides include 1,2-propylene oxide, epichlorohydrin, and bisphenol A. Non-limiting examples of diepoxides in accordance with the present disclosure include

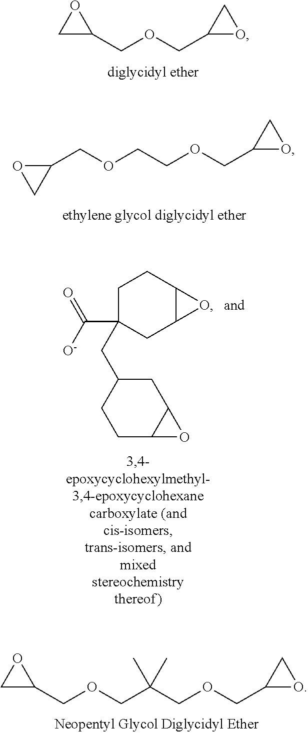 [SMILES: C(OCC1CO1)C1CO1 ; C(COCC1CO1)OCC1CO1 ; O=C([O-])C1(CC2CCC3OC3C2)CCC2OC2C1 ; "and" ; CC(C)(COCC1CO1)COCC1CO1]

FIG. 2M depicts an example of an epoxide 220 having four potential reactive groups 222 (denoted as R¹-R⁴).

Another example of a crosslinker in accordance with the present disclosure is a dianhydride. A dianhydride is an organic chemical compound with two anhydride groups. In some embodiments, each anhydride group includes two acyl groups bonded to the same oxygen atom. An example of a dianhydride is ethylenediaminetetraacetic (EDTA) dianhydride. In some embodiments, the dianhydride includes a structure having the formula (VIIj) or (VIIk):

R^{X1}-L-R^{X2} (VIIj) or

R^{X1}-L^{a}-Rⁿ¹ (VIIk),

where L is any described herein; each R^{X1} and R^{X2} is, an optionally substituted cyclic anhydride group; R^{a1} is any described herein, and L^{a} is optionally substituted with an optionally substituted cyclic anhydride group. In some embodiments, L^{a} is optionally substituted with one or more optionally substituted cyclic anhydride groups. Non-limiting examples of anhydrides include glutaric anhydride, succinic anhydride, and ethylenediaminetetraacetic dianhydride.

Nonlimiting examples of dianhydrides in accordance with the present disclosure include

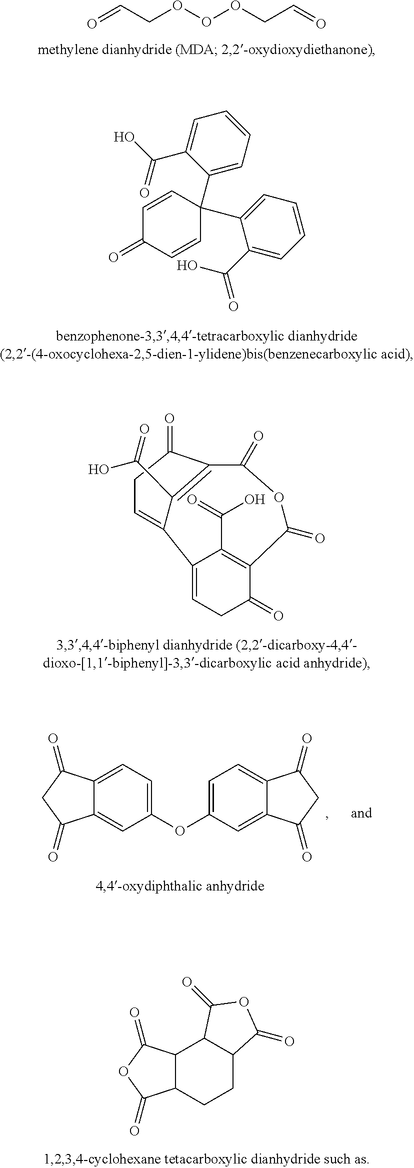 [SMILES: O=CCOOOCC=O ; O=C1C=CC(c2ccccc2C(=O)O)(c2ccccc2C(=O)O)C=C1 ; O=C(O)C1=C2C(=O)CC=C1C1=CCC(=O)C(=C1C(=O)O)C(=O)OC2=O ; O=C1CC(=O)c2cc(Oc3ccc4c(c3)C(=O)CC4=O)ccc21 ; O=C1OC(=O)C2C1CCC1C(=O)OC(=O)C12]

Another example of a crosslinker in accordance with the present disclosure is a diacid chloride. A diacid chloride is an organic chemical compound with two chlorocarbonyl functional groups. In some embodiments, the diacid chloride includes a structure having the formula (VIIl) or (VIIm):

ClC(O)-L-C(O)Cl (VIIl) or

ClC(O)-L^{a}-Rⁿ¹ (VIIm),

where L is any described herein, R^{a1} is any described herein; and L^{a} is optionally substituted with a chlorocarbonyl group (e.g., —C(O)Cl). In some embodiments, L^{a} is optionally substituted with one or more optionally substituted chlorocarbonyl groups. Non-limiting examples of diacid chlorides include

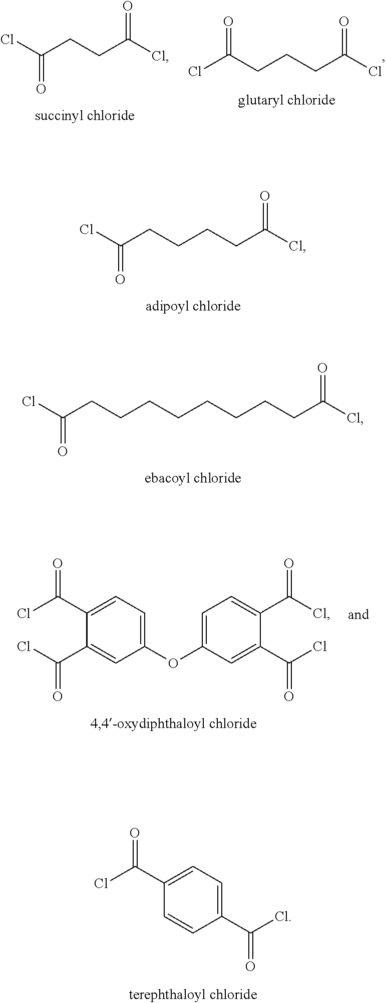

### iii. Interaction of Moieties, Groups, or Compounds

Any combination of moieties, groups, or compounds can be used to provide a functional portion. In some embodiments, the functional portion is provided as a coating or a surface modification layer, which in turn can be formed from a complex network of interactions between one or more silanes, aminosilanes, polymeric/oligomeric amines, monoamines, and/or surfaces of the substrate (e.g., a silica substrate).

In some embodiments, interactions form between a surface of a substrate and a silane moiety (e.g., present in any silane, aminosilane, polymeric silane, or polymeric aminosilane described herein). In instances when the silane moiety is provided by a (poly)aminosilane, the silanol moieties on a silica surface may react with the silane moiety to form siloxane linkages, which are non-limiting examples of covalent bonds. In some embodiments, such silanol moieties are acidic and are deprotonated by basic amine moieties of the (poly)aminosilane to form an acid-base pair, which is a non-limiting example of an ionic interaction. In some embodiments, silanol moieties (on silica) and silanol and amine moieties (on (poly)aminosilanes) form a variety of hydrogen bonding interactions (e.g., by way of hydrogen bonding). In the case of large polymeric silanes, the sum of these interactions is significant in some embodiments. In some embodiments the silica and (poly)silanes are polar and possess weak dipole-dipole interactions. In the case of large polymeric silanes, the sum of these interactions is significant in some embodiments.

In some embodiments, interactions form between the substrate surface and an amine moiety (e.g., present in any aminosilane, polyamine, or a monoamine described herein). In instances when the amine moiety is provided by a polyamine, silanol moieties on the silica surface are acidic and are deprotonated by the basic amine moieties of the polyamine to form acid-base pairs, which are non-limiting examples of ionic interactions. Silanol moieties (on silica) and amine moieties (on polyamines) form a variety of hydrogen bonding interactions in some embodiments. In some embodiments the silica and polyamines are polar and possess weak dipole-dipole interactions. Due to the large branching shape of some non-limiting polyamines, the sum of these weak interactions is significant when the polyamine adheres to or otherwise interacts with the silica surface in some embodiments.

In some embodiments, interactions form between substrate surfaces (e.g., a first surface and a second surface of a silica substrate). In instances when the substrate comprises silica, silica-silica interactions contribute to the formation and strength of the silica substrate in some embodiments. In some embodiments, silica substrates are composed of a single polymeric silica-dioxide molecule. In the case of precipitated silica, the silica substrate is e composed of a great number of small nucleites that are entangled into larger aggregates and finally agglomerated into the full particle and held together by physical interactions in some embodiments. In some embodiments silicon dioxide forms siloxane (—Si—O—Si—) linkages between individual silicon atoms, in which such siloxane linkages are non-limiting examples of covalent bonds. In some embodiments silica nucleites and aggregates are physically entangled and agglomerated to form substrate particles, in which such entanglement and agglomeration interactions are non-limiting examples of physical interactions. The surface of silica nucleites and aggregates include silanol moieties that form many hydrogen bonding interactions that promote cohesion in some embodiments. In some embodiments such silica nucleites and aggregates are polar and form cohesive dipole-dipole interactions.

In some embodiments, interactions form between silane moieties (e.g., present in any silane, aminosilane, or polymeric aminosilane described herein). In instances when the silane moieties are provided by alkoxysilane groups or silanol groups, the silane moieties react with each other to form siloxane condensation bonds in some embodiments. Both a silica surface and silanes can include silanol moieties that can condense to form siloxane bonds in some embodiments. This process is repeated many times to form branching polysilane networks having covalent bonds in some embodiments. In some embodiments silanols or polysilanes include acidic silanol moieties that are deprotonated by basic amine moieties (e.g., present in aminosilane) to form acid-base interactions, which are non-limiting examples of ionic interactions. In some embodiments the silanols or polysilanes of the present disclosure have silanol and amino moieties that form a variety of hydrogen bonding interactions. In some embodiments large branching polysilanes become physically entangled with each other. In some embodiments silanols and polysilanes are polar molecules and possess weak dipole-dipole interactions with each other. In the case of large branching polysilanes, the sum of these weak interactions is significant in some embodiments.

In some embodiments, interactions form between amine moieties (e.g., present in any amine, polyamine, aminosilane, or polymeric aminosilane). In instances when the amine moieties are provided by polyamines, polyamines have a variety of amine moieties that can donate and accept hydrogen bonds in some embodiments. Since polyamines are polymers, a higher number of these intermolecular interactions are possible (e.g., by way of hydrogen bonding) in some embodiments. Large polyamines become physically entangled with each other in some embodiments. In some embodiments polyamines are polar molecules and possess some weak dipole-dipole interactions with each other. In the case of large branching shapes present in some polyamines, the sum of these interactions can be significant in some embodiments.

In some embodiments, interactions form between an amino moiety (e.g., present in any amine, polyamine, aminosilane, or polymeric aminosilane), and a silane moiety (e.g., present in any silane, polymeric silane, aminosilane, or polymeric aminosilane). In instances when the amine moieties are provided by polyamines, polyamines have a plurality of basic amine moieties, which can deprotonate acidic silanol moieties (in (poly)silane) to form acid-base interactions in some embodiments. In the case of large polyamines interacting with large polysilanes, the sum of these interactions is even more significant (e.g., by way of ionic interactions) in some embodiments. In some embodiments, polyamines have many amine moieties, that form a variety of hydrogen bonding interactions with silanol moieties (in (poly)silane) and amine moieties. In the case of large polyamines interacting with large polysilanes, the sum of these interactions is even more significant (hydrogen bonding) in some embodiments. In some embodiments, polyamines and (poly)silanes are polar molecules and possess some weak dipole-dipole interactions with each other. In the case of large polyamines interacting with large polysilanes, the sum of these interactions is significant in some embodiments.

### iv. Additives

In some embodiments the compositions of the present disclosure further include additives. Such additives include any described herein, including one or more chelating agents, antioxidants, and the like.

In some embodiments, additives are included in the functionalization mixtures to extend the operational lifetime of the functionalized material. For example, the addition of bis[3-(trimethoxysilyl)propyl]amine (BTMSPA) to the mixture increases the operational lifetime of the functionalized material of the present disclosure in some embodiments. BTMSPA is an aminosilane having two ends, in which each end has a trimethoxysilyl reactive group. The BTMSPA bonds on the substrate with six binding points, as contrasted with the three binding points for an aminosilane with a single reactive group, such as would be present in a compound having a methoxydialkylsilyl reactive group. The increased number of binding points increases binding stability with the silica substrate in some embodiments. The BTMSPA forms a network with other aminosilanes and polyamines on the surface that increases binding stability of the overall network in some embodiments.

Other examples of additives include a polyamine (e.g., any described herein). Yet other examples of additives include 1,2-bis(triethoxysilyl)ethane (BTESE), other bisaminosilane compounds (e.g., X¹X²X³Si-L¹-NR^{N}-L²-SiX⁴X⁵X⁶, in which each of X¹, X², X³, X⁴, X⁵, and X⁶ is any described herein for X; each of L¹ and L² is any described herein for L; and R^{N} is any described herein for R^{N1}), or other bissilane compounds (e.g., X¹X²X³Si-L¹-SiX⁴X⁵X⁶, in which each of X¹, X², X³, X⁴, X⁵, and X⁶ is any described herein for X and L¹ is any described herein for L).

In some embodiments, the functionalized material includes antioxidant additives. Without wishing to be limited by theory, an additive prevents the degradation of the amine moieties by atmospheric oxygen and/or extends the cycling lifetime of the functionalized material of the present disclosure in some embodiments. For example, in some embodiments the antioxidant additives are organic sulfur-containing compounds, such as 2,2-thiodiethanol, 2-hydroxyethyl disulfide, and 3,3′-dithiodipropionic acid. In some embodiments, the organic sulfur-containing compound has the formula R′SR″ or R′SSR″ or R′S-L-SR″, in which each of R′ and R″ is, independently, aliphatic, alkyl, hydroxyalkyl, carboxyalkyl, aromatic, aryl, hydroxyaryl, or carboxyaryl (e.g., as defined herein), in which each of these is optionally substituted; and L is a linker (e.g., any described herein).

Another example of antioxidant additives is a metal catalyst chelator. Without wishing to be limited by theory or mechanism, transition metal impurities (e.g., such as iron or copper) increase the oxidation rate of amine moieties, which in turn reduces the lifetime of the sorbent. In some embodiments, a catalyst chelator includes, e.g., a phosphate or phosphonate alkali salt (e.g., a phosphate or phosphonate sodium salt), an aminopolycarboxylic acid or a salt thereof (e.g., ethylenediaminetetraacetic acid tetrasodium salt dihydrate or diethylenetriaminepentaacetic acid), a phosphonic acid or a salt thereof (e.g., 1-hydroxyethane 1,1-diphosphonic acid monohydrate or ethylenediamine tetramethylene phosphonic acid), a mercapto acid (e.g., meso-2,3-dimercaptosuccinic acid, and the like. In some embodiments, one or more catalyst chelators is used to reduce the oxidation rate and improve sorbent lifetime.

In general, the amount of antioxidant additives in the functionalized material is 5% (wt/wt) to the substrate (e.g., 3%, 4%, 6%, or 8% (wt/wt)). In some embodiments the antioxidant additives is added during any useful step (e.g., during formation of the suspension mixture or the functionalization mixture) of the following synthesis procedure or afterward (e.g., through dissolving in a solvent, such as an alcohol like methanol, and then soaking the functionalized material in the additive/solvent mixture for 1 hour).

In some embodiments, the functionalized material includes, or is functionalized with, other hydrophobic compounds including hydrophobic silanes or hydrophobic polymer coatings. In some embodiments, the hydrophobic silane includes one, two, or three alkyl chains. In particular embodiments, the hydrophobic silane includes R¹R²R³SiX¹ or [R¹]ₐSi[X¹]₄₋ₐ, in which each of R¹, R², and R³ is independently an optionally substituted aliphatic, alkyl, aromatic, or aryl; X¹ is a side group, a reactive group, or a leaving group (e.g., any described herein for X); and a is 1, 2, or 3. Without wishing to be limited by theory, alkyl chains on the silane molecule increases the hydrophobicity of the silane molecule in some embodiments. When the silane molecule is bonded to the substrate, it increases the hydrophobicity of the functionalized material as well in some embodiments. Thus, the water adsorption capacity of the functionalized material is reduced, which is beneficial for some cases such as when using the sorbent in high humidity conditions in some embodiments. For the same purpose of increasing the hydrophobicity of the functionalized material, additional hydrophobic polymer coatings are used in some embodiments. Polydimethylsiloxane (PDMS), silicone oil, polyethylene, polypropylene, poly(tetrafluorethylene), and polyurethane are examples of hydrophobic polymers that re used to coat the outer surface of the functionalized silica to reduce water adsorption for high humidity applications in some embodiments.

### v. Characteristics

In some embodiments the functionalized material of the present disclosure is used as a sorbent, which in turn can has any useful characteristics (e.g., any described herein).

In some embodiments, the crosslinked sorbent adsorbs CO₂ at concentrations similar to non-enhanced sorbents, enabling efficient capture at levels present in atmospheric conditions using stronger, longer-lasting products.

In some embodiments, the crosslinked sorbent has increased mechanical durability compared to non-enhanced sorbents such as increased crush strength and resistance to abrasion, thus increasing the useful lifespan of the sorbent and reducing the production of fines and sorbent particulates.

In some embodiments, crosslinking sorbent amines reduces amine volatility thereby reducing amines lost during vacuum desorption of adsorbed CO₂ from the functionalized material.

In some embodiments, crosslinking sorbent amines enhances sorbent oxidation resistance which improves operational lifetimes of the functionalized material thereby increasing adsorption/desorption cycle counts for the functionalized sorbent.

In some embodiments, crosslinking sorbent amines reduces amine leaching thereby reducing environmental release of free amines and reducing the environmental impact of the functionalized material.

In some embodiments, the functionalized material adsorbs CO₂ at low concentrations enabling increased capture at levels present in atmospheric conditions. Capturing CO₂ from atmospheric conditions can facilitate employing the functionalized material in a large number of applications.

In some embodiments, CO₂ is desorbed from the functionalized material at laboratory temperatures. This can reduce the energy required to remove captured CO₂, increase the applicability of the functionalized material to more industries and environments, and/or increase the speed at which the CO₂ is desorbed.

In some embodiments, the functionalized material achieves high adsorption/desorption counts, which reduces operational costs in carbon capture systems. In some embodiments the functionalized material is enabled for repeated use of the substrate.

In some embodiments, the functionalized material is produced using industrially available components, reducing the cost of and increasing the scalability of production.

In some embodiments, the functionalized material includes polymeric, oligomeric, or molecular sources with high densities of amine functionality that increase uptake of CO₂ per weight of dry sorbent.

In some embodiments, functionalizing the substrate with an aminosilane compound increases the binding stability of the polymeric, oligomeric, or high density amine source, thereby increasing the useful lifespan of the functionalized material.

In some embodiments, functionalizing the substrate with a polyamine (e.g., a high molecular weight polyamine) increases the binding stability, as compared to short chain amine functionalization (e.g., employing an oligomeric amine or a small molecular weight amine having at least two amine moieties and having a molecular weight from 100 to 800 g/mol).

In some embodiments, functionalizing the substrate with a small molecule polyamine (e.g., an oligomeric amine, an oligomeric ethylene amine, or an ethylene amine/oligomer mixture compound) decreases the cost of the functionalized substrate and facilitates large-scale functionalization of the substrate.

In some embodiments, polyamine sources have an increased amine density and are commercially available which increases cost effectiveness of the use of polyamine functionalized materials as sorbents.

In some embodiments, the functionalized material is produced in a single-pot reaction in short time scales to reduce the cost of production, reduce reliance on industrial solvents, and/or reduce the environmental impact of the product.

In some embodiments, the functionalized material is produced in a single-pot reaction in short time scales and using only water as a solvent to reduce the cost of production, reduce reliance on industrial solvents, and/or reduce the environmental impact of the product.

In some embodiments, the functionalized material is produced in a water-based, single-pot reaction at ambient pressures and temperatures in short time scales (e.g., using a dip-coating process) to reduce the cost of production, reduce reliance on industrial solvents, and/or reduce the environmental impact of the product.

In some embodiments, the compositions of the present disclosure adsorb atmospheric CO₂ (e.g., to an adsorbing moiety, such as an amine moiety) in a first temperature range and can desorb previously adsorbed CO₂ (e.g., from an adsorbing moiety, such as an amine moiety) in a second temperature range higher than the first temperature range. The second temperature range can be between 65° C. and 90° C.

In some embodiments, the compositions of the present disclosure adsorb atmospheric CO₂ (e.g., to an adsorbing moiety, such as an amine moiety) at a first gas pressure for CO₂ and desorb previously adsorbed CO₂ (e.g., from an adsorbing moiety, such as an amine moiety) at a second gas pressure for CO₂ that is lower than the first gas pressure. In some embodiments, the second gas pressure is below 1.5 psi (e.g., for functionalized silica or other functionalized material described herein). In some embodiments, the second gas pressure is below 0.3 psi (e.g., for functionalized MOF or other functionalized material described herein). The first and second gas pressure relate to the pressure for CO₂. Thus, when other gases are present in proximity of the sorbent, the first gas pressure and the second gas pressure relate to the partial pressure for CO₂.

In some embodiments, the composition adsorbs atmospheric CO₂ (e.g., to an adsorbing moiety, such as an amine moiety) at a first CO₂ concentration and desorbs previously adsorbed CO₂ (e.g., from an adsorbing moiety, such as an amine moiety) at a second CO₂ concentration lower than the first CO₂ concentration. In some embodiments the first CO₂ concentration is below 420 ppm or below 400 ppm.

In some embodiments, the composition comprises or consists essentially of porous silica particles as a substrate. In some embodiments the porous silica particles include a plurality of pores. In some embodiments the plurality of pores have a dimension (e.g., a diameter) in the range between 60 Å and 400 Å or between 20 Å and 1000 Å. In some embodiments the pores have a size in the range between 100 Å and 150 Å. In some embodiments the plurality of pores can have a volume that is greater than 0.5 mL/g. In some embodiments the porous silica particles have a total surface area greater than 100 m² per dry gram. In some embodiments the porous silica particles have an average diameter in the range between 25 μm and 3 mm or between 25 μm and 4 mm.

In some embodiments, the porous silica particles have a greatest dimension in the range between 70 μm and 80 μm. In some embodiments the porous silica particles include a plurality of pores, and the plurality of pores have volume greater than 0.8 mL/g and a size of at least 90 Å.

In some embodiments, the compositions of the present disclosure comprise or consist essentially of MOF particles as a substrate. In some embodiments the MOF particles include a plurality of pores. In some embodiments the plurality of pores have a dimension (e.g., a diameter) in the range between 30 Å and 400 Å. In some embodiments the plurality of pores have a volume greater than 0.5 mL/g. In some embodiments the MOF particles have a total surface area greater than 100 m² per dry gram. In some embodiments MOF particles have an average diameter in the range between 10 μm and 1 mm or between 50 and 100 μm.

In some embodiments, the compositions of the present disclosure comprise or consist essentially of resin as a substrate. In some embodiments the resin includes a plurality of pores. In some embodiments the plurality of pores have a dimension (e.g., a diameter) in the range between 1 nm and 200 nm. In some embodiments the plurality of pores have a volume greater than 0.5 mL/g. In some embodiments the resin has a total surface area greater than 100 m² per dry gram. In some embodiments the resin has an average diameter in the range between 25 μm and 4 mm.

In some embodiments, the compositions of the present disclosure adsorb between 0.5 mol and 2.5 mol of CO₂ per dry kilogram (mol CO₂/kg), between 0.5 mol CO₂/kg and 2 mol CO₂/kg, or between 1 mol CO₂/kg and 2 mol CO₂/kg. In some embodiments the compositions of the present disclosure adsorb CO₂ at a relative humidity in the range between 0% relative humidity (RH) and 100% RH, between 5% RH and 95% RH, or between 5% RH and 90% RH (e.g., for functionalized silica or other functionalized material described herein) or between 0% RH and 100% RH or between 5% and 60% RH (e.g., for functionalized MOF, functionalized resin, or other functionalized material described herein).

In some embodiments, a sorbent of the present disclosure is reused through the desorption process. For example, in some embodiments any of the sorbents of the present disclosure is reused 100 times or more (e.g., 1000 times or more, 10000 times or more). For the desorption process, in some embodiments the sample (sorbent of the present disclosure) is heated to 70° C. under vacuum for 30 minutes or another duration (e.g., the duration is change based on temperature and/or vacuum level). This facilitates the CO₂ captured during the adsorption process to be released, in which released CO₂ is collected for further sequestration, described with reference to the systems for direct air capture herein. A non-limiting aspect of the desorption process of the present disclosure includes maintaining the sorbent to be heated under a water vapor filled vacuum environment (e.g., >10% RH) in some embodiments. In some non-limiting embodiments, this reduces sorbent degradation.

When exposed to a gaseous mixture including CO₂, the amine moiety (or other adsorbing moiety) of the sorbents of the present disclosure react with the CO₂ to bond the CO₂ to the functional portion. This thereby functionally adsorbs the CO₂ to the substrate, in which the interaction moiety bonds the adsorbing moiety to substrate surface by way of covalent or non-covalent bonding interactions. Without wishing to be bound by theory, the total surface area, volume of the pores, and number of adsorbing moieties determines the adsorption capacity of the functionalized material of the present disclosure in some embodiments. The adsorption capacity (e.g., uptake) of the functionalized material of the present disclosure is in a range between 0.1 mol CO₂/kg and 2.5 mol CO₂/kg of functionalized material (e.g., between 0.1 mol CO₂/kg and 2 mol CO₂/kg, 0.1 mol CO₂/kg and 1.8 mol CO₂/kg, 0.1 mol CO₂/kg and 1.5 mol CO₂/kg, 0.1 mol CO₂/kg and 1.2 mol CO₂/kg, 0.1 mol CO₂/kg and 1.0 mol CO₂/kg, 0.1 mol CO₂/kg and 0.5 mol CO₂/kg, 0.2 mol CO₂/kg and 2 mol CO₂/kg, 0.2 mol CO₂/kg and 1.0 mol CO₂/kg, 0.2 mol CO₂/kg and 0.8 mol CO₂/kg, 0.5 mol CO₂/kg and 2.5 mol CO₂/kg, 0.5 mol CO₂/kg and 2.2 mol CO₂/kg, 0.5 mol CO₂/kg and 2 mol CO₂/kg, 0.5 mol CO₂/kg and 1.8 mol CO₂/kg, 0.5 mol CO₂/kg and 1.5 mol CO₂/kg, 0.5 mol CO₂/kg and 0.8 mol CO₂/kg, 0.8 mol CO₂/kg and 2.5 mol CO₂/kg, 0.8 mol CO₂/kg and 2.2 mol CO₂/kg, 0.8 mol CO₂/kg and 2 mol CO₂/kg, 0.8 mol CO₂/kg and 1.8 mol CO₂/kg, 0.8 mol CO₂/kg and 1.5 mol CO₂/kg, 1 mol CO₂/kg and 2 mol CO₂/kg, 1 mol CO₂/kg and 1.4 mol CO₂/kg, 1 mol CO₂/kg and 1.5 mol CO₂/kg, 1.2 mol CO₂/kg and 2.0 mol CO₂/kg, 1.2 mol CO₂/kg and 1.8 mol CO₂/kg, 1.5 mol CO₂/kg and 2.5 mol CO₂/kg, 1.5 mol CO₂/kg and 2 mol CO₂/kg, or 2 mol CO₂/kg and 2.5 mol CO₂/kg). In some embodiments, the range is greater than 0.5, 1, 1.5, 2, or 2.5 mol CO₂/kg. In some implementations, the functionalized material of the present disclosure achieves CO₂ adsorption capacity up to 1 mol CO₂/kg or up to 2 mol CO₂/kg at 420 ppm CO₂ in ambient air conditions.

In some implementations, the functionalized material (e.g., functionalized substrate including polyamine) achieves CO₂ adsorption capacity in a range from 0.8 to 2.5 mol CO₂/kg or 0.5 to 2.2 mol CO₂/kg (e.g., from 1 to 2 mol CO₂/kg, 1 to 1.5 mol CO₂/kg, 1.5 to 2 mol CO₂/kg, 1.5 to 2.5 mol CO₂/kg, or 2 to 2.5 mol CO₂/kg). In some implementations, the functionalized substrate achieves CO₂ adsorption capacity up to 2 mol CO₂/kg at 420 ppm CO₂ in ambient air conditions.

In some implementations, the functionalized material (e.g., functionalized substrate including ethylene amine, oligomeric ethylene amine, or mixtures thereof) achieves CO₂ adsorption capacity in a range from 0.5 to 1.8 mol CO₂/kg or 0.5 to 2 mol CO₂/kg (e.g., from 1.5 to 2 mol CO₂/kg, 1.5 to 1.8 mol CO₂/kg, 1 to 1.5 mol CO₂/kg, or 1.2 to 1.8 mol CO₂/kg). In some implementations, the functionalized substrate achieves CO₂ adsorption capacity up to 2 mol CO₂/kg at 420 ppm CO₂ in ambient air conditions.

In some implementations, the functionalized material (e.g., functionalized substrate prepared by way of a dip-coating process) achieves CO₂ adsorption capacity in a range from 1 to 2 mol CO₂/kg. In some implementations, the functionalized substrate achieves CO₂ adsorption capacity up to 2 mol CO₂/kg at 420 ppm CO₂ in ambient air conditions.

In some implementations, the functionalized material (e.g., functionalized MOF) achieves CO₂ adsorption capacity in a range from 0.8 to 2.5 mol CO₂/kg or 0.1 to 1 mol CO₂/kg (e.g., from 0.2 to 0.8 mol CO₂/kg). In some implementations, the functionalized MOF substrate achieves CO₂ adsorption capacity up to 2 mol CO₂/kg at 420 ppm CO₂ in ambient air conditions.

In some implementations, the functionalized material (e.g., functionalized resin) achieves CO₂ adsorption capacity in a range from 0.8 to 2.5 mol CO₂/kg, 0.8 to 3 mol CO₂/kg, or 0.1 to 2.0 mol CO₂/kg (e.g., from 0.1 to 1.8 mol CO₂/kg, 0.1 to 1.5 mol CO₂/kg, 0.1 to 1.2 mol CO₂/kg, 0.1 to 1.0 mol CO₂/kg, 0.1 to 0.5 mol CO₂/kg, 0.2 to 1.0 mol CO₂/kg, 0.2 to 0.8 mol CO₂/kg, 0.5 to 2.0 mol CO₂/kg, 0.5 to 1.5 mol CO₂/kg, 0.5 to 0.8 mol CO₂/kg, 1.2 to 2.0 mol CO₂/kg, 1.2 to 1.8 mol CO₂/kg, or any ranges described herein). In some implementations, the functionalized resin achieves CO₂ adsorption capacity up to 2 mol CO₂/kg at 420 ppm CO₂ in ambient air conditions.

In environmental conditions, the atmosphere includes a concentration of water vapor (e.g., humidity). The functionalized material of the present disclosure is used to capture CO₂ from atmospheric conditions in a range of RH levels in some embodiments. For example, in some embodiments of the present disclosure the functionalized material captures CO₂ from atmospheric conditions in the range between 0% RH and 100% RH, such as for example between 5% RH and 95% RH (e.g., between 15% RH and 50% RH, between 25% RH and 40% RH, between 10% RH and 60% RH, between 5% RH and 90% RH, between 10% RH and 90% RH, or between 20% RH and 80% RH). In some embodiments, the functionalized material captures CO₂ from atmospheric conditions having greater than 60% RH, greater than 75% RH, greater than 90% RH, or greater than 95% RH.

Described herein are functionalized materials, as well as methods of forming and using such materials (e.g., as a sorbent). In some embodiments, methods include forming or using a functionalized material including a porous structure that allows gas to diffuse through the material and that provides a large surface area for gas to be captured or “adsorbed.” Also described herein are systems for employing such materials in various capture processes. In some embodiments, systems include sample holder, reactors, adsorbers, desorbers, and the like that employ a functionalized material (e.g., any described herein) to adsorb carbon dioxide and/or that regenerate a functionalized material (e.g., any described herein) having adsorbed carbon dioxide.

Yet other functionalized material, methods, systems, and the like are provided in Int. Appl. No. PCT/US23/26724, filed Jun. 30, 2023, which is incorporated herein by reference in its entirety.

### vi. Chemical Definitions

Unless otherwise specified, the term “material” is used to encompass compounds, molecules, structures (e.g., substrates or particles), or combinations thereof (e.g., a functionalized substrate).

As used herein, the term “moiety” is used to describe characteristic parts of organic molecules, compounds, or materials. For example, an amine moiety is a molecule, compound, or portion of a compound containing an amine group (e.g., —NR^{N1}R^{N2}, as described herein), whereas a silane moiety is a molecule, compound, or portion of a compound containing a silane group (e.g., —SiR^{S1}R^{S2}R^{S3}, as described herein). In one non-limiting instance, an amine moiety is an aminoalkyl group (e.g., -Ak-NR^{N1}R^{N2}, as described herein), as may be present in an aminosilane compound or a polyamine compound. In another non-limiting instance, an amine moiety includes an amino group alone (e.g., —NR^{N1}R^{N2}, as described herein). The term moiety is used to describe both larger molecules containing the group, or may be used to describe the group itself.

As used herein, “interact” is used to describe covalent or non-covalent interactions between chemicals, such as by way of physical adsorption or ionic interactions.

By “acyl” or “alkanoyl,” as used interchangeably herein, is meant an aliphatic or alkyl group, as defined herein, attached to the parent molecular group through a carbonyl group. In particular embodiments, the alkanoyl is —C(O)-Ak, in which Ak is an aliphatic or alkyl group, as defined herein. In some embodiments, an unsubstituted alkanoyl is a C₂₋₇ alkanoyl group. Non-limiting examples of alkanoyl groups include acetyl.

By “acyloxy” or “alkanoyloxy,” as used interchangeably herein, is meant an acyl or alkanoyl group, as defined herein, attached to the parent molecular group through an oxy group. In particular embodiments, the alkanoyloxy is —O—C(O)-Ak, in which Ak is an aliphatic or alkyl group, as defined herein. In some embodiments, an unsubstituted alkanoyloxy is a C₂₋₇ alkanoyloxy group. Non-limiting examples of alkanoyloxy groups include acetoxy.

By “acyl halide” is meant —C(O)X, where X is a halogen, such as Br, F, I, or Cl.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl, e.g., as described herein), alkenes (or alkenyl), alkynes (or alkynyl), including cyclic versions thereof, and further including straight- and branched-chain arrangements, and all stereo and position isomers as well. Such a hydrocarbon can be unsubstituted or substituted with one or more groups, such as groups described herein for an alkyl group.

By “aliphatic-aryl” is meant an aryl group that is or can be coupled to a compound disclosed herein, where the aryl group is or becomes coupled through an aliphatic group, as defined herein. In some embodiments, the aliphatic-aryl group is -L-R, in which L is an aliphatic group, as defined herein, and R is an aryl group, as defined herein.

By “aliphatic-heteroaryl” is meant a heteroaryl group that is or can be coupled to a compound disclosed herein, where the heteroaryl group is or becomes coupled through an aliphatic group, as defined herein. In some embodiments, the aliphatic-heteroaryl group is -L-R, in which L is an aliphatic group, as defined herein, and R is a heteroaryl group, as defined herein.

By “alkenyl” is meant an optionally substituted C₂₋₂₄ alkyl group having one or more double bonds. The alkenyl group can be cyclic (e.g., C₃₋₂₄ cycloalkenyl) or acyclic. The alkenyl group can also be substituted or unsubstituted. For example, the alkenyl group can be substituted with one or more substitution groups, as described herein for alkyl. Non-limiting unsubstituted alkenyl groups include allyl and vinyl. In some embodiments, the unsubstituted alkenyl group is a C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkenyl group. Non-limiting examples of alkenyl groups include vinyl or ethenyl (—CH═CH₂), 1-propenyl (—CH═CHCH₃), allyl or 2-propenyl (—CH₂—CH═CH₂), 1-butenyl (—CH═CHCH₂CH₃), 2-butenyl (—CH₂CH═CHCH₃), 3-butenyl (—CH₂CH₂CH═CH₂), 2-butenylidene (=CH—CH═CHCH₃), and the like.

By “alkenylene” is meant a multivalent (e.g., bivalent) form of an alkenyl group, which is an optionally substituted C₂₋₂₄ alkyl group having one or more double bonds. The alkenylene group can be cyclic (e.g., C₃₋₂₄ cycloalkenyl) or acyclic. The alkenylene group can be substituted or unsubstituted. For example, the alkenylene group can be substituted with one or more substitution groups, as described herein for alkyl. Non-limiting examples of alkenylene include —CH═CH— or —CH═CHCH₂—.

By “alkoxy” is meant —OR, where R is an optionally substituted aliphatic or alkyl group, as described herein. Non-limiting examples of alkoxy groups include methoxy, ethoxy, n-propoxy, isopropoxy, n-butoxy, t-butoxy, sec-butoxy, n-pentoxy, trihaloalkoxy, such as trifluoromethoxy, etc. The alkoxy group can be substituted or unsubstituted. For example, the alkoxy group can be substituted with one or more substitution groups, as described herein for alkyl. Non-limiting examples of unsubstituted alkoxy include C₁₋₃, C₁₋₆, C₁₋₁₂, C₁₋₁₆, C₁₋₁₈, C₁₋₂₀, or C₁₋₂₄ alkoxy groups.

By “alkoxyalkyl” is meant an alkyl group, as defined herein, which is substituted with an alkoxy group, as defined herein. Non-limiting examples of unsubstituted alkoxyalkyl groups include between 2 to 12 carbons (C₂₋₁₂ alkoxyalkyl), as well as those having an alkyl group with 1 to 6 carbons and an alkoxy group with 1 to 6 carbons (i.e., C₁₋₆ alkoxy-C₁₋₆ alkyl). In some embodiments, the alkoxyalkyl group is -L-O—R, in which L is an alkylene group, as defined herein, and R is an alkyl group, as defined herein.

By “alkyl” and the prefix “alk” is meant a branched or unbranched saturated hydrocarbon group of 1 to 24 carbon atoms, such as methyl (Me), ethyl (Et), n-propyl (n-Pr), isopropyl (i-Pr), cyclopropyl, n-butyl (n-Bu), isobutyl (i-Bu), s-butyl (s-Bu), t-butyl (t-Bu), cyclobutyl, n-pentyl, isopentyl, s-pentyl, neopentyl, hexyl, heptyl, octyl, nonyl, decyl, dodecyl, tetradecyl, hexadecyl, eicosyl, tetracosyl, and the like. In some embodiments, the alkyl group is cyclic (e.g., C₃₋₂₄ cycloalkyl) or acyclic. In some embodiments, the alkyl group is branched or unbranched. In some embodiments, the alkyl group is also substituted or unsubstituted. For example, in some embodiments, the alkyl group is substituted with one or more alkenyl, alkoxy, alkynyl, amino, aryl, carboxyaldehyde (e.g., —C(O)H), carboxyl (e.g., —CO₂H), cyano (e.g., —CN), halo, nitro (e.g., —NO₂), oxo (e.g., ═O), and the like. In some embodiments, the alkyl group is substituted with one, two, three or, in the case of alkyl groups of two carbons or more, four substituents independently selected from the group consisting of: (1) C₁₋₆ alkoxy (e.g., —O—R, in which R is C₁₋₆ alkyl); (2) C₁₋₆ alkylsulfinyl (e.g., —S(O)—R, in which R is C₁₋₆ alkyl); (3) C₁₋₆ alkylsulfonyl (e.g., —SO₂—R, in which R is C₁₋₆ alkyl); (4) amine (e.g., —C(O)NR¹R² or —NHCOR¹, where each of R¹ and R² is, independently, selected from hydrogen, aliphatic, heteroaliphatic, haloaliphatic, haloheteroaliphatic, aromatic, as defined herein, or any combination thereof, or R¹ and R², taken together with the nitrogen atom to which each are attached, can form a heterocyclyl group, as defined herein); (5) aryl (e.g., C₄₋₁₈ aryl); (6) arylalkoxy (e.g., —O-L-R, in which L is C₁₋₆ alkylene and R is C₄₋₁₈ aryl); (7) aryloyl (e.g., —C(O)—R, in which R is C₄₋₁₈ aryl); (8) azido (e.g., —N₃); (9) cyano (e.g., —CN); (10) aldehyde (e.g., —C(O)H); (11) C₃₋₈ cycloalkyl; (12) halo; (13) heterocyclyl (e.g., as defined herein, such as a 5-, 6- or 7-membered ring containing one, two, three, or four non-carbon heteroatoms); (14) heterocyclyloxy (e.g., —O—R, in which R is heterocyclyl, as defined herein); (15) heterocyclyloyl (e.g., —C(O)—R, in which R is heterocyclyl, as defined herein); (16) hydroxy (e.g., —OH); (17) N-protected amino; (18) nitro (e.g., —NO₂); (19) oxo (e.g., ═O); (20) C₁₋₆ thioalkoxy (e.g., —S—R, in which R is alkyl); (21) thiol (e.g., —SH); (22) —CO₂R¹, where R¹ is selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); (23) —C(O)NR¹R², where each of R¹ and R² is, independently, selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); (24) —SO₂R¹, where R¹ is selected from the group consisting of (a) C₁₋₆ alkyl, (b) C₄₋₁₈ aryl, and (c) C₁₋₆ alkyl-C₄₋₁₈ aryl (e.g., -L-R, in which L is C₁₋₆ alkylene and R is C₄₋₁₈ aryl); (25) —SO₂NR¹R², where each of R¹ and R² is, independently, selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); and (26) —NR¹R², where each of R¹ and R² is, independently, selected from the group consisting of (a) hydrogen, (b) an N-protecting group, (c) C₁₋₆ alkyl, (d) C₂₋₆ alkenyl, (e) C₂₋₆ alkynyl, (f) C₄₋₁₈ aryl, (g) C₁₋₆ alkyl-C₄₋₁₈ aryl (e.g., -L-R, in which L is C₁₋₆ alkylene and R is C₄₋₁₈ aryl), (h) C₃₋₈ cycloalkyl, and (i) C₁₋₆ alkyl-C₃₋₈ cycloalkyl (e.g., -L-R, in which L is C₁₋₆ alkylene and R is C₃₋₈ cycloalkyl), where in one embodiment no two groups are bound to the nitrogen atom through a carbonyl group or a sulfonyl group.

In some embodiments, the alkyl group is a primary, secondary, or tertiary alkyl group substituted with one or more substituents (e.g., one or more halo or alkoxy). In some embodiments, the unsubstituted alkyl group is a C₁₋₃, C₁₋₄, C₁₋₆, C₁₋₈, C₁₋₁₀, C₁₋₁₂, C₁₋₁₆, C₁₋₁₈, C₁₋₂₀, C₁₋₂₄, C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkyl group. Unless stated otherwise specifically in the specification, an alkyl group is optionally substituted by one or more of substituents that are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

By “alkylene” is meant a multivalent (e.g., bivalent) form of an aliphatic or alkyl group, as described herein. Exemplary alkylene groups include methylene, ethylene, propylene, butylene, etc. In some embodiments, the alkylene group is a C₁₋₃, C₁₋₄, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. In some embodiments, the alkylene group is branched or unbranched. The alkylene group is also substituted or unsubstituted. For example, in some embodiments, the alkylene group is substituted with one or more substitution groups, as described herein for alkyl.

The term “alkoxy” refers to the group —O-alkyl, including from 1 to 24 carbon atoms of a straight, branched, cyclic configuration and combinations thereof attached to the parent structure through an oxygen. Exemplary alkoxy groups include methoxy, ethoxy, propoxy, isopropoxy, cyclopropyloxy, butoxy, cyclohexyloxy, and trihaloalkoxy, such as trifluoromethoxy, etc. In some embodiments, the alkoxy group is substituted or unsubstituted. For example, in some embodiments, the alkoxy group is substituted with one or more substitution groups, as described herein for alkyl. Exemplary unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

The term “substituted alkoxy” refers to alkoxy where the alkyl constituent is substituted (e.g., —O-(substituted alkyl)). Unless stated otherwise specifically in the specification, the alkyl moiety of an alkoxy group is optionally substituted by one or more substituents the independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “alkylsilyl,” as used herein, refers to —SiR¹R²R³ group, where R¹ is an optionally substituted alkyl, and where each of R² and R³ is independently selected from H and an optionally substituted alkyl. Alkylsilyls include mono, bis, and tris alkylsilyls. Examples of alkylsilyls include trimethylsilyl, dimethylsilyl, methylsilyl, triethylsilyl, diethylsilyl, ethylsilyl, and the like.

By “alkylsulfinyl” is meant an alkyl group, as defined herein, attached to the parent molecular group through an —S(O)— group. In some embodiments, the unsubstituted alkylsulfinyl group is a C₁₋₆ or C₁₋₁₂ alkylsulfinyl group. In other embodiments, the alkylsulfinyl group is —S(O)—R, in which R is an alkyl group, as defined herein.

By “alkylsulfinylalkyl” is meant an alkyl group, as defined herein, substituted by an alkylsulfinyl group. In some embodiments, the unsubstituted alkylsulfinylalkyl group is a C₂₋₁₂ or C₂₋₂₄ alkylsulfinylalkyl group (e.g., C₁₋₆ alkylsulfinyl-C₁₋₆ alkyl or C₁₋₁₂ alkylsulfinyl-C₁₋₁₂ alkyl). In other embodiments, the alkylsulfinylalkyl group is -L-S(O)—R, in which L is alkylene, as defined herein, and R is an alkyl group, as defined herein.

By “alkylsulfonyl” is meant an alkyl group, as defined herein, attached to the parent molecular group through an —SO₂— group. In some embodiments, the unsubstituted alkylsulfonyl group is a C₁₋₆ or C₁₋₁₂ alkylsulfonyl group. In other embodiments, the alkylsulfonyl group is —SO₂—R, where R is an optionally substituted alkyl (e.g., as described herein, including optionally substituted C₁₋₁₂ alkyl, haloalkyl, or perfluoroalkyl).

By “alkylsulfonylalkyl” is meant an alkyl group, as defined herein, substituted by an alkylsulfonyl group. In some embodiments, the unsubstituted alkylsulfonylalkyl group is a C₂₋₁₂ or C₂₋₂₄ alkylsulfonylalkyl group (e.g., C₁₋₆ alkylsulfonyl-C₁₋₆ alkyl or C₁₋₁₂ alkylsulfonyl-C₁₋₁₂ alkyl). In other embodiments, the alkylsulfonylalkyl group is -L-SO₂—R, in which L is alkylene, as defined herein, and R is an alkyl group, as defined herein.

By “alkynyl” is meant an optionally substituted C₂₋₂₄ alkyl group having one or more triple bonds. The alkynyl group can be cyclic or acyclic and is exemplified by ethynyl, 1-propynyl, and the like. The alkynyl group can also be substituted or unsubstituted. For example, the alkynyl group can be substituted with one or more substitution groups, as described herein for alkyl. Non-limiting unsubstituted alkynyl groups include C₂₋₈ alkynyl, C₂₋₆ alkynyl, C₂₋₅ alkynyl, C₂₋₄ alkynyl, or C₂₋₃ alkynyl. Non-limiting examples of alkynyl groups include ethynyl (—C≡CH), 1-propynyl (—C≡CCH₃), 2-propynyl or propargyl (—CH₂C≡CH), 1-butynyl (—C≡CCH₂CH₃), 2-butynyl (—CH₂C≡CCH₃), 3-butynyl (—CH₂CH₂C≡CH), and the like. In some embodiments, the unsubstituted alkynyl group is a C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkynyl group.

By “alkynylene” is meant a multivalent (e.g., bivalent) form of an alkynyl group, which is an optionally substituted C₂₋₂₄ alkyl group having one or more triple bonds. The alkynylene group can be cyclic or acyclic. The alkynylene group can be substituted or unsubstituted. For example, the alkynylene group can be substituted with one or more substitution groups, as described herein for alkyl. Non-limiting examples of alkynylene groups include —C≡C— or —C≡CCH₂—.

By “amido” is meant —C(O)NR¹R² or —NHCOR¹, where each of R¹ and R² is, independently, selected from hydrogen, aliphatic, heteroaliphatic, haloaliphatic, haloheteroaliphatic, aromatic, as defined herein, or any combination thereof, or where R¹ and R², taken together with the nitrogen atom to which each are attached, can form a heterocyclyl group, as defined herein.

By “amine” or “amino” is meant a —NR^{N1}R^{N2} group, a —NR^{N1}— group, or a compound having such a group, where each of R^{N1} and R^{N2} is, independently, H, optionally substituted aliphatic, alkyl, hydroxyalkyl, heteroaliphatic, heteroalkyl, aromatic, or aryl; or where R^{N1} and R^{N2}, taken together with the nitrogen atom to which each are attached, form a heterocyclyl group, as defined herein. In some embodiments an “amino” or “amino” is meant a —N(R^{a})₂ radical group, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl, unless stated otherwise specifically in the specification. When a —N(R^{a})₂ group has two R^{a} substituents other than hydrogen, they can be combined with the nitrogen atom to form a 4-, 5-, 6- or 7-membered ring. For example, —N(R^{a})₂ is intended to include, but is not limited to, 1-pyrrolidinyl and 4-morpholinyl. Unless stated otherwise specifically in the specification, an amino group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, C(O)N(R^{a})₂, —N(R^{a})C(O)OR^{a}, —N(R^{a})C(O)R^{a}, —N(R^{a})C(O)N(R^{a})₂, ¬N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), or —PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “substituted amino” also refers to N-oxides of the groups —NHR^{a}, and NR^{a}R^{a} each as described above. N-oxides can be prepared by treatment of the corresponding amino group with, for example, hydrogen peroxide or m-chloroperoxybenzoic acid.

By “aminoalkyl” is meant an aliphatic or alkyl group, as described herein, substituted with one, two, three, or more amine groups. In some embodiments the aminoalkyl includes internal amine groups or terminal amine groups. In some embodiments, the aminoalkyl group is further substituted. For example, in some embodiments, the aminoalkyl group is substituted with one or more substitution groups, as described herein for alkyl. Exemplary unsubstituted aminoalkyl groups include C₁₋₃, C₁₋₆, C₁₋₁₂, C₁₋₁₆, C₁₋₁₈, C₁₋₂₀, or C₁₋₂₄ aminoalkyl groups. In some embodiments, the aminoalkyl group is -L-NR¹R², in which L is an aliphatic or alkylene group, as defined herein, and each of R¹ and R² is, independently, selected from hydrogen, aliphatic, heteroaliphatic, haloaliphatic, haloheteroaliphatic, aromatic, as defined herein, or any combination thereof; or R¹ and R², taken together with the nitrogen atom to which each are attached, can form a heterocyclyl group, as defined herein. In other embodiments, the aminoalkyl group is -L-C(NR¹R²)(R³)—R⁴, in which L is a covalent bond, an aliphatic group, or an alkylene group, as defined herein; each of R¹ and R² is, independently, selected from hydrogen, aliphatic, heteroaliphatic, haloaliphatic, haloheteroaliphatic, aromatic, as defined herein, or any combination thereof; or R¹ and R², taken together with the nitrogen atom to which each are attached, can form a heterocyclyl group, as defined herein; and each of R³ and R⁴ is, independently, H or alkyl, as defined herein.

By “aminoaryl” is meant an aromatic or aryl group, as defined herein, substituted by an amino group, as defined herein.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system.

By “aryl” is meant an aromatic carbocyclic group comprising at least five carbon atoms to 15 carbon atoms (C₅₋₁₅), such as five to ten carbon atoms (C₅₋₁₀), having a single ring or multiple condensed rings, which condensed rings can or may not be aromatic provided that the point of attachment to a remaining position of the compounds disclosed herein is through an atom of the aromatic carbocyclic group. Aryl groups may be substituted with one or more groups other than hydrogen, such as alkyl, as well as any substitution groups described herein for alkyl. Non-limiting examples of aryl groups include, but are not limited to, benzyl, naphthalene, phenyl, biphenyl, phenoxybenzene, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted with one, two, three, four, or five substituents provided herein for alkyl. In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group. Aryl groups can have any suitable number of carbon ring atoms and any suitable number of rings. Aryl groups can include any suitable number of carbon ring atoms, such as C₆, C₇, C₈, C₉, C₁₀, C₁₁, C₁₂, C₁₃, C₁₄, C₁₅ or C₁₆, as well as C₆₋₁₂, C₆₋₁₀, or C₆₋₁₄. Bivalent radicals formed from substituted benzene derivatives and having the free valences at ring atoms are named as substituted phenylene radicals. Bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. Whenever it appears herein, a numerical range such as “6 to 10” (e.g., C₆-C₁₀ aromatic or C₆-C₁₀ aryl) refers to each integer in the given range; e.g., “6 to 10 ring atoms” means that the aryl group may consist of 6 ring atoms, 7 ring atoms, etc., up to and including 10 ring atoms. Aryl groups can be monocyclic, fused (i.e., rings which share adjacent pairs of ring atoms) to form bicyclic (e.g., benzocyclohexyl) or tricyclic groups or polycyclic groups, or linked by a bond to form a biaryl group. Representative aryl groups include phenyl, naphthyl and biphenyl. Other aryl groups include benzyl, having a methylene linking group. Unless stated otherwise specifically in the specification, an aryl moiety is optionally substituted by one or more substituents which are independently alkyl, heteroalkyl, acylsulfonamido, alkenyl, alkynyl, cycloalkyl, heterocycloalkyl, hydroxamate, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —S(O)ₜR^{a}— (where t is 1 or 2), —OC(O)—R^{a}, —N(R^{a})², C(O)R^{a}, C(O)OR^{a}, —OC(O)N(R^{a})², C(O)N(R^{a})², —N(R^{a})C(O)OR^{a}, —N(R^{a})C(O)R^{a}, N(R^{a})C(O)N(R^{a})₂, N(R^{a})C(NR^{a})N(R^{a})₂, N(R^{a})S(O)ₜR^{a} (where t is 1 or 2), —S(O)ₜR^{a} (where t is 1 or 2), —S(O)ₜOR^{a} (where t is 1 or 2), S(O)ₜN(R^{a})² (where t is 1 or 2), or PO(ORₐ)₂, where each Rₐ is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

By “arylene” is meant a multivalent (e.g., bivalent) form of an aromatic or aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. In some embodiments, the arylene group is branched or unbranched. In some embodiments, the arylene group is further substituted or unsubstituted. For example, In some embodiments, the arylene group is substituted with one or more substitution groups, as described herein for alkyl or aryl.

By “aryloxy” is meant —OR, where R is an optionally substituted aromatic or aryl group, as described herein. In some embodiments, an unsubstituted aryloxy group is a C₄₋₁₈ or C₆₋₁₈ aryloxy group.

By “arylalkoxy” is meant an alkyl-aryl group, as defined herein, attached to the parent molecular group through an oxygen atom. In some embodiments, the arylalkoxy group is —O-L-R, in which L is an alkylene group, as defined herein, and R is an aryl group, as defined herein.

By “aryloxycarbonyl” is meant an aryloxy group, as defined herein, that is attached to the parent molecular group through a carbonyl group. In some embodiments, an unsubstituted aryloxycarbonyl group is a C₅₋₁₉ aryloxycarbonyl group. In other embodiments, the aryloxycarbonyl group is —C(O)O—R, in which R is an aryl group, as defined herein.

By “aryloyl” is meant an aryl group that is attached to the parent molecular group through a carbonyl group. In some embodiments, an unsubstituted aryloyl group is a C₇₋₁₁ aryloyl or C₅₋₁₉ aryloyl group. In other embodiments, the aryloyl group is —C(O)—R, in which R is an aryl group, as defined herein.

By “(aryl)(alkyl)ene” is meant a bivalent form including an arylene group, as described herein, attached to an alkylene or a heteroalkylene group, as described herein. In some embodiments, the (aryl)(alkyl)ene group is -L-Ar— or -L-Ar-L- or —Ar-L-, in which Ar is an aromatic or arylene group and each L is, independently, an optionally substituted aliphatic, alkylene group, heteroaliphatic, or heteroalkylene group.

By “borono” is meant a —B(OH)₂ group.

By “carbonyl” is meant a —C(O)— group, which can also be represented as >C═O, or a —CO— group.

By “carboxyl” or “carboxylic acid” is meant a —CO₂H group or a compound including such a group, including deprotonated and protonated forms thereof.

By “carboxyalkyl” is meant an alkyl group, as defined herein, substituted by one or more carboxyl groups, as defined herein.

By “carboxyaryl” is meant an aryl group, as defined herein, substituted by one or more carboxyl groups, as defined herein.

By “cyclic anhydride” is meant a 3-, 4-, 5-, 6- or 7-membered ring (e.g., a 5-, 6- or 7-membered ring), unless otherwise specified, having a —C(O)—O—C(O)— group within the ring. The term “cyclic anhydride” also includes bicyclic, tricyclic, and tetracyclic groups in which any of the above rings is fused to one, two, or three rings independently selected from the group consisting of an aryl ring, a cyclohexane ring, a cyclohexene ring, a cyclopentane ring, a cyclopentene ring, and another monocyclic heterocyclic ring. Exemplary cyclic anhydride groups include a radical formed from succinic anhydride, glutaric anhydride, maleic anhydride, phthalic anhydride, isochroman-1,3-dione, oxepanedione, tetrahydrophthalic anhydride, hexahydrophthalic anhydride, pyromellitic dianhydride, naphthalic anhydride, 1,2-cyclohexanedicarboxylic anhydride, etc., by removing one or more hydrogen. Other exemplary cyclic anhydride groups include dioxotetrahydrofuranyl, dioxodihydroisobenzofuranyl, etc. The cyclic anhydride group can also be substituted or unsubstituted. For example, the cyclic anhydride group can be substituted with one or more groups including those described herein for heterocyclyl.

By “cycloaliphatic” is meant an aliphatic group, as defined herein, that is cyclic.

By “cycloalkoxy” is meant a cycloalkyl group, as defined herein, attached to the parent molecular group through an oxygen atom. In some embodiments, the cycloalkoxy group is —O—R, in which R is a cycloalkyl group, as defined herein.

By “cycloalkylalkoxy” is meant an alkyl-cycloalkyl group, as defined herein, attached to the parent molecular group through an oxygen atom. In some embodiments, the cycloalkylalkoxy group is —O-L-R, in which L is an alkylene group, as defined herein, and R is a cycloalkyl group, as defined herein.

By “cycloalkyl” is meant a monovalent saturated or unsaturated non-aromatic cyclic hydrocarbon group of from three to eight carbons, unless otherwise specified, and is exemplified by cyclopropyl, cyclobutyl, cyclopentyl, cyclohexyl, cycloheptyl, bicyclo[2.2.1.heptyl], and the like. The cycloalkyl group can also be substituted or unsubstituted. For example, the cycloalkyl group can be substituted with one or more groups including those described herein for alkyl.

By “cycloheteroaliphatic” is meant a heteroaliphatic group, as defined herein, that is cyclic.

By “disulfide” is meant —SSR, where R is selected from hydrogen, aliphatic, heteroaliphatic, haloaliphatic, haloheteroaliphatic, aromatic, as defined herein, or any combination thereof.

By “formyl” is meant a —C(O)H group.

By “halo” is meant F, Cl, Br, or I.

By “haloaliphatic” is meant an aliphatic group, as defined herein, substituted with one or more halo.

By “haloalkyl” is meant an alkyl group, as defined herein, substituted with one or more halo.

By “haloalkenyl” is meant an alkenyl group, as defined herein, substituted with one or more halo.

By “haloalkynyl” is meant an alkynyl group, as defined herein, substituted with one or more halo.

By “haloalkylene” is meant an alkylene group, as defined herein, substituted with one or more halo.

By “halocarbonyl” is meant a —C(O)X group, in which X is halo, as defined herein.

By “haloheteroaliphatic” is meant a heteroaliphatic, as defined herein, in which one or more hydrogen atoms, such as one to 10 hydrogen atoms, independently is replaced with a halogen atom, such as fluoro, bromo, chloro, or iodo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to boron, halo, nitrogen, oxygen, phosphorus, selenium, silicon, sulfur, and, if applicable, oxidized forms thereof within the group.

By “heteroalkyl,” “heteroalkenyl,” and “heteroalkynyl” is meant an alkyl, alkenyl, or alkynyl group (which can be branched, straight-chain, or cyclic), respectively, as defined herein, including at least one heteroatom to 20 heteroatoms, such as one to 15 heteroatoms, or one to 5 heteroatoms, which can be selected from, but not limited to, boron, halo, nitrogen (e.g., as present in imino), oxygen, phosphorus, selenium, silicon, sulfur, and, if applicable, oxidized forms thereof within the group.

By “heteroalkylene” is meant a multivalent (e.g., bivalent) form of a heteroaliphatic or heteroalkyl group, as described herein. The heteroalkylene group can be substituted or unsubstituted. For example, in some embodiments the heteroalkylene group is substituted with one or more substitution groups, as described herein for alkyl.

By “heteroalkenylene” is meant a multivalent (e.g., bivalent) form of a heteroalkenyl group, which is an optionally substituted heteroalkyl group having one or more double bonds. The heteroalkenylene group can be cyclic or acyclic. The heteroalkenylene group can be substituted or unsubstituted. For example, the heteroalkenylene group can be substituted with one or more substitution groups, as described herein for alkyl.

By “heteroalkynylene” is meant a multivalent (e.g., bivalent) form of a heteroalkynyl group, which is an optionally substituted heteroalkyl group having one or more triple bonds. The heteroalkynylene group can be cyclic or acyclic. The heteroalkynylene group can be substituted or unsubstituted. For example, the heteroalkynylene group can be substituted with one or more substitution groups, as described herein for alkyl.

By “heteroaromatic” is meant an aromatic group, as defined herein, including at least one heteroatom to 20 heteroatoms, such as one to 15 heteroatoms, or one to 5 heteroatoms, which can be selected from, but not limited to boron, nitrogen, oxygen, phosphorus, selenium, silicon, sulfur, and oxidized forms thereof within the group.

By “heteroaryl” is meant an aryl group including at least one heteroatom to six heteroatoms, such as one to four heteroatoms, which can be selected from, but not limited to, boron, nitrogen, oxygen, phosphorus, selenium, silicon, sulfur, and oxidized forms thereof within the ring. Such heteroaryl groups can have a single ring or multiple condensed rings, where the condensed rings may or may not be aromatic or may contain a heteroatom, provided that the point of attachment is through an atom of the aromatic heteroaryl group. Heteroaryl groups may be substituted with one or more groups other than hydrogen, such as alkyl, as well as any substitution groups described herein for alkyl. A non-limiting example of heteroaryl includes a subset of heterocyclyl groups, as defined herein, which are aromatic, e.g., they contain 4n+2 pi electrons within the mono- or multicyclic ring system.

By “heteroarylene” is meant a multivalent (e.g., bivalent) form of a heteroaromatic or heteroaryl group, as described herein. Exemplary heteroarylene groups include pyridinylene and the like. In some embodiments, the heteroarylene group is a C₄₋₁₈, C₄₋₁₄, C₄₋₁₂, C₄₋₁₀, C₆₋₁₈, C₆₋₁₄, C₆₋₁₂, or C₆₋₁₀ heteroarylene group. In some embodiments, the heteroarylene group is branched or unbranched. In some embodiments, the heteroarylene group is further substituted or unsubstituted. For example, in some embodiments, the heteroarylene group is substituted with one or more substitution groups, as described herein for alkyl or aryl.

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorus, selenium, silicon, or sulfur). The 3-membered ring has zero to one double bonds, the 4- and 5-membered ring has zero to two double bonds, and the 6- and 7-membered rings have zero to three double bonds. The term “heterocyclyl” also includes bicyclic, tricyclic, tetracyclic, or other multicyclic groups. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl, benzylsultimyl, bipyrazinyl, bipyridinyl, carbazolyl (e.g., 4H-carbazolyl), carbolinyl (e.g., β-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxooxolanyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxolanyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for alkyl.

By “heterocyclyloxy” is meant a heterocyclyl group, as defined herein, attached to the parent molecular group through an oxygen atom. In some embodiments, the heterocyclyloxy group is —O—R, in which R is a heterocyclyl group, as defined herein.

By “heterocyclyloyl” is meant a heterocyclyl group, as defined herein, attached to the parent molecular group through a carbonyl group. In some embodiments, the heterocyclyloyl group is —C(O)—R, in which R is a heterocyclyl group, as defined herein.

By “hydroxy” is meant —OH.

By “hydroxyalkyl” is meant an alkyl group, as defined herein, substituted by one to three hydroxy groups, with the proviso that no more than one hydroxy group may be attached to a single carbon atom of the alkyl group and is exemplified by hydroxymethyl, dihydroxypropyl, and the like.

By “hydroxyaryl” is meant an aryl group, as defined herein, substituted by one to three hydroxy groups, with the proviso that no more than one hydroxy group may be attached to a single carbon atom of the aryl group and is exemplified by hydroxyphenyl, dihydroxyphenyl, and the like.

By “imido” is meant a ═NR group, where R is selected from H, aliphatic, alkyl, heteroaliphatic, heteroalkyl, aromatic, or aryl, as defined herein, or any combination thereof.

By “imino” is meant —NR—, in which R can be H, optionally substituted aliphatic, alkyl, heteroaliphatic, heteroalkyl, aromatic, or aryl.

By “isocyanato” is meant a —NCO griyo.

By “nitro” is meant an —NO₂ group.

By “nitroalkyl” is meant an alkyl group, as defined herein, substituted by one to three nitro groups. In some embodiments, the nitroalkyl group is -L-NO, in which L is an alkylene group, as defined herein. In other embodiments, the nitroalkyl group is -L-C(NO)(R¹)—R², in which L is a covalent bond or an alkylene group, as defined herein, and each of R¹ and R² is, independently, H or alkyl, as defined herein.

By “oxiranyl” is meant a

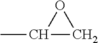

group or a

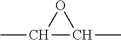

group, in which one or more hydrogen atoms can be optionally substituted with another functional group (e.g., halo, alkyl, or any described herein as a substituent for alkyl).

By “oxo” or “oxide” is meant an ═O group.

By “oxy” is meant —O—.

By “phosphono” or “phosphonic acid” is meant a —P(O)(OH)₂ group or a compound including such a group, including deprotonated and protonated forms thereof.

By “perfluoroalkyl” is meant an alkyl group, as defined herein, having each hydrogen atom substituted with a fluorine atom. Non-limiting examples of perfluoroalkyl groups include trifluoromethyl, pentafluoroethyl, etc. In some embodiments, the perfluoroalkyl group is —(CF₂)ₙCF₃, in which n is an integer from 0 to 20, 1 to 20, 1 to 18, 1 to 16, 1 to 14, 1 to 12, 1 to 10, 1 to 8, 2 to 20, 2 to 18, 2 to 16, 2 to 14, 2 to 12, 2 to 10, 2 to 8, and ranges therebetween.

By “perfluoroalkoxy” is meant an alkoxy group, as defined herein, having each hydrogen atom substituted with a fluorine atom. In some embodiments, the perfluoroalkoxy group is —O—R, in which R is a perfluoroalkyl group, as defined herein.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S. M. et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium).

By “silane” is meant —SiR^{S1}R^{S2}R^{S3}, —SiR^{S1}R^{S2}—, or a compound having such groups, where each of R^{S1}, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group.

By “silyl ether” is meant a functional group including a silicon atom covalently bound to an alkoxy group, as defined herein. In some embodiments, the silyl ether is —Si—O—R or Si—O—R, in which R is an alkyl group, as defined herein.

By “sulfinyl” is meant an —S(O)— group.

By “sulfo” or “sulfonic acid” is meant an —S(O)₂OH group or a compound including such a group, including deprotonated and protonated forms thereof.

By “sulfonyl” or “sulfonate” is meant an —S(O)₂— group or a —SO₂R, where R is selected from hydrogen, aliphatic, alkyl, heteroaliphatic, heteroalkyl, haloaliphatic, haloheteroaliphatic, aromatic, aryl, as defined herein, or any combination thereof.

By “thio” is meant —S—.

By “thiol” is meant an —SH group.

By “thioalkoxy” is meant an alkyl group, as defined herein, attached to the parent molecular group through a sulfur atom. Non-limiting examples of unsubstituted thioalkoxy groups include C₁₋₆ thioalkoxy. In some embodiments, the thioalkoxy group is —S—R, in which R is an aliphatic or alkyl group, as defined herein.

By “thioalkoxyalkyl” is meant an alkyl group, as defined herein, which is substituted with a thioalkoxy group, as defined herein. Non-limiting examples of unsubstituted thioalkoxyalkyl groups include between 2 to 12 carbons (C₂₋₁₂ thioalkoxyalkyl), as well as those having an alkyl group with 1 to 6 carbons and a thioalkoxy group with 1 to 6 carbons (i.e., C₁₋₆ thioalkoxy-C₁₋₆ alkyl). In some embodiments, the thioalkoxyalkyl group is -L-S—R, in which L is alkylene, as defined herein, and R is an alkyl group, as defined herein.

### II. Methods of Forming a Functionalized Material

A functionalized material can be prepared in any useful manner. In some embodiments, a functionalization mixture is prepared that includes the substrate, a solvent, and one or more compounds to provide a functional portion. In some embodiments, at least one of the compounds in the functionalization mixture has an amine moiety and at least one of the compounds in the functionalization mixture has a silane moiety. In particular embodiments, at least one compound in the functionalization mixture has both an amine moiety and a silane moiety.

In some embodiments, the polymer coating, chelating agent(s), and/or antioxidant(s) are introduced by any useful operation described herein. For example and without limitation, in some embodiments a polymer for the polymer coating is introduced to the substrate prior to, during, or after the functionalization mixture is applied to the substrate. In another example, the chelating agent(s) are introduced to the substrate prior to, during, or after the functionalization mixture is applied to the substrate. In yet another example, the antioxidant(s) is introduced to the substrate prior to, during, or after the functionalization mixture is applied to the substrate. Optionally, the chelating agent(s) and/or antioxidant(s) are introduced with the polymer of the polymer coating. In another option, the chelating agent(s) and/or antioxidant(s) are introduced with the functionalization mixture.

In some embodiments, the functionalization mixture is prepared in any useful manner. In one non-limiting example, a suspension mixture is prepared that includes the substrate and a solvent. To this suspension mixture is added a compound (to provide a functional portion) to form a functionalization mixture. Non-limiting examples of compounds that are added include a silane coupling material, an aminosilane, a polyamine, or a combination of any of these compounds. In some embodiments, functionalization is conducted using solution-based reaction conditions.

Various methods are employed to provide the functionalized materials described herein. In some embodiments, the functionalized material is produced using solution-based reaction methods in which a silane-containing compound (e.g., an aminosilane compound with an amine moiety and a silane moiety) is solvated and the substrate (e.g., porous silica, MOF, or resin) is added. The silane moiety binds to the substrate surface while the amine moieties extend from the silane moiety. The resultant substrate is filtered from the solvent, washed, and dried. In some embodiments, the functionalized material is further reacted with a polymeric/oligomeric amine compound. The mixture is stirred and then dried, thereby functionalizing the substrate with both the silane-containing compound and the polymeric/oligomeric amine in such embodiments.

In other embodiments, the functionalized material is produced using solvent-based reaction methods in which a polyamine (e.g., a compound with a plurality of amine moieties) or an oligomeric ethylene amine compound (e.g., a compound with a plurality of ethylene groups and amine moieties, as well as mixtures of such compounds, including any described herein) with an optional aminosilane compound (e.g., a compound with an amine moiety and a silane moiety) is solvated (e.g., water-based reaction methods when the aminosilane compound is absent), and the substrate (e.g., porous silica, MOF, or resin) is added. When polyamine is used alone, in some embodiments, the polyamine has an increased number of amine moieties for increased carbon capture (e.g., >2 mol/kg) in the functionalized material. When both a polyamine and an aminosilane is employed, the polyamine and aminosilane compounds react to form a complex network that bonds to the substrate surface. When the oligomeric ethylene amine compound or mixture thereof is used alone, in some embodiments, the oligomeric ethylene amine compound or a mixture thereof has an increased number of amine moieties for increased carbon capture (e.g., >1 mol/kg) in the functionalized material. In some embodiments the resulting material is stirred, optionally filtered from the solvent, optionally washed, and dried.

Any of these methods (e.g., such as the process in FIGS. 3A-3C) are used to provide any functionalized material described herein (e.g., a functionalized material 100A-100C in FIGS. 1A-IC) in some embodiments.

FIGS. 3A-3C are non-limiting flow chart diagrams showing examples of steps for producing a functionalized material. These diagrams are further described below.

In some embodiments the synthesis of the functionalized material is conducted under industrially applicable reaction conditions, e.g., such as liquid application to particles undergoing tumbling or mixing motion. After synthesis, the adsorbent is optionally purified, dried, and optionally activated before being used as a CO₂ adsorbent.

As seen in FIG. 3A, a non-limiting process 300A for making functionalized material includes preparing coated particles that, in turn, are further functionalized to provide functionalized coated particles (e.g., for use in a reversible adsorbent material, such as a reversible CO₂ adsorbent).

Referring to FIG. 3A, in some implementations, the process 300A is performed at large scale, e.g., producing 1 kilogram or more of functionalized material in a single process. In some implementations, the process 300A produces 100 kilograms or more of functionalized material (e.g., up to 10,000 kg). To maintain the original particle size distribution and reduce further attrition, agitation methods in which the particles are subjected to comparatively low friction or stirring forces are preferred, such as overhead stirring, gentle tumbling, slow and periodic stirring, or vibration.

The process 300A includes introducing porous particles (e.g., porous silica particles) to a first reagent including a polymer, and an optional chelating agent, to provide a plurality of coated particles (step 302A). Step 1 of Example 23 is an example of step 302A in which no chelating agent is used.

In some embodiments, the chelating agent is added. In some such embodiments the chelating agent is within the polymer coating

In some embodiments the porous particles are any of particles 102A-C of FIGS. 1A-1C. A solvent into which the porous particles and the first reagent are introduced solvates the polymer and optional chelating agent into a coating liquid and exposes the dissolved molecules to the porous particles. The dissolved molecules of the first reagent adsorb to the surfaces and pores of the porous particles to form coated particles.

The solvent for step 302A depends on the polymer used. Using the example polymer provided herein, PVA is water-soluble and therefore an example of the solvent is water. Other solvents are selected based on the criteria of the polymer that is used to create the protective coating in step 302A.

In an example, the process 300A is a ‘wet’ method, such as dip-coating, in which the volume of solvent is much larger than the volume of liquid the porous particles are capable of adsorbing. In the example, the porous particles are introduced to the solvent such that the particles are fully submerged in the solvent and at a wt:wt ratio in a range from 1.5 to 4:1 solvent to substrate (e.g., porous particles).

In the example of a batch method, the polymer is introduced to the solvent at a ratio sufficient for the polymer to be fully dissolved in the solvent, e.g., no precipitation occurs, no precipitant is present. The quantity of polymer introduced to the solvent is sufficient to coat the quantity of particles to be coated in the process 300A to achieve the desired characteristics described herein. In the example of PVA (or any other polymer), the polymer is introduced in a (wt/wt) percentage of up to 20% of the polymer to the substrate (e.g., porous particles), such as, e.g., up to 15% (wt/wt), up to 12% (wt/wt), up to 10% (wt/wt), up to 8% (wt/wt), less than 12% (wt/wt), or less than 9% (wt/wt). In some embodiments, the polymer is introduced (e.g., to a first solvent) in a (wt/wt) percentage from about 1% to 20% (wt/wt) of the polymer to the substrate (e.g., from about 1% to 5%, 1% to 10%, 1% to 15%, 3% to 5%, 3% to 10%, 3% to 15%, 3% to 20%, 5% to 10%, 5% to 15%, 5% to 20%, 7% to 10%, 7% to 15%, 7% to 20%, 10% to 15%, 10% to 20%, 13% to 15%, 13% to 20%, or 15% to 20% (wt/wt)).

Furthermore, in some embodiments, one or more chelating agent(s) are introduced to the coating liquid (first reagent) including the polymer used to coat the substrate. In some embodiments, the chelating agent(s) are introduced in a (wt/wt) percentage of up to 5% of the chelating agent(s) to the substrate (e.g., porous particles), such as, e.g., from about 0.1% to 5% (wt/wt) to the substrate.

In another example, the process 300A is a spray method in which the volume of solvent is similar to the volume of liquid the porous particles are capable of adsorbing. In such an example, the solvent is introduced to the particles such that the particles are ‘wetted’ by the solvent and at a wt:wt ratio in a range between 0.2 and 15:1 solvent to substrate (e.g., porous particles). In examples in which a spray method is used, the solvent and/or other additives (e.g., chelation agents, antioxidants, polymer materials) are sprayed in single, or multiple steps, alone, or in combinations in which the solubility and/or reactivity of the agents/solvents are compatible. In one example, PVA and a chelating agent are sprayed on in a first step in solvent, Then the sorbent is dried and subsequently sprayed with one or more additives (e.g., PEI, aminosilane, antioxidant, and crosslinker) in the same, or different, solvent (e.g., isopropyl alcohol/hexane).

The process 300A includes introducing a second reagent comprising at least one adsorbing moiety to the coated silica particles to form functionalized coated particles at step 304A. In some embodiments of step 304A, an optional antioxidant, crosslinker, and/or third reagent comprising at least one interaction moiety is also added to the coated silica particles. Example 11 illustrates an instance of adding the hindered amine light stabilizer Chimassorb 944 FDL as an antioxidant. Example 12 illustrates an instance of adding Irganox 1076 as an antioxidant. Example 13 illustrates an instance of adding Irganox 1010 as an antioxidant. Example 14 illustrates an instance of adding an antioxidant that includes 2,2,6,6-tetramethylpiperidine units (TINUVIN 622 SF (T622); BASF SE, Ludwigshafen, Germany). Example 15 illustrates an instance of adding 2-Methyl-4,6-[(octylthio)methyl]phenol CAS No.: [110553-27-0], Rianlon Corporation, Tianjin, China) having the chemical structure:

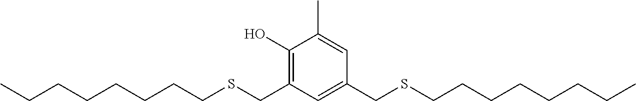 [SMILES: CCCCCCCCSCc1cc(C)c(O)c(CSCCCCCCCC)c1]

as an antioxidant. Example 16 illustrates an instance of adding RIANOX 5057, CAS No.: [68411-46-1], Rianlon Corporation, Tianjin, China as an antioxidant. Example 17 illustrates an instance of adding 2,2-thiodiethylene bis[3-(3,5-di-tert-butyl-4-hydroxyphenyl)propionate](RIANOX 1035, CAS No.: [41484-35-9], Rianlon Corporation, Tianjin, China) as an antioxidant. Example 18 illustrates an instance of adding bis(2,4-di-t-butylphenyl)pentaerythritol diphosphite (RIANOX 626, (R626); CAS No.: [26741-53-7], Rianlon Corporation, Tianjin, China) as an antioxidant. Example 19 illustrates an instance of adding dilauryl 3,3′-thiodipropionate (RIANOX DLTP, (R-DLTP); CAS No.: [123-28-4], Rianlon Corporation, Tianjin, China) as an antioxidant. Example 20 illustrates an instance of adding pentaerythrityl tetrakis (3-laurylthiopropionate) (RIANOX 412S, (R412S); CAS No.: [29598-76-3], Rianlon Corporation, Tianjin, China) as an antioxidant. Example 21 illustrates an instance of adding RIANOX UV-791, ((RUV791), Rianlon Corporation, Tianjin, China) as an antioxidant. Example 22 illustrates an instance of adding CeO₂ nanoparticles as an antioxidant.

Introducing the second and, optionally the third reagent, functionalizes the surfaces and pores of the coated particles with an adsorbing moiety (e.g., one or more amine moieties provided by a compound, such as an amine, an aminosilane, a polyamine, a monoamine, and the like). In embodiments where the third reagent is also added, it additionally introduces an interaction moiety (e.g., a silane moiety provided by a compound, such as a silane, an aminosilane, and the like).

In some embodiments, the second reagent is a polyamine.

In some embodiments, the third reagent is an aminosilane.

Other combinations are possible (e.g., any described herein). For example and without limitation, in some embodiments the second reagent is an amine (e.g., a polyamine, a monoamine, or an aminosilane), and the third reagent is an aminosilane or a silane (e.g., any described herein).

In some embodiments, the second reagent includes both an adsorbing moiety and an interaction moiety (e.g., as in aminosilane), and the third reagent is omitted.

In some embodiments one more antioxidants is introduced in step 304A. Introducing such antioxidant(s) provide functionalized coated particles that scavenge oxygen or other oxidative species that, in turn, results in reduced oxidation of amine-containing functional groups of the adsorbing species.

In some embodiments a crosslinker is introduced in step 304A. In such embodiments, the crosslinker reacts with one or more amine functional group to turn primary amine groups to secondary amine groups, and secondary amine groups to tertiary amine groups. For antioxidant resistance, a tertiary amine has higher resistance to oxidation than a secondary amine, which has higher resistance to oxidation than a primary amine. Therefore, the crosslinking turns crosslinked amine groups into more oxidization resistance species of amine groups and thus increases the chemical lifetime of the functionalized material. Examples of crosslinkers include, but are not limited to, diisocyanates, formaldehyde, dialdehydes, boric acid, isocyanates, dihaloalkanes, diepoxides, dianhydrides (EDTA), dianhydride, and diacid chlorides.

In examples in which the polymer used in step 302A is polyethyleneimine (PEI), crosslinking binds the amine groups on PEI and therefore increases the stability of PEI binding and reduces evaporation during the adsorption/desorption processes, thus reducing the chance of amine loss during use and increasing the functional lifetime of the functionalized material.

Functionalizing the particles in accordance with step 304A includes exposing the porous particles to a functionalization mixture (e.g., second reagent and optionally the third reagent). The functionalization mixture (second reagent) includes any compound(s) herein to provide a functional portion (e.g., one or more of amines, aminosilanes, polyamines, monoamines, or any combination of any of these), any compound(s) herein to provide a polymer coating (e.g., one or more polymers, such as PVA), any chelating agent(s) herein, or any antioxidant(s) herein, as well as combinations of any of these.

In one non-limiting embodiment, creating the functionalization mixture includes introducing the second reagent including a polyamine and the third reagent comprising a silane moiety and an amine functional group (e.g., an aminosilane) into a volume of a second solvent to form the functionalization mixture. In some embodiments the second solvent is an organic solvent such as ethanol. For example, in some embodiments the second solvent is selected such that the polymer used to coat the particles is not miscible in the second solvent, thereby minimizing removal of the protective polymer coating from the coated particles that was added in step 302A while introducing the polyamine and aminosilane in step 304A. As used herein, the terms “reagent” and “compound” are used interchangeably. Depending on use, a reagent optionally includes one or more solvents, salts, or other compounds. Example 5 provides an example of a functionalization mixture that includes a second reagent including the polyamine polyethyleneimine (PEI) and the third reagent comprising the aminosilane aminopropyltrimethoxysilane (DAMO) in the second solvent ethanol.

In one example, the first solvent is water, and the second solvent is hexane.

While an example functionalization mixture includes a polyamine and an aminosilane, any useful combination of compounds is employed (e.g., any combination of one or more of an aminosilane, a silane, a polyamine that can include non-polymeric or polymeric amines, a monoamine, and the like) in accordance with the present disclosure.

In some embodiments, the second reagent, the third reagent, and the volume of second solvent are mixed and dispensed.

In some embodiments, the second reagent is a polyamine (e.g., a polymeric amine), such as any polyamine described herein.

In some embodiments the second solvent is dispensed to fully suspend the polyamine, for example, by dispensing 20 mL/g of the second solvent to polyamine (e.g., 10 mL/g, 15 mL/g, or 25 mL/g). In some embodiments the polyamine is added to the second solvent in a range between 5% (wt/wt) to 20% (wt/wt) of the substrate to be functionalized in step 304A (e.g., 6% (wt/wt), 8% (wt/wt), 10% (wt/wt), 12% (wt/wt), 14% (wt/wt), 16% (wt/wt), or 18% (wt/wt)).

Alternatively, the solvent is dispensed to entirely cover the coated particles within the vessel, for example, by dispensing from 1 to 15 mL/g of the solvent to the coated particles (e.g., 1 mL/g, 5 mL/g, 8 mL/g, 15 mL/g, 2 to 2 mL/g, 2 to 2.5 mL/g, or other ranges herein). The solvent is any described herein.

In some embodiments the third reagent is a silane coupling material that includes a silane moiety (e.g., as in an amino silane or a silane, such as any described herein). In some embodiments the silane coupling material is dispensed in a range between 20% (wt/wt) to 80% (wt/wt) of a loading silane to the substrate to be functionalized in step 304A (e.g., 25% (wt/wt), 30% (wt/wt), 35% (wt/wt), 45% (wt/wt), 50% (wt/wt), or 60% (wt/wt)).

In some embodiments the third reagent is an adsorbing moiety material that can include one or more adsorbing moieties (e.g., one or more amine moieties, such as any described herein). In some embodiments the adsorbing moiety material is dispensed in a range between 20% (wt/wt) to 80% (wt/wt) of a loading silane to the substrate to be functionalized in step 304A (e.g., 25% (wt/wt), 30% (wt/wt), 35% (wt/wt), 45% (wt/wt), 50% (wt/wt), or 60% (wt/wt)).

In some embodiments the liquid mixture is stirred until the polyamine and the silane coupling material are fully suspended in the second solvent. In some examples, mechanical stirring with a propeller, a magnetic stirrer, or sonication disperses the polyamine in a time range from about 5 minutes (min) to 60 min (e.g., from 10 min to 30 min, from 5 min to 30 min, from 10 min to 45 min).

In some implementations, one or more additives are included in the functionalization mixtures of step 304A to extend the operational lifetime of the functionalized coated particles. For example, the addition of bis[3-(trimethoxysilyl)propyl]amine) (BTMSPA):

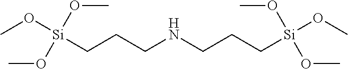

to the functionalization mixture of step 304A to increase the operational lifetime of the functionalized coated particles in some embodiments. As the structure for BTMSPA above illustrates, it is an aminosilane having two ends, in which each end has a trimethoxysilyl reactive group. The BTMSPA bonds on the coated particles with six binding points, as contrasted with the three binding points for an aminosilane with a single reactive group, such as would be present in a compound having a methoxydialkylsilyl reactive group. The increased number of binding points increases the binding stability with the coated particles. The BTMSPA forms a network with other aminosilanes and polyamines on the surface of the coated particles that increases binding stability of the overall network.

In another example, the addition of a chelator to the polymer used during coating (step 302A) increases the operational lifetime of the functionalized coated particles. In yet another example, the addition of an antioxidant with the polyamine and/or aminosilane used during functionalization (step 304A increases the operational lifetime of the functionalized coated particles.

Optionally, the functionalization mixture of step 304A is agitated for a duration to allow hydrolysis of and to fully dissolve the silane coupling material and polyamine. In some non-limiting examples, this agitation time period is between 1 minute (min) and 10 minutes (e.g., 5 min). Optionally, the functionalization mixture of step 304A is heated (e.g., to a heating temperature above ambient temperature and below 90° C.) and/or cooled (e.g., passively, for instance by way of radiant cooling) to any useful temperature, such as room temperature.

Turning to FIG. 3B, in some embodiments, the polymer coating, the chelating agent, the antioxidant, and the crosslinker are employed. As seen in FIG. 3B, the process 300B includes introducing porous particles (e.g., porous silica particles) to a chelating agent and a first reagent including a polymer to provide a plurality of coated particles (step 302B). Any useful chelating agent in any useful amount (e.g., any described herein) is included with the first reagent. Example 6 illustrates one instance of performing step 302B with the chelator etidronic scid (ETDA) in accordance with the present disclosure. Example 7 illustrates another instance of performing step 302B with the chelator tripotassium phosphate in accordance with the present disclosure. Example 8 illustrates another instance of performing step 302B with the chelator Trilon D in accordance with the present disclosure. Example 9 illustrates another instance of performing step 302B with the chelator Trilon B in accordance with the present disclosure. Example 10 illustrates another instance of performing step 302B with the chelator Trilon M in accordance with the present disclosure.

The process 300B further includes functionalizing the coated particles by exposing the coated particles to a functionalization mixture that includes an antioxidant (e.g., any useful antioxidant in any useful amount, such as described herein), a crosslinker (e.g., any useful crosslinker in any useful amount, such as described herein), a second reagent, and a third reagent. Details regarding the second and third reagents are, for example, as provided herein for process 300A.

FIG. 3C illustrates how coating, functionalizing, and introduction of a chelating agent is performed in any combination. As seen in FIG. 3C, the process 300C include introducing porous particles (e.g., porous silica particles) to a first reagent that includes a polymer to provide a plurality of coated particles (step 302C).

The process 300C further includes functionalizing the coated particles by exposing the particles to a functionalization mixture that includes a second reagent and a third reagent. Details regarding the second and third reagents are, for example, as provided herein for process 300A.

The process 300C also include introducing a fourth reagent comprising the chelating agent to the plurality of functionalized coated particles, thereby providing a plurality of further functionalized coated particles (step 306C). Introducing the fourth reagent chelates the one or more metals present on the surfaces and pores of the functionalized coated particles to reduce oxidation of the adsorbing moieties.

In some embodiments, chelation includes exposing the functionalized coated particles to the chelating agent. In some such embodiments, the chelating agent is suspended in a chelation solvent, e.g., mixed with the chelation solvent, to form a chelating mixture, and the chelating mixture is applied to the functionalized coated particles, such as through spraying. The chelation solvent is selected such that the polymer used to coat the functionalized coated particles is not miscible in the chelating solvent, which minimizes removal of the protective polymer coating from the coated particles while introducing the chelating agent.

The steps of processes 300A-300C, e.g., steps 302A-C, 304A-C, or 306C, can be performed in any order, e.g., in other examples, the particles are functionalized, chelated, and then coated; or the particles are functionalized and then coated, with optional drying separating the steps.

Optionally, process 300A-C include one or more steps (e.g., a separate step or a step combined with another step present in the process) for introducing a fifth reagent comprising an antioxidant. Examples of antioxidants for use in the methods include sacrificial antioxidants and cyclic antioxidants. In some examples, more than one antioxidant is introduced. The antioxidant(s) is added in any of steps 302A-C, 304A-C, or 306C of the process 300A-C, or after such steps are performed.

Optionally, the processes 300A-C include one or more steps for washing the porous particles to minimize the presence of one or more metals. In some embodiments, washing includes the use of an acid (e.g., a dilute acid).

Optionally, the processes 300A-C include one or more steps for oxidizing metals present in the porous particles by raising the temperature of the porous particles above a threshold for a duration before the first, second, third, fourth, or fifth reagents are introduced. Metals found on the surfaces and pores of the porous particles is available for oxygenation during the lifetime of the functionalized coated particles. By raising the temperature of the porous particles, the metals can be completely- or near-completely oxidized thereby reducing the effects of oxidation on the functionalized coated particles during carbon capture processes when the functionalized particles are exposed to atmospheric oxygen. The complete oxidation of the metals present on the surface of the porous particles helps passivate the substrate to catalyze the oxidation of the amines during operation. One non-limiting example of the temperature threshold is 300° C. (e.g., 400° C.). One non-limiting example of the duration is at least one hour (e.g., at least two hours, at least three hours).

The temperature to which the porous particles is raised depends on the composition of metals that are present in the porous particles. Iron and copper are examples of metal contaminants that can be oxidized by raising the temperature of the porous particles in the presence of an oxygen-containing gas, e.g., air.

Optionally, the processes 300A-C include one or more steps for filtering the coated particles, functionalized coated particles, or both. Filtering is performed using methods known in the art for separating solid from liquid phases. This includes, but is not limited to, vacuum filtration, centrifugation, vacuum evaporation, or a combination of these or other methods in some embodiments. The volume of solvent separated from the coated particles or functionalized particles is discarded, stored, or recycled.

Optionally, the processes 300A-C include washing the substrate, coated particles, and/or functionalized coated particles in at least one wash volume of fresh (e.g., a new volume) solvent medium. For example, the functionalized coated particles can be immersed in a wash volume of fresh solvent medium (e.g., 40 mL of solvent for 4 g of functionalized material), in which a single wash or a plurality of washes is performed. In some embodiments, the wash solvent dissolves the silane moiety to remove moieties coated on the surface of functionalized coated particles but is not reacted.

Optionally, the processes 300A-C include one or more steps for drying the coated particles, functionalized coated particles, or both. In some embodiments, drying the particles includes increasing the temperature, reducing the atmospheric pressure, passing an inert dry gas over them, passing a heated dry gas over them, or a combination of these. Drying occurs after the particles are introduced to the coating mixture, after the particles are introduced to the functionalization mixture, or both, in order to remove substantially all of the first solvent, or the second solvent entrained in or on the particles, in some embodiments. For example, in some implementations, the functionalized material is dried in an oven (e.g., a vacuum oven) at 50° C. for 12 hours, e.g., overnight, or at 70° C. for between 5 min and 20 min. Drying times longer than 60 min at elevated temperatures reduce the adsorption capacity of the final product. However, in some embodiments the drying time is scale- or condition(s)-dependent. For example, when drying under N₂ or vacuum, the drying time is longer in some embodiments. In examples in which batch drying is performed, even with N₂ or vacuum, drying times are longer than 60 min, depending on the scale of the functionalized particles which are being dried, in some embodiments. Alternatively, the functionalized material is dried until a hydration threshold is reached. As non-limiting examples, the drying threshold is a weight lost by the sample of 15% (e.g., weight lost to solvent removal) or having minimal weight loss (e.g., a weight loss of less than about 5% over a period of about 2 hours at 100° C.) with an inert gas flow (e.g., 50 mL/min of N2 flow) through the sample (e.g., as measured on TGA)). In some embodiments, the functionalized coated particles are dried until a hydration threshold is reached, e.g., such as <5% (wt/wt) solvent to functionalized coated particles remains. The functionalized coated particles is then be prepared for use as a reversible sorbent material.

In some embodiments, the functionalized coated particles are reused through the desorption process. For example, in some embodiments the functionalized coated particles are reused 100 times or more (e.g., 1000 times or more, 10000 times or more). For the desorption process, in some embodiments, the functionalized coated particles are heated to 70° C. or higher under vacuum for 30 min (the duration may change based on temperature and/or vacuum level). Without wishing to be limited by theory, this can facilitate release of CO₂ captured during the adsorption process, in which release CO₂ can be collected for further sequestration, described with reference to the systems for direct air capture herein. A non-limiting aspect of the desorption process is to maintain the functionalized coated particles heated under a water vapor filled vacuum environment (e.g., >10% relative humidity). Without wishing to be limited by mechanism, this reduces functionalized coated particle degradation.

### III. Production Systems

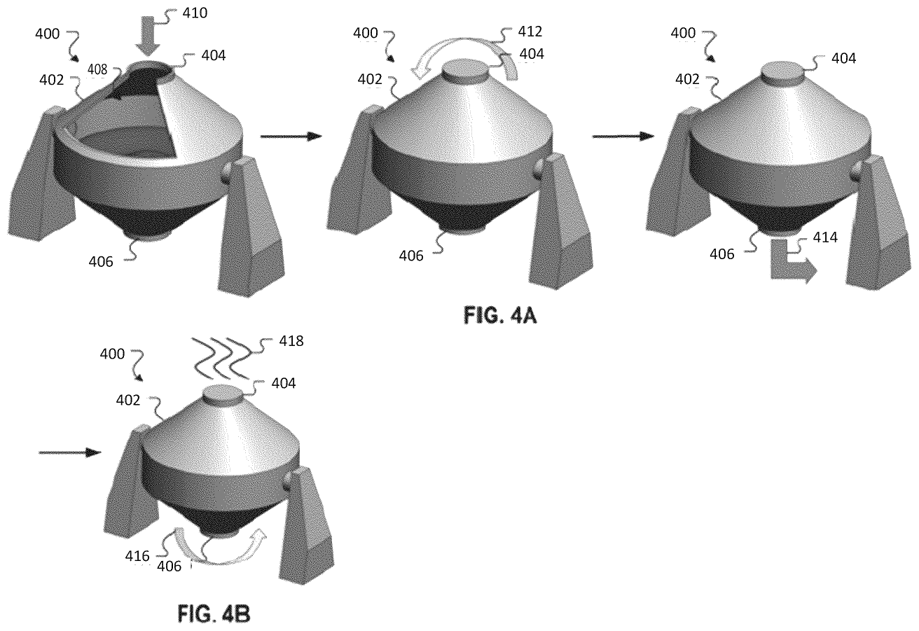

Any useful component can be used to form a functionalized material. In some embodiments, one or more components can be employed in a dip coating system. FIGS. 4-9 are example systems by which a functionalized material can be produced in coating and functionalization methods, such as process 300A-C, described herein.

FIGS. 4A-4B shows a double cone tumble mixing system 400 which includes a tumbler 402 having an inlet 404, outlet 406, and an inner volume 408. The double cone mixing system 400 results in a high degree of particle mobility during mixing when the substrate is added to the inner volume 408 through the inlet 404. In general, the contents of the tumbler 402 are mixed by rotating the tumbler 402 around a central horizontal axis.

The double cone tumble mixing system 400 is an efficient machine for mixing of dry powders and granules homogeneously. All of the surfaces which contact the contents can be manufactured from non-reactive metal, such as stainless steel, glass, or glass-coated interior, to prevent interaction with the polymer for coating, silane compounds, the polyamines, or the substrate (e.g., silica particles). In general and without wishing to be bound by theory, the effective volume for optimum homogeneity is between 35-70% of the inner volume 408 of the tumbler 402. The double cone tumble mixing system 400 is advantageous for use with fragile substrates (e.g., fragile silica particles) as the cone-shapes and smooth inner walls of the tumbler 402 reduce attrition of the substrate during agitation.

In general, the coating liquid components (e.g., including a polymer to provide a polymer coating) and/or functionalization mixture components are poured into the inlet 404 and allowed to form the coating liquid/functionalization mixture. In other words, the polymer, aminosilanes, the polyamines, and/or a volume of solvent (e.g., water) water are sprayed into the inner volume 408 of the mixing system 400, shown in the left-most image of FIG. 4A. Spraying can be conducted within components in multiple steps (e.g., in which the polymer coating liquid is first formed and then functionalization mixture components are provided; or in which the functionalization mixture is first formed and then the polymer for coating is provided). If necessary, the inlet 404 is sealed and the components agitated within the mixing system 400 to form, or hasten the formation of, the polymer coating liquid/functionalization mixture.

The substrate (e.g., porous silica particles) are added to the coating liquid/functionalization mixture through the inlet 404 and the tumbler 402 is sealed and agitated, shown in the central image of FIG. 4A.

The coated material can be separated from the coating by opening the outlet 406 and decanting the coating (the right-most image of FIG. 4A) from the coated particles through filtration or other means.

Similarly, the functionalized material can be separated from the functionalization mixture by opening the outlet 406 and decanting the functionalization mixture (the right-most image of FIG. 4A) from the functionalized material through filtration or other means. In some examples, the tumbler 402 does not include an outlet 406, and the inlet 404 is instead used to decant the functionalization mixture and separate the functionalized material. In one example, the porous substrate is added into the mixing system 400 first. Then a functionalization mixture is sprayed over the substrate as the mixing system 400 spins so that a uniform coating is obtained. Then heat and vacuum are applied to remove the solvent.

In some examples, the mixing system 400 is used to coat, functionalize, and dry the particles. In FIG. 4B, the mixing system 400 applies heat 418 to the inner volume 408 of the tumbler 402 which causes excess solvent used coating liquid/functionalization mixture absorbed by the coated and/or functionalized material to evaporate. The tumbler 402 is rotated to agitate the coated and/or functionalized material, which increases the evaporation rate of the absorbed coating liquid/functionalization mixture during heating.

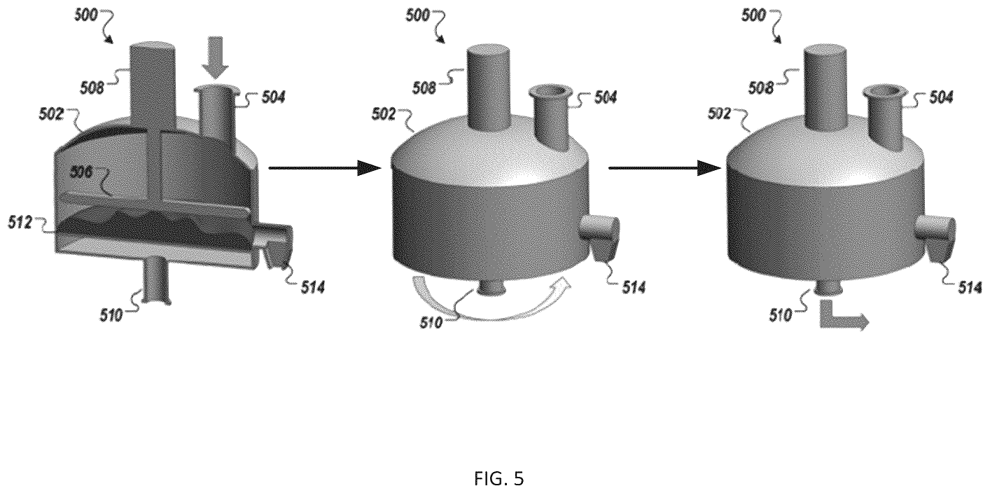

FIG. 5 illustrates three images of an example Nutsche filter mixing system 500 that effectively performs the separation of solid matter from a liquid under pressure or vacuum in a closed system. The left-most image of FIG. 5 shows a cut-away view of the mixing system 500. The mixing system 500 includes a vessel 502 having an inlet 504, filter discharge 510, and outlet 514. Some examples of the vessel 502 are jacketed for temperature control. An agitator 506 is rotatable within the vessel 502 by a drive motor 508 around the drive motor 508 shaft. The inlet 504 receives the coating liquid (e.g., including a polymer to provide a polymer coating), functionalization mixture components including the silane compounds, polyamines, volume of solvent (e.g., water), and/or substrate (e.g., particles).

The drive motor 508 rotates the agitator 506 such that the mixture is stirred and shear forces are applied to the substrate and functionalization mixture. The substrate is mobilized within the coating liquid/functionalization mixture. The vessel 502 includes a filter 512 sized to separate the solid particles and/or the solid particles and the coating liquid/functionalization mixture during agitation, coating, and/or functionalization. When the discharge 510 and outlet 514 are open, the liquids are removed from the vessel 502 and discarded while the filter 512 separates the coated and/or functionalized material. The filter 512 can be wire mesh, a cloth layer, or a perforated metal layer.

Some examples of the mixing system 500 include a heating mechanism integrated into the filter 512 such that, following decanting of the coating liquid/functionalization mixture in the right-most image of FIG. 5, the separated coated and/or functionalized material can be dried within the vessel 502.

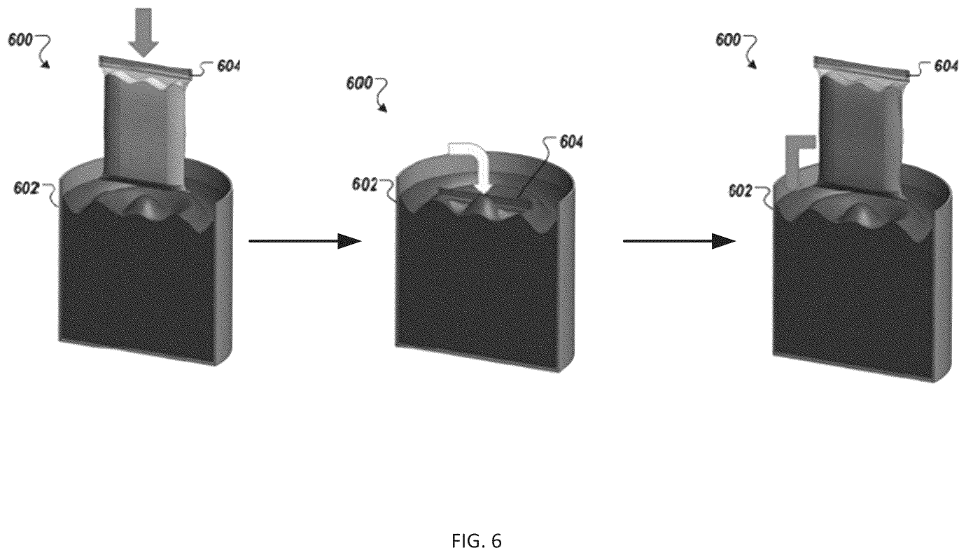

FIG. 6 is three images of a filtration bag dip-coating method used to produce a functionalized material. An open-topped container 602, e.g., a vat, is filled with the liquid components of the coating liquid/functionalization mixture and allowed to produce a homogeneous mixture. In some examples, the liquid components are agitated to produce the homogeneous mixture. In the left-most image, a mesh filtration bag 604 is filled with the substrate (e.g., silica particles) to be coated and/or functionalized. The mesh of the filtration bag 604 is sufficiently small to permit liquid ingress while withholding the substrate (e.g., particulates of the silica particles). In some cases, the mesh is large enough to permit fine dust to be separated from the substrate when the filtration bag 604 is submerged.

In the central image of FIG. 6, the filtration bag 604 is submerged within the liquid components and rested for a duration. The filtration bag 604 can be moved within the container 602 to facilitate uniform contact between the coating liquid/functionalization mixture and the substrate contained within the filtration bag 604. The uniform contact produces homogenous coated and/or functionalized material when the filtration bag 604 is withdrawn and the coated and/or functionalized material is dried.

In the right-most image of FIG. 6, the filtration bag 604 is withdrawn from the container 602 and the excess coating liquid/functionalization mixture decanted, e.g., drained, such that the coated and/or functionalized material is maintained in the filtration bag 604. The coated and/or functionalized material (e.g., functionalized silica particles) can then be removed from the filtration bag 604 and dried to complete the coating and/or functionalization process.

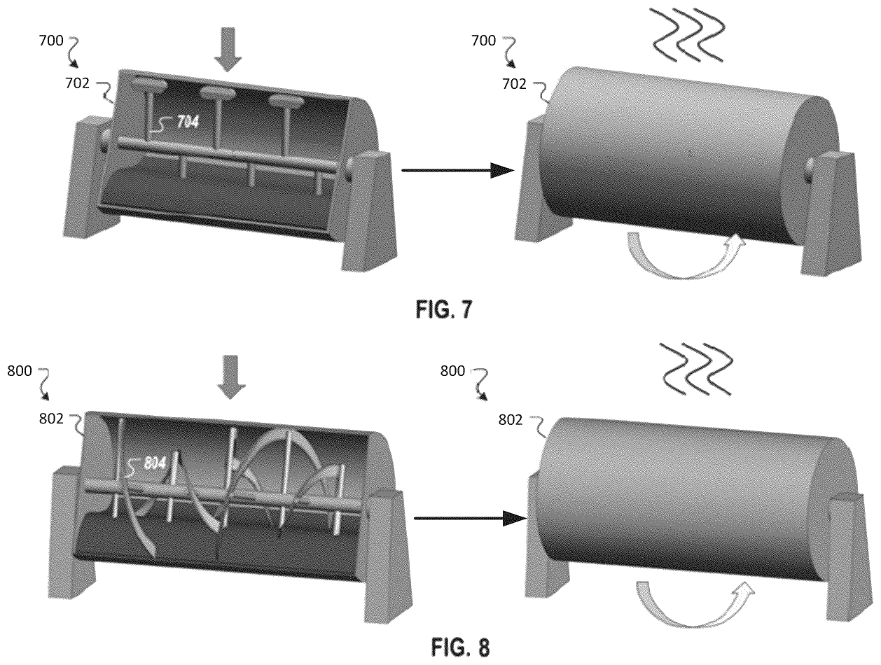

FIGS. 7 and 8 show two different examples of drum mixers which can be used for mixing the coating liquid and/or functionalization mixture, exposing the particles to the coating liquid/functionalization mixture thereby coating and/or functionalizing the particles, and/or drying of the coated and/or functionalized particles. In the left image of FIG. 7, a paddle mixer 700 includes a cylindrical drum 702 in which mixing occurs. A paddle agitator 704 rotates independently of the drum 702 to mix the coating liquid/functionalization mixture with the substrate. The substrate is dispensed into the drum 702, and the paddle agitator 704 rotates to agitate the substrate (e.g., silica particles) in the coating liquid/functionalization mixture.

In the left image of FIG. 8, a ribbon mixer 800 includes cylindrical drum 802 in which mixing occurs by a ribbon agitator 804, which rotates independently of the drum 802. The substrate (e.g., silica particles) is dispensed into the drum 802, and the ribbon agitator 804 rotates to agitate the substrate (e.g., silica particles) in the coating liquid/functionalization mixture.

In some embodiments, examples of the paddle mixer 700 and ribbon mixer 800 include heating mechanisms, such as jacketed drums 702 and 802, or forced gas venting to flow heated gas over the coated and/or functionalized material after separating the solid substrate from the coating liquid and/or functionalization mixture. In some embodiments, the heated gas is air, or an inert gas (e.g., nitrogen, N₂). In some embodiments, if a heat carrier is flown through a jacket of the paddle mixer 700 or ribbon mixer 800, the heat carrier is heated oil, steam, or hot water. In some embodiments, if the heat carrier is flown inside the vessel (e.g., forced gas venting), an inert gas such as N₂ is used. However, in examples of forced gas venting air should be avoided to prevent oxidation. In this way, the paddle mixer 700 and ribbon mixer 800 can be used to coat/functionalize and dry the coated and/or functionalized material. The mixers 700 and 800 apply heat to the inner volume of the mixers, which causes excess solvent from the coating liquid/functionalization mixture absorbed by the functionalized material to evaporate. As the agitators 704 and 804 are rotated to agitate the coated and/or functionalized material, the evaporation rate of the absorbed coating liquid/functionalization mixture increases during heating.

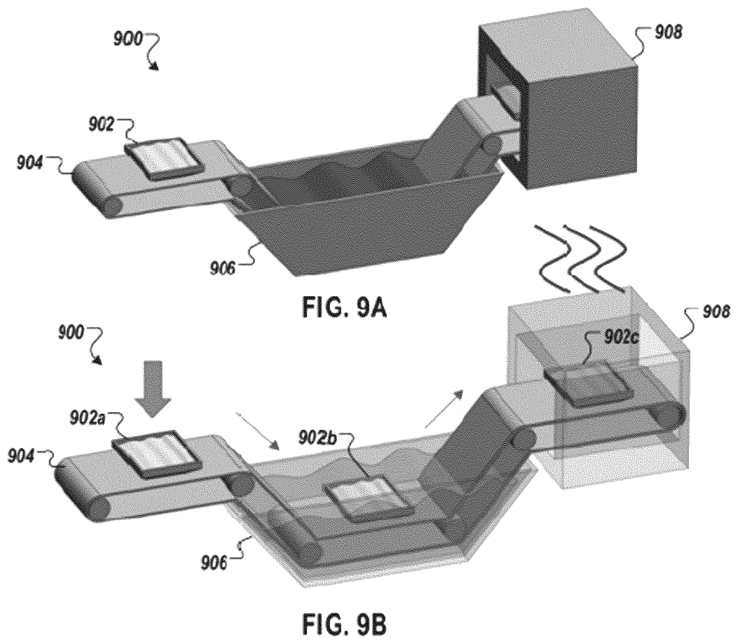

FIGS. 9A-9B illustrate an example dip-coating conveyor system 900 in which silica particles to be functionalized are placed in a container 902 and conveyed through the dip-coating process by a conveyor 904. The container 902 shown is an open-top vessel, though in other examples a mesh bag containing the substrate is functional with the conveyor system 900. The container 902 can be solid or perforated to facilitate rapid and complete absorption of the coating liquid/functionalization mixture by the substrate.

FIG. 9A illustrates the container 902 arranged on the conveyor 904. The conveyor is operated by a controller, which causes the container 902 to enter a dip tank 906. The dip tank 906 contains the coating liquid/functionalization mixture including the polymer for the polymer coating, aminosilanes, and/or polyamines to coat and/or functionalize the substrate (e.g., silica particles). Some examples of the dip tank 906 include agitation elements, such as mixing or stirring blades, or pumps.

The conveyor 904 transports the container 902 into the dip tank 906. The conveyor 904 operates continuously, or intermittently, so the container 902 spends sufficient time within the coating liquid/functionalization mixture to coat and/or functionalize the substrate. The conveyor 904 operates to remove the container 902 from the coating liquid/functionalization mixture.

The conveyor system 900 includes a dryer 908 after the dip tank 906 for removing excess coating liquid/functionalization mixture from the coated and/or functionalized material (e.g., functionalized silica particles). The dryer 908 can raise the temperature of the substrate by blowing heated gas, through passive heating elements, or both.

FIG. 9B illustrates the conveyor system 900 operating in a continuous mode in which multiple containers 902 are transported by the conveyor 904 concurrently. FIG. 9B illustrates containers 902a, 902b, and 902c each at different stages of the dip-coating process. In this manner, the conveyor system 900 are operated efficiently to dip-coat and dry batches of the silica particles sequentially.

### IV. Methods of Using or Testing a Functionalized Material

The functionalized material may be used as a sorbent. Described herein are methods and systems to test such materials.

### i. Methods of Using a Functionalized Material

The present disclosure encompasses methods of using a functionalized material to remove atmospheric CO₂ from air by direct air capture. In addition to air, the functionalized material can be used to remove CO₂ from a fluid.

Methods of use can include providing a functionalized material for capturing (e.g., reversibly capturing) CO₂. In general, the functionalized material is a layer of conventional or uniform beads, granules, pellets, fibers, membranes, or powders over which gaseous mixtures including CO₂ are flowed. Gas exiting the layer of functionalized material has a lower concentration of CO₂ than the entering gas.

Capture of CO₂ can be achieved by using a reactor or a sample holder, e.g., such as any described herein. Accordingly, methods of use can include: providing air to a reactor (e.g., any described herein) or a sample holder (e.g., any described herein) comprising a sorbent, where the sorbent can include a functionalized material (e.g., any described herein); and exposing the sorbent to conditions to adsorb CO₂ from the air to form CO₂-reduced air. In some embodiments, the sorbent is provided as a fluidized bed.

Methods of use can further include: releasing adsorbed CO₂ under certain conditions to desorb CO₂ from the sorbent to form CO₂-enriched air. Non-limiting conditions can include, e.g., a temperature swing adsorption process, a pressure swing adsorption, a vacuum swing adsorption process, or a combination of any of these.

In some embodiments, the method includes: providing ambient air comprising CO₂ to a reactor (e.g., any described herein) comprising one or more air chambers; blowing the ambient air so that it travels from the one or more air chambers into a reaction chamber; delivering a powdered sorbent material to the reaction chamber through an inlet; creating a fluidized bed of the powdered sorbent material and the air under conditions in which the powdered sorbent material adsorbs the CO₂ from the air to form CO₂-reduced air and used powdered sorbent material; continuously removing used powdered sorbent material from the reaction chamber; and continuously removing CO₂-reduced air from the reaction chamber through one or more exhaust ports.

### ii. Sample Holder

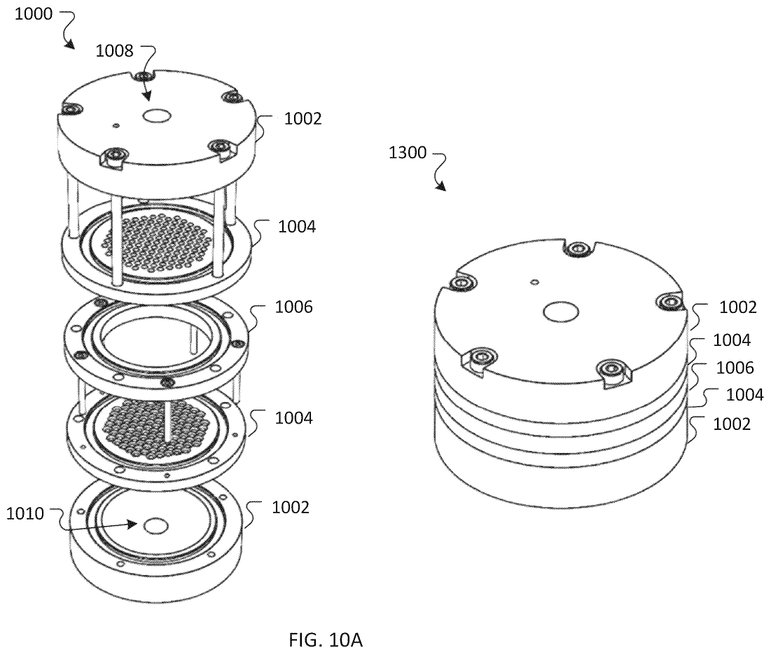

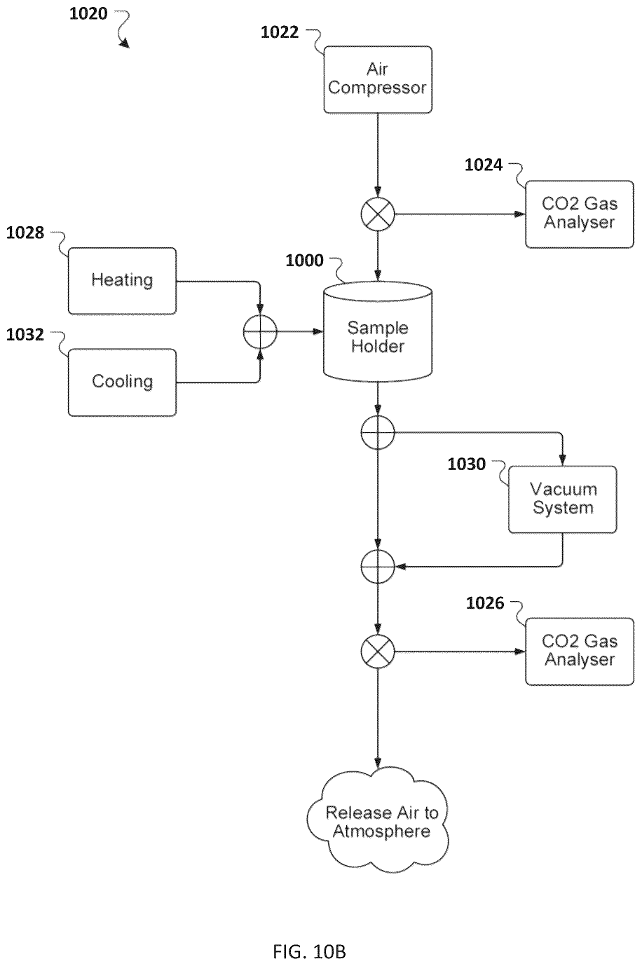

The functionalized material can be provided in a sample holder for testing and/or during use as a sorbent. FIG. 10A schematically illustrates an exploded view (left) and an assembled view (right) of a non-limiting sample holder 1000 for the sorbent. Functionalized material can be placed in a sample space 1006 arranged between two layers of filter 1004 (e.g., such as glass wool) in a sample holder 1000. The sealing ends 1002 of the sample holder 1000 can include an inlet 1008 and an outlet 1010 permissive to gas flow. The sealing ends 1002 can include reversible screw connections to assemble the sample holder 1000. When assembled (right), the sample holder 1000 was otherwise sealed against gaseous inflow.

In FIG. 10B, a schematic diagram of the experimental setup 1020 is shown. Referring now to FIGS. 10A and 10B, a gas source, e.g., air compressor 1022, provided compressed environmental air to the inlet 1008 of the testing sample holder 1000. The air passes through the filters 1004, thereby exposing the functionalized material to the environmental air. Air can be exhausted from the outlet 1010. The concentration of CO₂ in the compressed environmental air can be measured by a gas analyzer, e.g., CO₂ gas analyzers 1024 and 1026, prior to entering the inlet 1008 and subsequent to exiting the outlet 1010.

The samples of functionalized material were treated with an activation process before data collection. Samples were heated in a vacuum drier (e.g., vacuum heater 1028) to 70° C. for 30 minutes under vacuum (e.g., at 0.3 psi) to activate the sorbent, e.g., as the activation process. Alternatively, and as shown in FIG. 10B, the heating element 1028 and the vacuum system 1030 are separate elements of the setup 1020 and work in concert to heat and apply vacuum to the sample holder 1000. In some implementations, a cooling element 1032 is included in the setup 1020 to further control the temperature of the environment in the sample holder 1000. Both the heating element 1028 and the cooling element 1032 are integrated into the sample holder 1000 in the experimental setup 1020 to apply temperature control directly to the sorbent sample. The activation process can facilitate removal, e.g., evaporation, of residual solvent medium in the pores of the functionalized silica and desorbs CO₂ molecules bonded during the synthesis process (e.g., processes 300A-C) for venting to the atmosphere.

For a non-limiting adsorption procedure, samples of functionalized silica in a range between 0.5 g and 10 g were placed in between two layers of glass fiber filters 1004 in the testing sample holder 1000. Compressed environmental air (e.g., input air) from a gas source 1022 can be continuously fed through the testing sample holder 1000 at a rate in a range from 1 to 10 standard liters per minute (slpm), thereby exposing the activated functionalized material. The activated functionalized material was exposed for time periods in a range from 30 to 60 minutes. The humidity of the input air can be controlled to be in a range between 15% to 50% relative humidity (RH) at 21° C. As the activated functionalized material adsorbs CO₂, the concentration of CO₂ is measured both before the sample holder with CO₂ gas analyzer 1024 and after the sample holder with CO₂ gas analyzer 1026. The same sample holder can then be brought to vacuum by a vacuum system 1030 and heated by a heating element 1028 to extract the carbon dioxide from the sample. The amount of carbon dioxide extracted was also measured by gas analyzer 1026.

The humidity can be controlled through blending of “dry air” and “wet air” with a flow meter (not shown). As an example, to produce input air having 50% relative humidity (RH) at a flow rate of 5 slpm, dry air (e.g., <10% RH) at 2.5 slpm and wet air (e.g., >95% RH or 100% RH) can be blended at 2.5 slpm each. The dry air and wet air flow control can be accomplished using a closed loop controller.

The compressed environmental air including CO₂ concentration can be monitored by gas analyzers 1024 and 1026 at the input and output of the testing sample holder 1000 during the experimental time period in units of mol CO₂/kg of sorbent.

### V. Example Direct Air Capture Systems

Disclosed herein are systems for employing a functionalized material. In some embodiments, the functionalized material is used as a sorbent in a fluidized bed reactor for use in direct air capture (DAC).

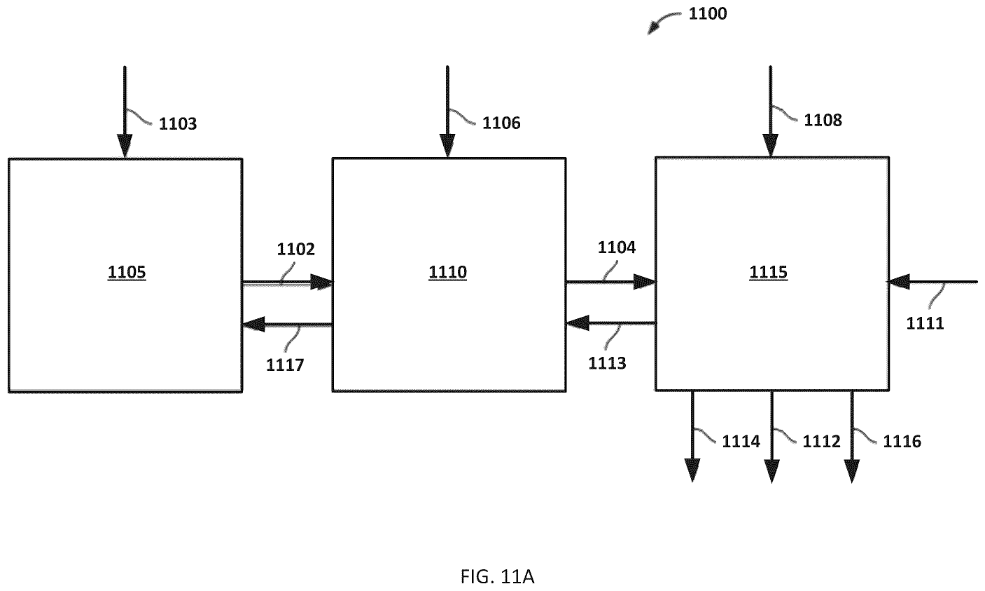

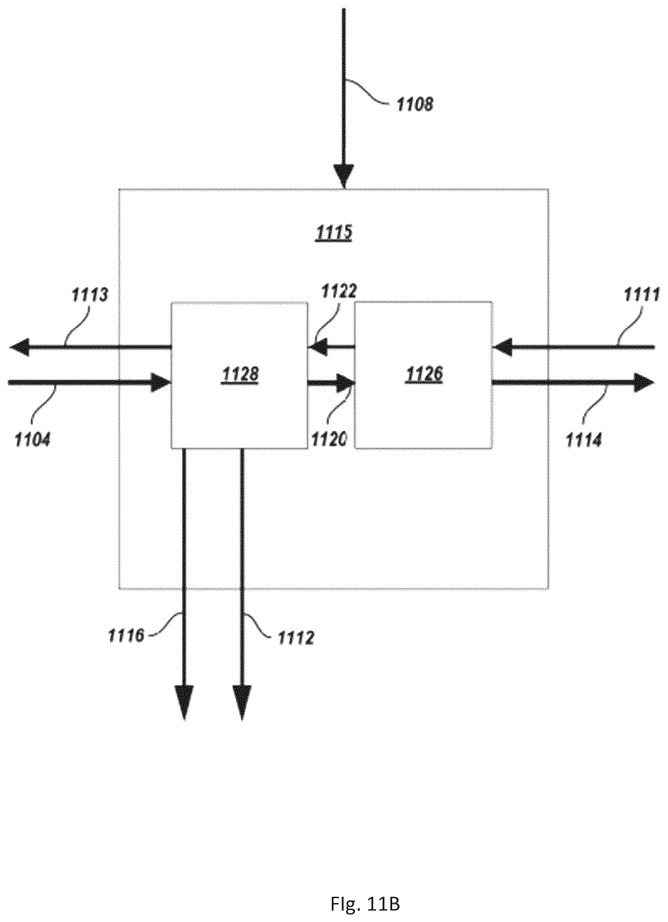

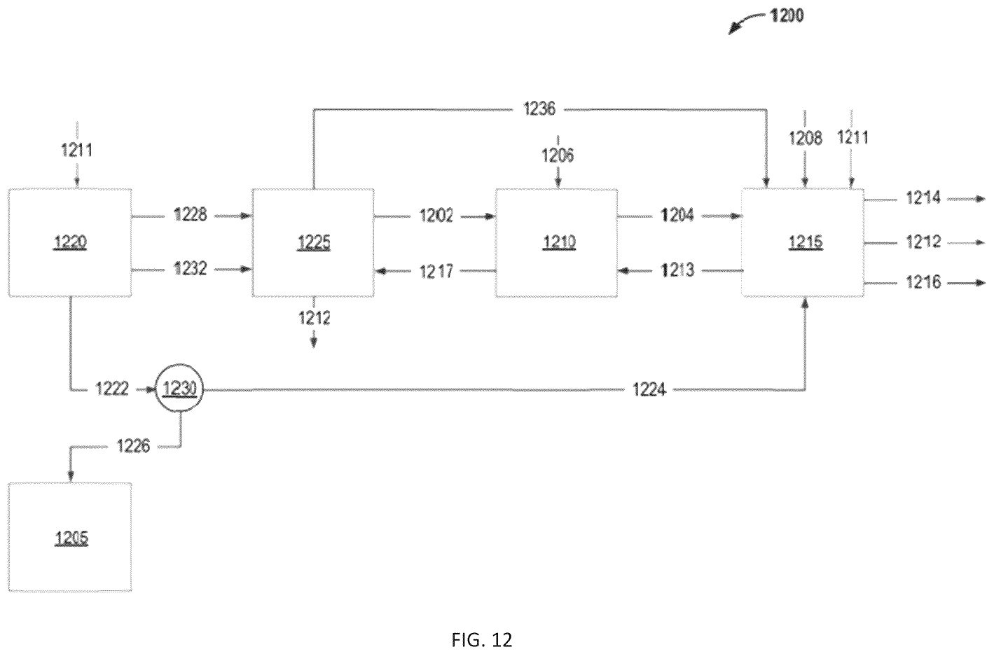

Examples of DAC systems of CO₂ using the sorbent of the present disclosure are described with reference to FIGS. 11A-11B and FIG. 12, examples of which are described in U.S. Pat. Pub. No. 2021/0300765 or Int. Pub. No. WO 2021/202499, the disclosure of which are hereby incorporated by reference in their entirety.

FIG. 11A is a schematic illustration of an example implementation of a carbon dioxide extraction system 1100 that uses waste heat to provide energy for a carbon dioxide direct air capture (DAC) system 1115. As illustrated, the carbon dioxide extraction system 1100 includes an industrial process 1105 that generates waste heat 1102. In some implementations, the industrial process utilizes a power input 1103. The waste heat 1102 is supplied, in this example, to a thermal heat-reuse system 1110 that also utilizes a power input 1106.

The thermal heat-reuse system 1110 provides a heated fluid 1104 to a carbon dioxide DAC system 1115. The carbon dioxide DAC system 1115 also receives a power input 1108 and an ambient airflow input 1111. The carbon dioxide DAC system 1115 outputs a carbon dioxide supply stream 1112, a carbon dioxide-reduced airflow output stream 1114, and demineralized water 1116. As will be discussed in greater detail herein, DAC system 1115 includes an adsorber system (e.g., that may optionally comprise a fluidized bed reactor or a silo adsorber) and a desorber system (e.g., that may optionally comprise a gravity fed desorption system).

Generally, the carbon dioxide extraction system 1100 operates to utilize the heated fluid 1104 as thermal energy that is generated from the waste heat 1102 by the thermal heat-reuse system 1110. The thermal energy in the heated fluid 1104 is used by the carbon dioxide DAC system to separate carbon dioxide captured from the ambient airflow input 1111 and supply the separated carbon dioxide as the carbon dioxide supply stream 1112. The heated fluid 1104 is then returned via heated fluid return 1113 to the thermal heat-reuse system 1110, and the waste heat 1102 is returned to the industrial process 1105 via waste heat return 1117. In some aspects, the carbon dioxide supply stream 1112 can be provided as an injectant into a subterranean formation during hydrocarbon production operations. In some aspects, the injected carbon dioxide may be sequestered in the subterranean formation (with or without assisting in the hydrocarbon production operations).

The industrial process 1105 may be any process that generates, as an output, thermal energy in the form of waste heat, e.g., energy, that, unless captured, that otherwise would be lost to, e.g., the ambient environment. As an example, the industrial process 1105 may be a computer data center that, generally, houses computer systems and associated components, such as telecommunications and storage systems. In some aspects, a data center includes tens, hundreds, thousands, or even more server devices that generate heat, such as hardware processors, voltage regulators, memory modules, switches, and other devices that operate to provide a particular amount of information technology (IT) power.

Such devices, typically, utilize electrical power to operate and output heat during operation. In order for such devices to operate correctly, the output heat must be captured in a cooling fluid flow (e.g., air, water, refrigerant) and expelled from the data center. For instance, air handling systems (e.g., fans, cooling coils) may operate to capture the output heat in an airflow circulated over the heat-generating components. The output heat now within the airflow is transferred to a cooling liquid, e.g., within a cooling coil. The heat transferred to the cooling liquid is then typically rejected to the ambient environment as waste heat, such as through evaporative cooling systems, chiller/cooling tower systems, or otherwise. In this example, this waste heat takes the form of waste heat 1102.

The example thermal heat-reuse system 1110 utilizes the waste heat 1102 and power input 1108 to provide the heated fluid 1104. The thermal heat reuse system 1110 comprises a bank of heat pumps and a bank of heat exchangers to provide the heated fluid 1104. By balancing the use of passive and active heating, power can be saved to provide the carbon dioxide DAC system with the required temperatures of heated fluid 1104. Generally, the thermal heat-reuse system 1110 includes one or more vapor-compression cycles (“heat pumps”) to add thermal energy in the form of heat of compression to the waste heat 1102 and transfer the sum of such energy to a fluid to generate the heated fluid 1104 (e.g., a heated liquid). Generally, each heat pump and heat exchanger within the thermal heat-reuse system 1110 operates to transfer thermal energy from a heat sink to a heat source, i.e., in an opposite direction of spontaneous heat transfer. The one or more heat pumps of the thermal heat-reuse system 1110 use the power input 1106 to accomplish the work of transferring energy from the heat source to the heat sink. Each heat pump in the thermal heat-reuse system 1110 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components is fluidly coupled within a closed-loop refrigerant circuit in the heat pump.

As is generally known, in a vapor-compression heat pump cycle, a refrigerant exits a first heat exchanger in which heat from the refrigerant is released to a first medium. The refrigerant then enters a compressor in which it is compressed, and a heat of compression is added thereto. The refrigerant then enters a second heat exchanger in which heat from a second medium is added. The refrigerant then enters an expansion device and undergoes an isenthalpic pressure drop. The refrigerant completes the cycle by entering the evaporator to release the heat of compression and the heat from the second medium to the first medium.

Although the present disclosure describes a vapor-compression heat pump cycle as a heat transfer system between a source of waste heat and a carbon dioxide DAC system, other thermodynamic cycles may also be used in place of (or along with) the described vapor-compression heat pump cycle. For example, one or more vapor-adsorption cycles may be used in place of (or along with) the described vapor-compression heat pump cycle. A vapor-adsorption cycle, for example, consists of a cycle of desorption-condensation-expansion-evaporation, followed by adsorption.

The carbon dioxide DAC system 1115, generally, operates to pass the ambient airflow input 1111 (which includes low concentrations of gaseous carbon dioxide) over or through one or more media (e.g., “filters”). In some aspects, one or more fans (not shown) utilize the power input 1108 to circulate the ambient airflow input 1111. The media or filter, in some aspects, includes a solid sorbent to which the atmospheric carbon dioxide in the airflow input 1111 bonds. The sorbent that is saturated with carbon dioxide may be referred to as “rich sorbent.”

In the case of a solid sorbent, such as the sorbent described in the present disclosure, as the airflow input 1111 passes over the solid media or filter, atmospheric carbon dioxide within the airflow input 1111 bonds to the media or filter. When the media or filter is saturated with carbon dioxide, it can be heated (e.g., to 600-620° C. or to 60-100° C.) to release the carbon dioxide for collection (as described herein).

Using thermal energy from the heated fluid 1104, heat is applied to the solid or liquid sorbent, which breaks the bonds between the carbon dioxide and the sorbent. The separated carbon dioxide is provided as the carbon dioxide supply stream 1112 from the carbon dioxide DAC system 1115. The now-“lean adsorbent” that is carbon dioxide free (i.e., the solid or liquid) is recycled back to capture more carbon dioxide from the ambient airflow input 1111. The airflow output 1114, typically, contains little to no carbon dioxide.

FIG. 11B shows an example carbon dioxide DAC system 1115. The carbon dioxide DAC system 1115 includes an adsorber system 1126 and a desorber system 1128.

The adsorber system 1126 generally operates to pass the ambient airflow input 1111 (which includes gaseous carbon dioxide) over or through one or more sorbents (e.g., in media or filters) under conditions at which the sorbent adsorbs CO₂ from the air. In some embodiments, the sorbent is provided within a fluidized bed reactor, where air flows through an air inlet into a reaction chamber and will diffuse through a distribution plate to make contact with the sorbent. In some embodiments, the adsorber system can include any useful adsorber. In other embodiments, air can flow through one or more filter panels of a silo adsorber.

The desorber system 1128 generally operates to remove adsorbed carbon dioxide from sorbent material. The desorber system can include, for example, any useful desorption system.

In some aspects, one or more fans (not shown) utilize the power input 1108 to circulate the ambient airflow input 1111. For example, a blower can use the power input 1108 to circulate airflow input to a chamber of a silo adsorber.

The media, filter, or sorbent, in some aspects, includes a solid sorbent to which the atmospheric carbon dioxide in the airflow input 1111 bonds. For example, the solid sorbent can be in a pelletized or powdered form. Alternatively, a liquid sorbent may be also passed over the media or filter to which the atmospheric carbon dioxide in the airflow input 1111 bonds. The sorbent that is saturated with carbon dioxide may be referred to as “rich sorbent.” Rich sorbent 1122 exits the adsorber system 1126 and enters the desorber system 1128. Carbon dioxide-reduced air exits the adsorber system 1126 through the airflow output 1114.

As the airflow input 1111 passes over the sorbent (e.g., as a solid media and/or with a filter), atmospheric carbon dioxide within the airflow input 1111 bonds to the sorbent. The airflow output 1114 exits the system as carbon dioxide-reduced air and is released into the atmosphere. The airflow output 1114, typically, contains little to no carbon dioxide. When the sorbent is saturated with carbon dioxide, it can be heated (e.g., to 70-120° C.) to release the carbon dioxide for collection.

In some aspects, a powdered sorbent material can be used. For example, silica-based sorbent powders are possible, e.g., porous silica functionalized with an amine compound. In some cases, metal oxide framework (MOF) powders can also be used. The degree of coarseness (granularity) of the powder can vary depending on the application. In some cases, particles with an average grain size in a range from 50 to 1,700 μm or from 50 to 3,000 μm can be used. In some examples, the sorbent powder is pelletized.

In some aspects, for example, if liquid sorbent is used, such liquid has a high affinity for carbon dioxide and is circulated over a non-reactive metal (or other material) filter. Once saturated with carbon dioxide, the liquid can be heated (e.g., to 800° C.) to release the carbon dioxide (as described herein). The liquid can then be reused to capture more carbon dioxide in a continual cycle.

The desorber system 1128 uses thermal energy from the heated fluid 1104 to apply heat to the solid or liquid rich sorbent 1122. The heat dissolves the bonds between the carbon dioxide and the rich sorbent 1122. The heated fluid return 1113 exits the desorber system 1128 in order to collect more heat from a process outside of the carbon dioxide DAC system. The separated carbon dioxide is provided as the carbon dioxide supply stream 1112 from the carbon dioxide DAC system 1115. The heat also dissolves bonds between water molecules and the rich sorbent 1122, which exits the system as demineralized water output 1116. The sorbent exiting the desorber system 1128 may be referred to as “lean sorbent,” e.g., sorbent that is carbon dioxide free and, optionally, moisture free. Lean sorbent 1120 (e.g., as a solid or liquid) exits the desorber system 1128 and is recycled back to the adsorber system 1126. The lean sorbent 1120, in the filters of the adsorber system 1126, captures more atmospheric carbon dioxide from the ambient airflow input 1111. The demineralized water output 1116, typically, contains little to no carbon dioxide.

FIG. 12 is a schematic illustration of an example implementation of an integrated power and carbon dioxide DAC system (“integrated system”) 1200. As illustrated, the integrated system 1200 includes a natural gas plant 1220 attached to a CCS flue gas carbon dioxide scrubber 1225 that generates waste heat 1202. The waste heat 1202 is supplied, in this example, to a thermal heat-reuse system 1210 that also utilizes a power input 1206. The thermal heat-reuse system 1210 provides a heated fluid 1204 to a carbon dioxide direct air capture (DAC) system 1215.

A natural gas plant 1220 generates flue gas containing carbon dioxide and electrical power 1228 that is sent to the CCS flue gas carbon dioxide scrubber system 1225. The scrubber system 1225 separates out the carbon dioxide from the flue gas. The scrubber system 1225 provides waste heat 1202 to a carbon dioxide direct air capture (DAC) system 1215. The carbon dioxide DAC system 1215 also receives a power input 1208 and an ambient airflow input 1211. The carbon dioxide DAC system 1215 outputs a carbon dioxide supply stream 1212 and a carbon dioxide-reduced airflow output stream 1214.

Generally, the integrated system 1200 operates to capture the waste heat 1202, generate the heated fluid 1204 that has a thermal energy that includes the waste heat 1202, as well as heat of compression from the thermal heat-reuse system 1210, and utilize such thermal energy in the heated fluid 1204 to separate carbon dioxide captured from the ambient airflow input 1211 to supply the separated carbon dioxide as the carbon dioxide supply stream 1212. In some aspects, the carbon dioxide supply stream 1212 can be provided as an injectant into a subterranean formation during hydrocarbon production operations. In some aspects, the injected carbon dioxide may be sequestered in the subterranean formation (with or without assisting in the hydrocarbon production operations).

In this implementation, the industrial process 1205 is powered by the natural gas plant 1220 rather than the electrical power grid since the electrical power 1226 would be considered carbon negative electricity.

The example thermal heat-reuse system 1210 utilizes the waste heat 1202 from the CCS Flue Gas CO₂ Scrubber 1225 and power input 1206 to provide the heated fluid 1204. Generally, the thermal heat-reuse system 1210 includes one or more vapor-compression cycles (“heat pumps”) to add thermal energy in the form of heat of compression to the waste heat 1202 and transfer the sum of such energy to a fluid to generate the heated fluid 1204 (e.g., a heated liquid). Generally, each heat pump within the thermal heat-reuse system 1210 operates to transfer thermal energy from a heat sink to a heat source, i.e., in an opposite direction of spontaneous heat transfer. The one or more heat pumps of the thermal heat-reuse system 1210 use the power input 1206 to accomplish the work of transferring energy from the heat source to the heat sink. Each heat pump in the thermal heat-reuse system 1210 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components is fluidly coupled within a closed-loop refrigerant circuit in the heat pump.

The carbon dioxide DAC system 1215, generally, operates to pass the ambient airflow input 1211 (which includes gaseous carbon dioxide) over or through one or more media (e.g., “filters”). In some aspects, one or more fans (not shown) utilize the power input 1208 to circulate the ambient airflow input 1211. The media or filter, in some aspects, includes a solid sorbent to which the atmospheric carbon dioxide in the airflow input 1211 bonds. The sorbent that is saturated with carbon dioxide may be referred to as “rich sorbent.”

In the case of a solid sorbent, such as the sorbent described in the present disclosure, as the airflow input 1211 passes over the solid media or filter, atmospheric carbon dioxide within the input 1211 bonds to the media or filter. When the media or filter is saturated with carbon dioxide, it can be heated (e.g., to 100-120° C., to 60-100° C.) to release the carbon dioxide for collection (as described herein).

Using thermal energy from the heated fluid 1204, heat is applied to the solid sorbent, which breaks the bonds between the carbon dioxide and the sorbent. The separated carbon dioxide is provided as the carbon dioxide output stream 1212 from the carbon dioxide DAC system 1215. The now-“lean adsorbent” that is carbon dioxide free (i.e., the solid or liquid) is recycled back to capture more carbon dioxide from the ambient airflow input 1211. The airflow output 1214, typically, contains little to no carbon dioxide. The carbon dioxide DAC system 1215 outputs carbon dioxide 1212 and demineralized water 1216.

As further shown in the example embodiment of FIG. 12, the integrated system 1200 includes a power plant 1220 (e.g., a natural gas power plant 1220) and a scrubbing system 1225 (e.g., a CCS Flue Gas CO₂ scrubbing system 1225). As shown in this example, the power plant 1220 may provide waste heat 1202 (e.g., as generated through the generation of electrical power by the power plant 1220) to the DAC system 1215. In this example, the power plant 1220 also generates electrical power 1222 and 1228. In some aspects, as shown, the electrical power 1222 goes through one or more switches 1230 (shown here as one, but more are possible) to provide electrical power 1224 to the DAC system 1215 and backup electrical power 1226 to the industrial process 1205.

As shown in this example, the power output of the power plant 1220 may be sized to provide a sum of the electrical power 1224 to the DAC system 1215 and the electrical power 1228 to the scrubbing system 1225 for normal operation, as well as the backup electrical power 1226 to the industrial process 1205 when needed (i.e., when the industrial process 1205 loses or cannot use grid electrical power 1217). Thus, in some aspects, when the industrial process 1205 needs the backup electrical power 1226, electrical power 1228 and electrical power 1224 are still provided to their respective users. Alternatively, in some aspects, the power output of the power plant 1220 may be sized to provide a sum of the electrical power 1224 to the DAC system 1215 and the electrical power 1228 to the scrubbing system 1225 for normal operation, as well as the backup electrical power 1226 to the industrial process 1205 when needed (i.e., when the industrial process 1205 loses or cannot use grid electrical power 1217), as well as one or both of power inputs 1206 or 1208.

Alternatively, in some aspects, the power output of the power plant 1220 may be sized only to provide the backup electrical power 1226 to the industrial process 1205 when needed (i.e., when the industrial process 1205 loses or cannot use grid electrical power 1217). Thus, during operational periods when the industrial process 1205 does not need backup electrical power 1226, the electrical power 1228 and/or the electrical power 1224 (as well as other power inputs) may be provided by the power plant 1220. During operational periods when the industrial process 1205 does need backup electrical power 1226, the electrical power 1228 and/or the electrical power 1224 (as well as other power inputs) may not be provided by the power plant 1220. For example, electrical power 1222 may be routed, in such operational periods, through the switch 1230 as backup electrical power 1226.

In some aspects, the electrical power 1226 supplied from the power plant 1220 to the industrial process 1205 may not be “backup” power but instead may be a primary power source for the industrial process 1205. For example, in some aspects, the power plant 1220 may be sized to provide primary electrical power 1226 to the industrial process 1205, as well as, in some aspects, one or more other components shown in the integrated system 1200.

As further shown in FIG. 12, in some aspects, waste heat 1202 that is generated from the scrubber system 1225 may be used by the thermal heat-reuse plant 1210 to provide heated fluid to the DAC system 1215. In some implementations, the heated fluid 1204 is then returned via heated fluid return 1213 to the thermal heat-reuse system 1210 and the waste heat 1202 is returned to the industrial process 1205 via waste heat return 1217.

As shown in this example implementation, the scrubbing system 1225 also receives an exhaust fluid 1232 (e.g., the flue gas with 100% CO₂) from the power plant 1220. For example, in some aspects, the power plant 1220 may be a natural gas power plant in which natural gas is combusted to drive electrical power generation equipment that operates to generate the electrical power shown in FIG. 12. In other aspects, the power plant 1220 may use other carbon-based fuel rather than natural gas. In still other aspects, the power plant 1220 may use non-carbon based fuels to generate electrical power (e.g., geothermal, solar, and other). For a natural gas power plant 1220, although not shown specifically here, such equipment may include, for example, a compressor rotatably coupled to a gas turbine that drives the compressor. The gas turbine receives combustion products fluid from a combustion chamber that receives compressed natural gas from the compressor. The combustion products fluid drives the gas turbine, which in turn is coupled to and drives a generator to produce electrical power.

Output from such a gas turbine (at a lower pressure than the combustion products fluid) is exhaust fluid 1232 (e.g., as a flue gas). A difference in pressure between the combustion products fluid and the exhaust fluid 1232 drives the gas turbine to produce electrical power from the generator. As shown in this example, the exhaust fluid 1232 is separated by the scrubbing system 1225 into multiple output streams. For example, the flue gas with 100% CO₂ 1232 is separated into a carbon dioxide output and a flue gas stream 1236 with 5% CO₂. The flue gas stream 1236 with 5% CO₂ is sent to the DAC system 1215 to remove the remaining carbon dioxide from the output airflow of the natural gas plant 1220. This makes the resulting power generated from the natural gas plant carbon negative power. For example, similar to the DAC system 1215, outputs of a carbon dioxide supply stream 1212 and a carbon dioxide-reduced airflow output stream 1214 may be output from the scrubbing system 1225.

In some aspects, the carbon dioxide supply streams 1212 may be sold (e.g., for CO₂-EOR, sequestration, and/or other processes). For example, the carbon dioxide supply streams 1212 may generate revenue through emissions credits and federal tax credits. In some aspects, such revenue may offset capital and/or operations costs of the DAC system 1215, the power plant 1220, both, or other components of the system 1200.

The integrated system 1200 may advantageously utilize the power plant 1220, which may normally be sitting idle, to produce a saleable product in the carbon dioxide fluid streams 1212, which also provide environmental benefits. Additionally, in the event of a power outage at the industrial process 1205, the power plant 1220 would already be running, meaning the delay between the outage and providing the process 1205 with power would be reduced. Further, by using the thermal energy 1202 from the waste heat 1202 from the scrubber 1225, operating costs of the DAC system 1215 may be significantly reduced, allowing for the carbon dioxide captured to finance the construction of the DAC system 1215 as well as help subsidize the cost of the industrial process's backup power. In addition, the integrated system 1200 may produce water from ambient humidity as the DAC system 1215 pulls carbon dioxide from the air. The water can be sold or used, e.g., at the industrial process 1205.

In some embodiments, a DAC system comprises: a fluidized bed adsorption reactor configured to adsorb CO₂ from ambient air using a sorbent material (e.g., any described herein); a desorption reactor configured to receive the sorbent material from the fluidized bed adsorption reactor and to desorb CO₂ from the sorbent material; and an industrial process facility which produces waste heat that is provided to the desorption reactor to heat the sorbent material.

In some embodiments, a DAC system comprises: a fluidized bed reactor or a silo adsorber configured to adsorb CO₂ from ambient air using a sorbent material (e.g., any described herein). In some embodiments, the system further comprises a desorption system (e.g., a reactor, a desorber, a gravity fed desorption system, and the like) configured to receive the sorbent material from the fluidized bed reactor or the silo adsorber and to desorb CO₂ from the sorbent material.

In some embodiments, a DAC system comprises: a gravity fed desorption system configured to desorb CO₂— from a sorbent material (e.g., any described herein). In some embodiments, the system further comprises an adsorption system (e.g., a reactor, an adsorber, a silo adsorber, and the like) configured to adsorb CO₂ from ambient air using the sorbent material and configured to provide the sorbent material to the gravity fed desorption system.

### EXAMPLES

### Example 1—Silane and Polymeric Amine Functionalized Porous Substrate for Carbon Capture

Examples 1.1 to 1.3 generally relate to a functionalized porous silica and more specifically, to a functionalized porous silica for reversibly capturing carbon dioxide.

### Example 1.1—N1-(3-Trimethoxysilylpropyl)diethylenetriamine and PEI Grafting

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hours. N1-(3-trimethoxysilylpropyl)diethylenetriamine, having the chemical formula:

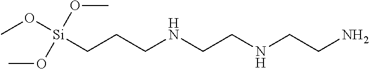 [SMILES: CO[Si](CCCNCCNCCN)(OC)OC]

was added into the above solution at a molar ratio in a range from 2.3 g to 4.7 g (e.g., 8 mmol to 16 mmol, e.g., a silica particle to amine material molar ratio in a range from 5:1 to 10:1). The mixture was heated and stirred at 60° C. or above (e.g., up to 90° C.). The temperature depends on the chosen solvent. The mixture was stirred for 18 hours (in some cases, the mixing continued for 24 hours). The mixture was cooled to room temperature. The functionalized silica particles were filtered from the solvent and washed twice while stirring with a 40 mL volume of solvent each time. The functionalized silica particles were dried in a vacuum oven at 50° C. for 12 hours. Alternatively, [3-(2-aminoethylamino)propyl]trimethoxysilane, having the chemical formula:

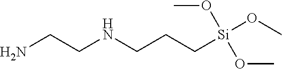

was added to the solution at 2.2 g to 4.5 g (e.g., 8 mmol to 16 mmol, e.g., a silica particle to amine material molar ratio in a range from 5:1 to 10:1).

In a second round bottom flask, 30 mL of methanol or solvent mixture (e.g., cyclohexane:ethanol=2:1), 5 g of silane-treated silica from the above step, and 1.5 g polyethylenimine (PEI) or other second amine (30 wt % to silica) was added. The mixture was stirred for 1 hour. The solvent was dried from the functionalized silica through evaporation, such as on a rotovap, to recover the functionalized silica. The functionalized silica particles were dried in a vacuum oven at 50° C. for 12 hours. The second step can be performed as a large scale process such as using vacuum drying together with an amine/solvent mixture spraying process.

### Example 1.2—Bis[3-(trimethoxysilyl)propyl]amine grafting

Using a silane compound having two or more silane moieties (e.g., two trimethoxysilane or triethoxysilane functional groups) in the same molecule, such as for example bis[3-(trimethoxysilyl)propyl]amine, can facilitate a plurality of interactions between silane groups and silica, potentially improving binding stability of the silane bond to the silica surface.

To add bis[3-(trimethoxysilyl)propyl]amine), having the chemical formula:

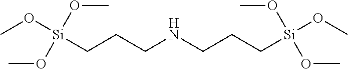

to the reaction, the same procedure as for [3-(2-aminoethylamino)propyl]trimethoxysilane grafting was followed.

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hours. [3-(2-aminoethylamino)propyl]trimethoxysilane, having the chemical formula:

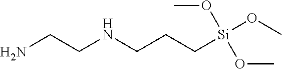

was added into the above solution at 2.2 g to 4.5 g (e.g., 8 mmol to 16 mmol, e.g., a silica particle to amine material molar ratio in a range from 5:1 to 10:1). Bis[3-(trimethoxysilyl)propyl]amine) was added into the above solution at 0.68 g (e.g., 2 mmol, a silica particle to bisamine material ratio of 40:1). The mixture was heated and stirred at 60° C. or above (e.g., up to 90° C.). The temperature depends on the chosen solvent. The mixture was stirred for 18 hours. The mixture was cooled to room temperature. The functionalized silica particles were filtered from the solvent and washed twice while stirring with a 40 mL volume of solvent each time. The functionalized silica particles were dried in a vacuum oven at 50° C. for 12 hours.

### Example 1.3—Experimental Results

Functionalized silica produced using the processes described herein (e.g., in FIG. 3) was characterized by a CO₂ uptake measurement (e.g., using a sample holder as illustrated in FIGS. 10A-10B). FIG. 14 is a line chart depicting CO₂ uptake in mol CO₂/kg (left y-axis) and against cycle number, e.g., the number of absorption and desorption cycles, (x-axis). The total CO₂ uptake of the functionalized silica sample during a single desorption is indicated.

### Example 2—CO₂ Uptake Measurements for Functionalized Material

Functionalized silica produced using the processes described herein (e.g., process 300 illustrated in FIG. 3) were characterized by a CO₂ uptake measurement. FIG. 10A schematically illustrates an exploded view (left) and an assembled view (right) of the sample holder 1000 for a sorbent. Functionalized silica particles or granules were placed in a sample space 1006 arranged between two layers of filter 1004 (e.g., such as glass wool) in a sample holder 1000. The sealing ends 1002 of the sample holder 1000 included an inlet 1008 and an outlet 1010 permissive to gas flow. The sealing ends 1002 included reversible screw connections to assemble the sample holder 1000. When assembled (right), the sample holder 1000 was otherwise sealed against gaseous inflow.

In FIG. 10B, a schematic diagram of the experimental setup 1020 is shown. Referring now to FIGS. 10A and 10B, a gas source, e.g., air compressor 1022, provided compressed environmental air to the inlet 1008 of a testing sample holder 1000, which was then passed through the filters 1004 and exposed the functionalized silica to environmental air. Optionally, air was exhausted from the outlet 1010. The concentration of CO₂ in the compressed environmental air was measured by a gas analyzer, e.g., CO₂ gas analyzers 1024 and 1026, prior to entering the inlet 1008 and/or subsequent to exiting the outlet 1010.

The samples of functionalized silica were treated with an activation process before data collection. Samples were heated in a vacuum drier (e.g., vacuum heater 1028) to 70° C. for 30 minutes under vacuum (e.g., 0.3 psi) to activate the adsorbent, e.g., as the activation process. Alternatively, and as shown in FIG. 10B, the heating element and the vacuum system 1030 were separate elements of the setup 1020 and worked in concert to heat and apply vacuum to the sample holder 1000. In some implementations, a cooling element 1032 was included in the setup 1020 to further control the temperature of the environment in the sample holder 1000. The activation process facilitated removal, e.g., evaporation, of residual solvent medium in the pores of the functionalized silica and facilitated desorption of CO₂ molecules bonded during a synthesis process (e.g., process 300) for venting to the atmosphere.

For the adsorption procedure, samples of functionalized silica in a range between 0.5 g and 10 g were placed in between two layers of glass fiber filters 1004 in the testing sample holder 1000. Compressed environmental air (e.g., input air) from gas source 1022 were continuously fed through the testing sample holder 1000 at a rate 1 to 10 standard liters per minute (slpm), thereby exposing the activated functionalized silica. The activated functionalized silica was exposed for time periods 30 to 60 minutes. The humidity of the input air was controlled to be 15% to 50% RH at 21° C. The same sample holder was then brought to vacuum by vacuum system 1030 and heated by vacuum heater 1028 to extract the carbon dioxide from the sample.

The amount of carbon dioxide extracted was measured by gas analyzer 1026. The humidity was controlled through blending of “dry air” and “wet air” with a flow meter (not shown). As an example, to produce input air having 50% RH at a flow rate of 5 slpm, dry air (e.g., <10% RH) at 2.5 slpm and wet air (e.g., >95% RH, 100% RH) was blended at 2.5 slpm each. The dry air and wet air flow control was performed using a closed loop controller.

The compressed environmental air including CO₂ concentration was monitored by gas analyzers 1024 and 1026 at the input and output of the testing sample holder 1000 during the experimental time period in units of mol CO₂/kg of adsorbent.

### Example 3—Agglomeration Trials for Functionalized Material

Shown below in Tables 1 and 2 are two trials in which fine particles were agglomerated to a baseline silica to form recycled silica particles. The CO₂ uptake (mol/kg), attrition loss (wt %), crush strength (MPa), and/or bulk density (g/L) were determined.

A baseline raw silica product was used as a base for the agglomerated particles. The CO₂ uptake of the baseline raw silica was determined using methods described herein to determine a normalized uptake with which to compare the agglomerated samples.

The agglomerated samples were formed as described herein using the baseline silica. The agglomerated samples of Table 1 were agglomerated using dry roller compaction under a pressure according to the specific row, e.g., either 20 kilopounds per square inch (ksi) or 30 ksi. In the “Condition” column, the term “Milled” means the baseline material was less than 100 microns in size. The term “Non-milled” means the baseline material was up to 500 microns.

Attrition testing was performed on the agglomerated samples. Briefly, 100 g of each sample was placed in a sieve shaker using a 20 mesh screen. The samples were agitated in the shaker for 5 minutes using a tapper. 50 g of the plus 20 mesh product was placed on the mesh 20 screen. 50 pieces of 9.5 mm ceramic beads were added to the 20 mesh screen. The samples were agitated for 5 minutes without the tapper. The weight percentage of fines found in the base pan following the agitation with the ceramic beads was determined compared to the original sample.

Following agglomeration, the samples were coated with the functionalization mixture and tested for CO₂ uptake, both methods as described herein. Briefly, for the functionalization/coating process, 7.7 wt % of PEI and 36 wt % of aminopropyltrimethoxysilane (DAMO) in 160 wt % of water were added to 100 g of the silica substrate by dip coating in the polyethyleneimine (PEI)/DAMO/Water solution. After the dip coating, the samples were dried under vacuum at 70° C. for 24 hrs. The samples were tested with the method described in Examples 1 and 2 to determine the uptake performance.

TABLE 1

| | | | Uptake | |
|---|---|---|---|---|
| Trial 1 | Condition | Shape | (mol/kg) | Attrition |
| Baseline Silica | Not from agglomeration | Spherical granules | 1.2 | 8.7% |
| BT1 Run1 | Silica 150 A no-milled | Flat chips | 1.14 | 30.5% |
| | 20 ksi (70-200 um) | | | |
| BT1 Run2 | Silica 150 A milled 20 ksi | Flat chips | 0.67 | 6.9% |
| BT1 Run3 | Silica 150 A milled 30 ksi | Flat chips | 0.53 | 7.7% |
| BT1 Run4 | Silica F1 milled 20 ksi | Flat chips | 0.64 | 11.3% |

The agglomerated samples for Table 2 (below) were produced using a liquid binding mixture of PVA and water at varying wt % (PVA to water wt %) as a binder. The samples from Table 2 were agglomerated using a mixer with the liquid binding mixture.

The CO₂ uptake capacity and attrition were determined using the same method as for the samples for Table 1. The agglomerated particles for Table 2 were characterized for compression strength. The bulk compression strength test utilizes a test fixture that consists of a lower crush platform and upper crusher head. The lower crush platform included a flat surface onto which samples are placed. The upper crush head included a crush head with a flat lower surface substantially parallel with the plane of surface such that force was applied evenly to particles between the crush head and surface during force application. The crush head had an outer diameter (OD) 72.6 mm and the surface was 124.5 mm in diameter. The crush platform had a diameter 125.4 mm. In another example, the crush platform had a diameter of 146 mm.

During testing, a layer of particles, e.g., the sample, was packed closely on the crush platform and roughly aligned with the center of the crush head. The particle bed diameter was about 90 mm to about 2 mm in thickness. The samples were 3-6 g dry weight depending on particle coating components. The force applied to the crush head was recorded while displacement changed. The packed particle bed was crushed to achieve 50% of its compressive strain (e.g., displacement divided by initial sample bed thickness) and the stress (MPa) (e.g., force divided by contact area) is reported as 50% strain crush strength. Samples of uncoated, and coated particles were tested. For both types of particle, at least 3 samples were tested to get the average performance for the bulk compression strength.

The bulk density was measured according to ASTM D1895 Method A. Briefly, fine granules were poured through a V shaped funnel. The material being tested were allowed to flow into a cylinder cup with a known volume of 100 mL. Testing results were averaged using more than 4 measurements.

TABLE 2

| | | | | | Crush | Bulk |
|---|---|---|---|---|---|---|
| | | | Uptake | | Strength | Density |
| Trial 2 | Condition | Shape | (mol/kg) | Attrition | (MPa) | (g/L) |
| Baseline | Not from | Spherical | 1.2 | 12% | 1.14 | 260 |
| Silica | agglomeration | granules | | | | |
| BT1 | 7% PVA solution | | 1.35 | 5-7 wt % | 1.04 | 262 |
| Run1 | as binder | | | | | |
| BT1 | 10% PVA solution | | 1.3 | 5-7 wt % | 1.21 | 268 |
| Run2 | as binder | | | | | |
| BT1 | 3% PVA solution | | 1.35 | 5-7 wt % | 0.87 | 255 |
| Run3 | as binder | | | | | |

### Example 4—Experimental Results of Uncoated and Coated Functionalized Material

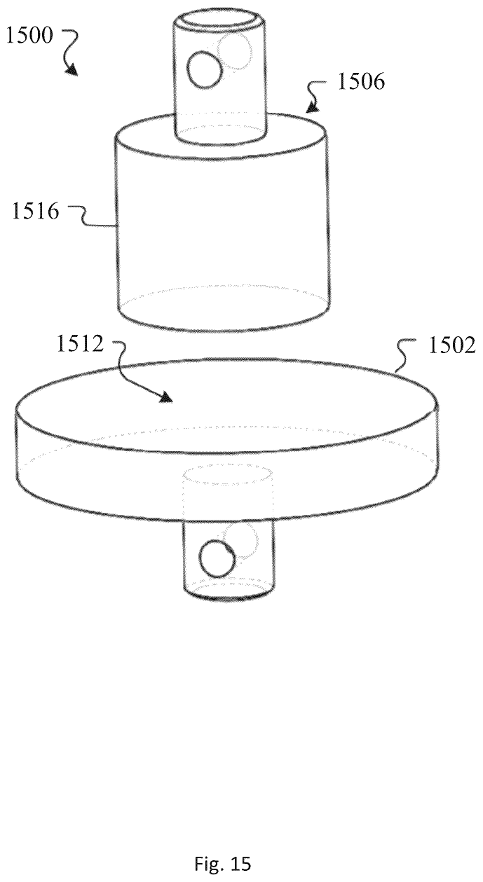

Functionalized, coated particles produced using the process 300 described herein were characterized for compression strength and attrition resistance. The bulk compression strength test utilized the test fixture 1500 shown in FIG. 15. The test fixture 1500 consisted of a lower crush platform 1502 and upper crusher head 1506. The lower crush platform 1502 included a flat surface 1512 onto which samples are placed. The upper crush head 1506 included a crush head 1516 with a flat lower surface substantially parallel with the plane of surface 1512 such that force was applied evenly to particles between the crush head 1516 and surface 1512 during force application. The crush head 1516 had an outer diameter (OD) 72.6 mm and the surface 1512 was 124.5 mm in diameter. The crush platform 1502 had a diameter 125.4 mm. In another example, the crush platform had a diameter of 146 mm.

During testing, a thin layer of particles, e.g., the sample, was packed closely on the crush platform 1502 and roughly aligned with the center of the crush head 1516. The particle bed diameter was 90 mm and about 2 mm in thickness. The samples were in a range from 3-6 g dry weight depending on particle coating components. The force applied to the crush head 906 was recorded while displacement changed. The packed particle bed was crushed to achieve 50% of its compressive strain (e.g., displacement divided by initial sample bed thickness) and the stress (MPa) (e.g., force divided by contact area) was reported as 50% strain crush strength. Samples of uncoated, and coated particles were tested. For both types of particle, at least 3 samples were tested to get the average performance for the bulk compression strength.

Table 3 presents the bulk compression strength for the samples. Compression strength is also known as ‘crush strength.’ Samples included no coating raw porous substrate, silica coated with amine only, and silica coated with various types of polymers. The particles of each sample had average radii in a range from 1 to 1.4 mm to ensure consistent particle size distribution.

TABLE 3
Bulk Compression Strength Results.

| | | 50% Strain | |
|---|---|---|---|
| | | Compressive | Normalized % |
| | Sample | Strength (MPa) | to Control |
| Control | No coating | 1.29 | 100% |
| 1 | Amine coating | 1.36 | 105% |
| 2 | Amine coating + | 2.09 | 162% |
| | 200K Mw PVA | | |
| 3 | Amine coating + | 2.05 | 159% |
| | 30-50K Mw PVA | | |
| 4 | Amine coating + | 1.73 | 134% |
| | 13-23K Mw PVA | | |
| 5 | Amine coating + | 1.40 | 108% |
| | cellulose acetate | | |
| 6 | Amine coating + | 1.59 | 123% |
| | PVP | | |
| 7 | Amine coating + | 1.77 | 137% |
| | PVA 99% | | |
| | Hydrolyzed | | |

PVA reinforcement (Sample 2) improved the crush strength by ˜162% (maximum) compared to baseline raw silica. Different molecular weight PVA resulted in different reinforcement effects. Lower molecular weight PVA (Sample 4) showed less reinforcement effect compared to Sample 2, e.g., the normalized improvement was about 134%. Other polymers such as cellulose acetate, PVP also provided a reinforcement effect. Cellulose acetate reinforcement (Sample 5) provided 108% reinforcement and PVP (Sample 7) provided 137% reinforcement. A bar chart of the compression strength results comparison is shown in FIG. 10.

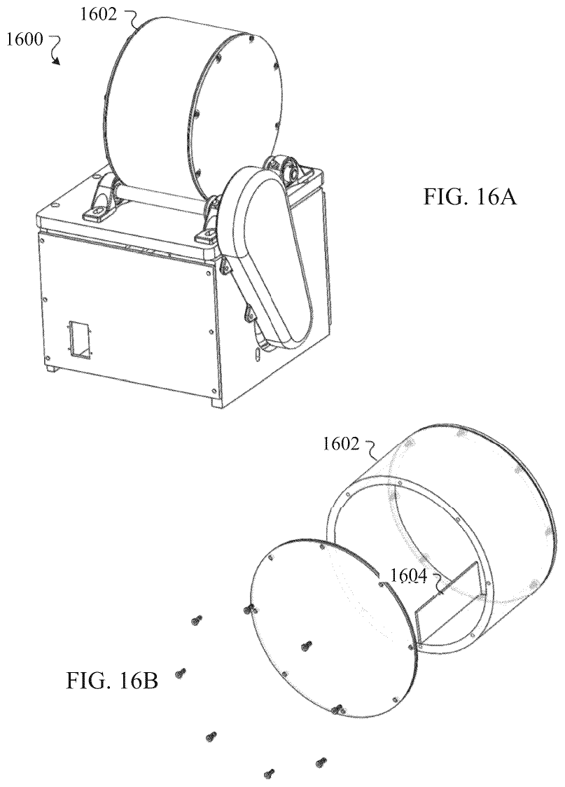

Attrition and abrasion resistance was determined according to the ASTM D4058-96 (Standard Test Method for Attrition and Abrasion of Catalysts and Catalyst Carriers) testing method. The testing fixture 1600 is shown in FIG. 16A and exploded diagram of the drum 1602 is shown in FIG. 16B. Samples of particles were placed inside the drum 1602 and the testing fixture 1600 rotated the drum 1602 for a 30 minute cycle. The particles within the drum 1602 interacted with a baffle 1604 that caused attrition loss. As the particles are tumbled, attrition occurred. The sample of particles were removed and the particles sieved to determine loss to attrition. Attrition is the process of breaking down, therefore “loss to attrition” refers to the amount of particles that have broken down to a standard definition. In the process described herein, particles broken down to <0.5 mm are no longer useful and will be collected, e.g., filtered, and discarded and would be defined as “lost to attrition.” Table 4 shows the results.

TABLE 4
Attrition Loss Results

| | | | Reduction in generated fines | |
|---|---|---|---|---|
| | | | (%) | |
| Single cycle | particle | particle | particle | particle |
| attrition | size | size | size | size |
| (% loss) | >0.71 mm | >0.1 mm | >0.71 mm | >0.1 mm |
| Raw silica | 1.65% | 1.33% | — | — |
| PVA coated | 0.91% | 0.89% | 45% | 33% |
| silica test 1 | | | | |
| PVA coated | 1.05% | 1.04% | 36% | 22% |
| silica test 2 | | | | |
| PVA and amine | 0.93% | 0.93% | 44% | 30% |
| coated silica | | | | |

As shown in Table 4, particles including the polymer reinforcement coating had improvement on the attrition loss resistance of between 36%-45% for particle size <0.71 mm.

### Example 5—Example Functionalization Mixture (Second Reagent

In one non-limiting embodiment, creating the functionalization mixture includes introducing a second reagent including the polyamine polyethyleneimine (PEI) and a third reagent comprising the aminosilane aminopropyltrimethoxysilane (DAMO) having the structure:

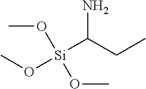

into a volume of the second solvent ethanol to form the functionalization mixture. A total of 45 g of aminopropyltrimethoxysilane (DAMO) and 10 g of polyethyleneimine PEI were charged into a 500 mL beaker and stirred till a homogenous mixture was obtained. 190 mL ethanol was charged into the DAMO-PEI mixture and stirred till a homogeneous mixture was obtained. The PEI-DAMO-ethanol solution was decanted over 100 grams of porous silica particles in a 500 mL beaker. The beaker was placed in a vacuum oven at 80° C. and 50 mbar for 12 hours till a dry product (coated particles) was obtained.

### Example 6—First Procedure for Adding Chelator

Slowly, 15 g of 13-23K Mw polyvinyl alcohol (PVA), the polymer, was charged into 60 mL of rapidly stirring cold water in a 500 mL flask with a condenser. The mixture was heated to 70-80° C. and stirred till a homogeneous solution was obtained, approximately 30 minutes. The solution was cooled to 60-70° C. under constant stirring. Slowly, 140 mL of hot ethanol (˜60° C.) was charged into the flask and mixed thoroughly till a uniform solution was obtained. 1.67 g of 60% etidronic acid (ETDA) solution (chelator) was charged into the warm solution (50-60° C.) and mixed thoroughly till a uniform solution was obtained. The warm PVA-ETDA-ethanol-water solution was decanted over 100 g of porous silica particles (silica) in a 1 L rotary evaporation flask with mixing. The flask was placed on the rotary evaporator and set to 20 rotations per minute (rpm) till the mixture was observed to be homogenous with no dry particles (coated particles). Once a uniform mixture was obtained the rotary evaporator was set to 70° C., 50 mbar, and 10 rpm. The mixture was dried till the sorbent (coated particles) contained 20-30 wt % volatiles as measured by a Mettler Toledo Halogen Moisture Analyzer HE73.

### Example 7—Second Procedure for Adding Chelator

Slowly, 15 g of 13-23K Mw polyvinyl alcohol (PVA), the polymer, was charged into 200 mL of rapidly stirring cold water in a 500 mL flask with a condenser. The mixture was heated to 70-80° C. and stirred till a homogeneous solution was obtained, approximately 30 minutes. The solution was cooled to 60-70° C. under constant stirring. 1 g of tripotassium phosphate (chelator; K₃PO₄) was charged into the warm solution (50-60° C.) and mixed thoroughly till a uniform solution was obtained. The warm PVA-K₃PO₄— water solution was decanted over 100 g of porous silica particles (silica) in a 1 L rotary evaporation flask with mixing. The flask was placed on the rotary evaporator and set to 20 rpm till the mixture was observed to be homogenous with no dry particles (coated particles). Once a uniform mixture was obtained the rotary evaporator was set to 70° C., 50 mbar, and 10 rpm. The mixture was dried till the sorbent (coated particles) contained 20-30 wt % volatiles as measured by a Mettler Toledo Halogen Moisture Analyzer HE73.

### Example 8—Third Procedure for Adding Chelator

Slowly, 15 g of 13-23K Mw polyvinyl alcohol (PVA), the polymer, was charged into 200 mL of rapidly stirring cold water in a 500 mL flask with a condenser. The mixture was heated to 70-80° C. and stirred till a homogeneous solution was obtained, approximately 30 minutes. The solution was cooled to 60-70° C. under constant stirring. 2.5 g of Trilon D (a 40% aqueous solution of trisodium salt of hydroxyethylenediaminetriacetic acid (HEDTA-Na₃)) (chelator) having the chemical formula:

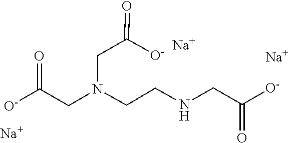 [SMILES: [Na+] ; O=C([O-])CNCCN(CC(=O)[O-])CC(=O)[O-] ; [Na+] ; [Na+]]

was charged into the warm solution (50-60° C.) and mixed thoroughly till a uniform solution was obtained. The warm PVA-Trilon D—water solution was decanted over 100 g of porous silica particles (silica) in a 1 L rotary evaporation flask with mixing. The flask was placed on the rotary evaporator and set to 20 rpm till the mixture was observed to be homogenous with no dry particles (coated particles). Once a uniform mixture was obtained the rotary evaporator was set to 70° C., 50 mbar, and 10 rpm. The mixture was dried till the sorbent (coated particles) contained 20-30 wt % volatiles as measured by a Mettler Toledo Halogen Moisture Analyzer HE73.

### Example 9—Fourth Procedure for Adding Chelator

Slowly, 15 g of 13-23K Mw polyvinyl alcohol (PVA), the polymer, was charged into 200 mL of rapidly stirring cold water in a 500 mL flask with a condenser. The mixture was heated to 70-80° C. and stirred till a homogeneous solution was obtained, approximately 30 minutes. The solution was cooled to 60-70° C. under constant stirring. 1 g of Trilon B powder (a tetrasodium salt of ethylenediaminetetraacetic acid (Na₄EDTA)) (chelator) having the chemical formula:

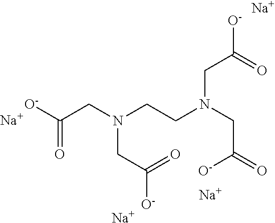 [SMILES: [Na+] ; [Na+] ; O=C([O-])CN(CCN(CC(=O)[O-])CC(=O)[O-])CC(=O)[O-] ; [Na+] ; [Na+]]

was charged into the warm solution (50-60° C.) and mixed thoroughly till a uniform solution was obtained. The warm PVA-Trilon B—water solution was decanted over 100 g of porous silica particles (silica) in a 1 L rotary evaporation flask with mixing. The flask was placed on the rotary evaporator and set to 20 rpm till the mixture was observed to be homogenous with no dry particles (coated particles). Once a uniform mixture was obtained the rotary evaporator was set to 70° C., 50 mbar, and 10 rpm. The mixture was dried till the sorbent (coated particles) contained 20-30 wt % volatiles as measured by a Mettler Toledo Halogen Moisture Analyzer HE73.

### Example 10—Fifth Procedure for Adding Chelator

Slowly, 15 g of 13-23K Mw polyvinyl alcohol (PVA), the polymer, was charged into 200 mL of rapidly stirring cold water in a 500 mL flask with a condenser. The mixture was heated to 70-80° C. and stirred till a homogeneous solution was obtained, approximately 30 minutes. The solution was cooled to 60-70° C. under constant stirring. 2.5 g of Trilon M liquid (trisodium salt of methylglycinediacetic acid (MGDA)) (chelator) was charged into the warm solution (50-60° C.) and mixed thoroughly till a uniform solution was obtained. The warm PVA-Trilon B—water solution was decanted over 100 g of porous silica particles (silica) in a 1 L rotary evaporation flask with mixing. The flask was placed on the rotary evaporator and set to 20 rpm till the mixture was observed to be homogenous with no dry particles (coated particles). Once a uniform mixture was obtained the rotary evaporator was set to 70° C., 50 mbar, and 10 rpm. The mixture was dried till the sorbent (coated particles) contained 20-30 wt % volatiles as measured by a Mettler Toledo Halogen Moisture Analyzer HE73.

### Example 11—First Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD), having the chemical structure:

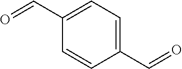

was charged into a 250 mL beaker followed by 141 mL of hexane and 19 mL of IPA. 1 g of the antioxidant Chimassorb 944 FDL (C944) (Poly[[6-[(1,1,3,3-tetramethylbutyl)amino]-1,3,5-triazine-2,4-diyl][imino(2,2,6,6-tetramethyl-4-piperidinyl)]-1,6-hexanediylimino(2,2,6,6-tetramethyl-4-piperidinyl)]]; BASF, Ludwigshafen am Rhein, 67056 Germany) was charged into the same 250 mL beaker and mixed till a uniform solution was obtained. TALD-C944-hexane-IPA was warmed to 60° C. with mixing till a uniform solution was obtained.

The DAMO-PEI-IPA solution was warmed to 40° C. with mixing.

The warm TALD-C944-hexane-IPA solution was charged into the 500 mL beaker of DAMO-PEI-IPA. The temperature was maintained at 60° C. and mixed till a homogeneous solution was obtained.

The warm PEI-DAMO-TALD-C944-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 12—Second Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant octadecyl-[3-(3,5-di-tert-butyl-4-hydroxyphenyl)propionate](IUPAC: octadecyl-[3-(3,5-di-tert-butyl-4-hydroxyphenyl)propionate]; Irganox 1076; 11076; BASF, Ludwigshafen am Rhein, 67056 Germany) was charged into the same 250 mL beaker and mixed till a uniform solution was obtained. TALD-I1076-hexane-IPA was warmed to 60° C. with mixing till a uniform solution was obtained.

The DAMO-PEI-IPA solution was warmed to 40° C. with mixing.

The warm TALD-I1076-hexane-IPA solution was charged into the 500 mL beaker of DAMO-PEI-IPA. The temperature was maintained at 60° C. and mixed till a homogeneous solution was obtained.

The warm PEI-DAMO-TALD-I1076-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 13—Third Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant pentaerythritol tetrakis(3-(3,5-di-tert-butyl-4-hydroxyphenyl)propionate (Irganox 1010; 11010; BASF, Ludwigshafen am Rhein, 67056 Germany) having the chemical structure:

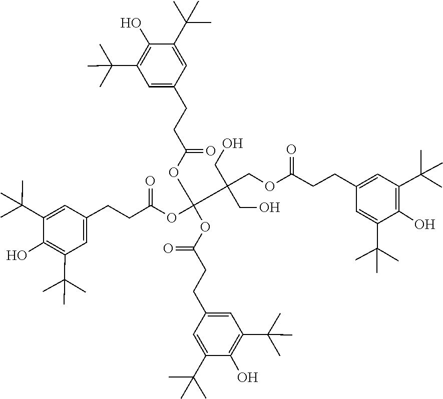 [SMILES: CC(C)(C)c1cc(CCC(=O)OCC(CO)(CO)C(OC(=O)CCc2cc(C(C)(C)C)c(O)c(C(C)(C)C)c2)(OC(=O)CCc2cc(C(C)(C)C)c(O)c(C(C)(C)C)c2)OC(=O)CCc2cc(C(C)(C)C)c(O)c(C(C)(C)C)c2)cc(C(C)(C)C)c1O]

was charged into the same 250 mL beaker and mixed till a uniform solution was obtained. TALD-I1010-hexane-IPA was warmed to 60° C. with mixing till a uniform solution was obtained.

The DAMO-PEI-IPA solution was warmed to 40° C. with mixing.

The warm TALD-I1010-hexane-IPA solution was charged into the 500 mL beaker of DAMO-PEI-IPA. The temperature was maintained at 60° C. and mixed till a homogeneous solution was obtained.

The warm PEI-DAMO-TALD-I1010-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 14—Fourth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of antioxidant that includes 2,2,6,6-tetramethylpiperidine units (TINUVIN 622 SF (T622); BASF SE, Ludwigshafen, Germany) was charged into the same 250 mL beaker and mixed till a uniform solution was obtained. TALD-T622-hexane-IPA was warmed to 60° C. with mixing till a uniform solution was obtained.

The DAMO-PEI-IPA solution was warmed to 40° C. with mixing.

The warm TALD-T622-hexane-IPA solution was charged into the 500 mL beaker of DAMO-PEI-IPA. The temperature was maintained at 60° C. and mixed till a homogeneous solution was obtained.

The warm PEI-DAMO-TALD-T622-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 15—Fifth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of 2-Methyl-4,6-[(octylthio)methyl]phenol (RIANOX 1520, (R1520); CAS No.: [110553-27-0], Rianlon Corporation, Tianjin, China) having the chemical structure:

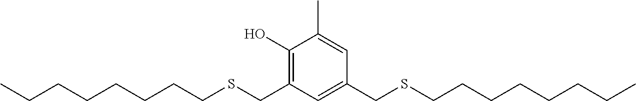 [SMILES: CCCCCCCCSCc1cc(C)c(O)c(CSCCCCCCCC)c1]

was charged into the same 250 m beaker an mixed till a uniform solution was obtained. TALD-R1520-hexane-IPA was warmed to 60° C. with mixing till a uniform solution was obtained.

The DAMO-PEI-IPA solution was warmed to 40° C. with mixing.

The warm TALD-R1520-hexane-IPA solution was charged into the 500 mL beaker of DAMO-PEI-IPA. The temperature was maintained at 60° C. and mixed till a homogeneous solution was obtained.

The warm PEI-DAMO-TALD-R1520-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 16—Sixth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of benzenamine,N-phenyl-,reaction products with 2,4,4-trimethylpenten (RIANOX 5057, (R5057); CAS No.: [68411-46-1], Rianlon Corporation, Tianjin, China) was charged into the same 250 mL beaker and mixed till a uniform solution was obtained. TALD-R5057-hexane-IPA was warmed to 60° C. with mixing till a uniform solution was obtained.

The DAMO-PEI-IPA solution was warmed to 40° C. with mixing.

The warm TALD-R5057-hexane-IPA solution was charged into the 500 mL beaker of DAMO-PEI-IPA. The temperature was maintained at 60° C. and mixed till a homogeneous solution was obtained.

The warm PEI-DAMO-TALD-R5057-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 17—Seventh Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant 2,2-thiodiethylene bis[3-(3,5-di-tert-butyl-4-hydroxyphenyl)propionate](RIANOX 1035, (R1035); CAS No.: [41484-35-9], Rianlon Corporation, Tianjin, China) was charged into the same 250 mL beaker and mixed till a uniform solution was obtained. TALD-R1035-hexane-IPA was warmed to 60° C. with mixing till a uniform solution was obtained.

The DAMO-PEI-IPA solution was warmed to 40° C. with mixing.

The warm TALD-R1035-hexane-IPA solution was charged into the 500 mL beaker of DAMO-PEI-IPA. The temperature was maintained at 60° C. and mixed till a homogeneous solution was obtained.

The warm PEI-DAMO-TALD-R1035-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 18—Eighth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant bis(2,4-di-t-butylphenyl)pentaerythritol diphosphite (RIANOX 626, (R626); CAS No.: [26741-53-7], Rianlon Corporation, Tianjin, China) was charged into the same 250 mL beaker and mixed till a uniform solution was obtained. TALD-R626-hexane-IPA was warmed to 60° C. with mixing till a uniform solution was obtained.

The DAMO-PEI-IPA solution was warmed to 40° C. with mixing.

The warm TALD-R626-hexane-IPA solution was charged into the 500 mL beaker of DAMO-PEI-IPA. The temperature was maintained at 60° C. and mixed till a homogeneous solution was obtained.

The warm PEI-DAMO-TALD-R626-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 19—Ninth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant dilauryl 3,3′-thiodipropionate (RIANOX DLTP, (R-DLTP); CAS No.: [123-28-4], Rianlon Corporation, Tianjin, China) was charged into the same 250 mL beaker and mixed till a uniform solution was obtained. TALD-R-DLTP-hexane-IPA was warmed to 60° C. with mixing till a uniform solution was obtained.

The DAMO-PEI-IPA solution was warmed to 40° C. with mixing.

The warm TALD-R-DLTP-hexane-IPA solution was charged into the 500 mL beaker of DAMO-PEI-IPA. The temperature was maintained at 60° C. and mixed till a homogeneous solution was obtained.

The warm PEI-DAMO-TALD-R-DLTP-hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 20—Tenth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant pentaerythrityl tetrakis (3-laurylthiopropionate) (RIANOX 412S, (R412S); CAS No.: [29598-76-3], Rianlon Corporation, Tianjin, China) was charged into the same 250 mL beaker and mixed till a uniform solution was obtained. TALD-R412S-hexane-IPA was warmed to 60° C. with mixing till a uniform solution was obtained.

The DAMO-PEI-IPA solution was warmed to 40° C. with mixing.

The warm TALD-R412S-hexane-IPA solution was charged into the 500 mL beaker of DAMO-PEI-IPA. The temperature was maintained at 60° C. and mixed till a homogeneous solution was obtained.

The warm PEI-DAMO-TALD-R412S-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 21—Eleventh Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 1 g of the antioxidant RIANOX UV-791, ((RUV791), Rianlon Corporation, Tianjin, China) was charged into the same 250 mL beaker and mixed till a uniform solution was obtained. TALD-RUV791-hexane-IPA was warmed to 60° C. with mixing till a uniform solution was obtained.

The DAMO-PEI-IPA solution was warmed to 40° C. with mixing.

The warm TALD-RUV791-hexane-IPA solution was charged into the 500 mL beaker of DAMO-PEI-IPA. The temperature was maintained at 60° C. and mixed till a homogeneous solution was obtained.

The warm PEI-DAMO-TALD-RUV791-Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 22—Twelfth Procedure for Adding Antioxidant

The PVA-ETDA-coated silica product (141 g) made in accordance with Example 5 was left in the 1 L rotary evaporator flask.

10 g of polyethyleneimine (PEI) and 45 g of aminosilane aminopropyltrimethoxysilane (DAMO) was charged into a 500 mL beaker followed by 10 mL isopropyl alcohol (IPA). The PEI, DAMO, and IPA were mixed till a uniform solution was obtained.

1.1 g of the linking moiety terephthalaldehyde (TALD) was charged into a 250 mL beaker followed by 141 mL of hexane and 19 mL of IPA. 0.5 g of CeO₂ nanoparticles, serving as the antioxidant was charged into the same 250 mL beaker and mixed till a uniform solution was obtained. TALD-CeO₂-hexane-IPA was warmed to 60° C. with mixing till a uniform solution was obtained.

The DAMO-PEI-IPA solution was warmed to 40° C. with mixing.

The warm TALD-CeO₂-hexane-IPA solution was charged into the 500 mL beaker of DAMO-PEI-IPA. The temperature was maintained at 60° C. and mixed till a homogeneous solution was obtained.

The warm PEI-DAMO-TALD-CeO₂—Hexane-IPA solution was decanted over the 141 g of PVA-ETDA-coated silica product from Example 5 in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 23—Two-Step Procedure for Sorbent Formation

This example provides a method comprising A) forming a plurality of coated particles by introducing a plurality of porous particles to a first reagent comprising a polymer. The method further comprises B) forming a plurality of functionalized coated particles by introducing a second reagent comprising at least one adsorbing moiety to at least a portion of a surface of each coated particle in at least a subset of the plurality of coated particles. The forming B) is in the presence of a third reagent comprising at least one interaction moiety that is incorporated into the plurality of functionalized coated particles. The forming B) is in the presence of a crosslinker that is incorporated into the plurality of functionalized coated particles.

In this example the plurality of porous particles were silica particles.

In this example the polymer in the first reagent was 13K-23K MW polyvinylalcohol (PVA).

In this example the at least one adsorbing moiety of the second reagent was the polyamine poly(ethyleneimine) (PEI).

In this example the at least one interaction moiety of the third reagent was the aminosilane aminopropyltrimethoxysilane (DAMO).

In this example the crosslinker was the dialdehyde terephthalaldehyde (TALD).

### Step 1 for a 100 g Batch of Coated Particles.

Formation of first reagent. Slowly, 15 g of 13-23K Mw PVA was charged into 60 mL of rapidly stirring cold water in a 500 mL flask with a condenser. The mixture was heated to 70-80° C. and stirred till a homogeneous solution was obtained, approx 30 minutes. The solution was cooled to 60-70° C. under constant stirring. Slowly, 140 mL of hot ethanol (˜60° C.) was charged into the flask and mixed thoroughly till a uniform solution was obtained.

Forming a plurality of coated particles by introducing a plurality of porous particles to a first reagent comprising a polymer. The warm PVA-ethanol-water solution was decanted over 100 g of silica in a 1 L rotary evaporation flask with mixing. The flask was placed on the rotary evaporator and set to 20 rotations per minute (rpm) till the mixture was observed to be homogenous with no dry particles. Once a uniform mixture was obtained the rotary evaporator was set to 70° C., 50 mbar, and 10 rpm. The mixture was dried till the sorbent (plurality of coated particles) contained 20-30 wt % volatiles as measured by a Mettler Toledo Halogen Moisture Analyzer HE73.

### Step 2 for a 100 g (Starting Silica) Batch.

The plurality of coated particles. The PVA-coated silica product from the first step (141 g) was left in the 1 L rotary evaporator flask.

Form the second and third reagent. 10 g of the polyamine poly(ethyleneimine) (PEI) (second reagent and 45 g of the aminosilane aminopropyltrimethoxysilane (DAMO) (third reagent) was charged into a 500 mL beaker followed by 10 mL isopropyl alcohol (IPA). The PEI, DAMO, and IPA were mixed till a uniform DAMO-PEI-IPA solution was obtained.

1.1 g of the crosslinker terephthalaldehyde (TALD) was charged into a 250 mL beaker followed by 141 mL of hexane and 19 mL of IPA. TALD-hexane-IPA was warmed to 60° C. with mixing till a uniform solution was obtained.

The DAMO-PEI-IPA solution (second and third reagents) was warmed to 40° C. with mixing. The warm TALD-hexane-IPA solution (crosslinker) was charged into the 500 mL beaker of DAMO-PEI-IPA. The temperature was maintained at 60° C. and mixed till a homogeneous solution was obtained.

Forming a plurality of functionalized coated particles by introducing the second reagent comprising at least one adsorbing moiety (PEI) to at least a portion of a surface of each coated particle in at least a subset of the plurality of coated particles in the presence of crosslinker (TALD. The warm PEI-DAMO-TALD-Hexane-IPA solution was decanted over the 140 g of PVA-coated silica product from step 1 (plurality of coated particles) in the 1 L rotary evaporation flask with mixing. The flask was placed on the rotary evaporator and spun at 20 rpm till the mixture was observed to be uniform. Once a uniform mixture was obtained, the rotary evaporator was set to 70° C., 50 mbar, and 10 rpm. The mixture was dried till the sorbent contained <5 wt % volatiles as measured by a Mettler Toledo Halogen Moisture Analyzer HE73.

### Example 24—Characterization of Lifetime Improvement

To characterize the lifetime improvement from various treatments, two different testing method types were used.

Cyclic testing methods test the sample with a real adsorption/desorption process on a breakthrough instrument to see the CO₂ uptake changing with the number of testing cycles and also runs a linear curve fit to get the slope of the degradation curve against larger than 100 cycles.

Uptake is measured with a breakthrough instrument. The sorbent is packed in a packed bed with thickness ˜3 mm. Compressed environment air is fed through the sorbent in a constant flow rate. The CO₂ concentration in the air feed in the sorbent and flow out of the sorbent is measured with an infrared CO₂ measuring device. Enough run time is given to allow the sorbent to be fully saturated. The uptake is calculated based on the breakthrough measurement.

Cyclic testing cognition: Approximately 1 g of the sorbent is put on the breakthrough tester. One hundred continuous cycles of testing with 40 minutes adsorption and 30 minutes desorption is run. The adsorption condition is as described in above uptake measurement that feeds compressed air through the sample till saturation. Desorption condition is heating the sample to elevated temperature such as 70° C. or above and meanwhile pulling vacuum on the sample to vacuum level below 0.3 psi.

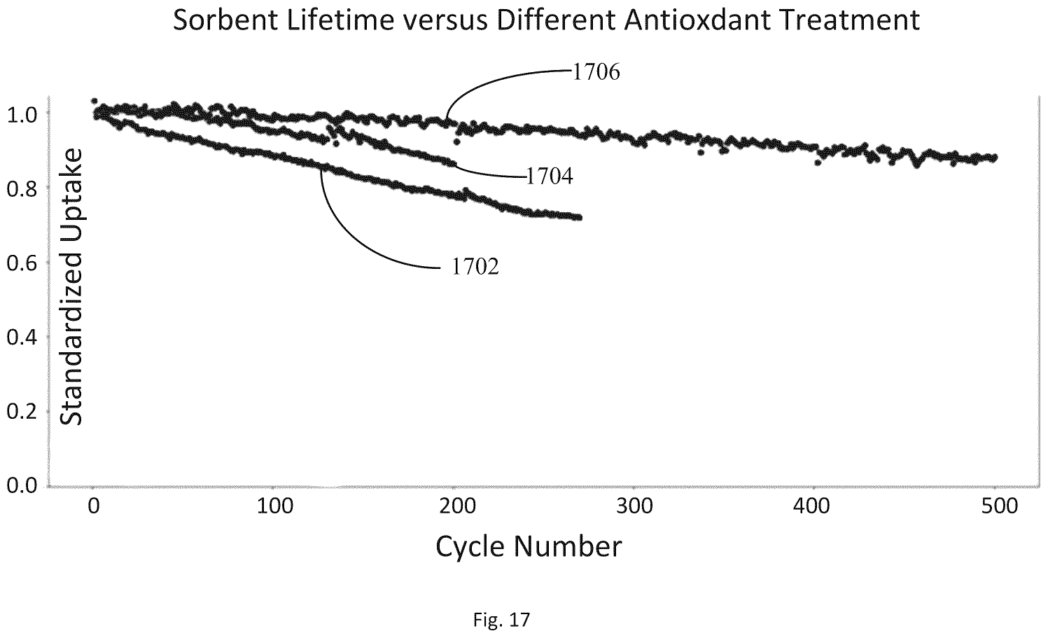

FIG. 17 illustrates the cyclic testing result that compares basic sorbent without additives, sorbent with PVA as an oxygen barrier and sorbent with PVA+chelator+antioxidant. Curve 1702 is the degradation curve for a sorbent without chelator, antioxidant, or PVA. Curve 1704 is the degradation curve for a sorbent without chelator, antioxidant but with PVA only. Curve 1706 is the degradation curve for a sorbent with chelator, antioxidant C944 (Example 11) and PVA. Both curve 1704 and curve 1706 show degradation slowdown due to the antioxidant treatment.

Table 5 below shows the curve fit slope for various sorbents. It is clear that sorbent without any additives has a more steep slope (−12.2) compared to the rest of the sorbent with various antioxidant treatments (PVA only, chelator only or PVA+chelator+antioxidant).

TABLE 5

| | Degradation curve fit |
|---|---|
| Sample type | slope X (E-04) |
| Sorbent without chelator, antioxidant, PVA | −12.20 |
| Sorbent with PVA | −6.70 |
| Sorbent with PVA + crosslinker | −6.20 |
| Sorbent with Chelator K₃PO₄ | −1.60 |
| Sorbent with chelator K₃PO₄ + PVA + | −1.60 |
| antioxidant (C944) + crosslinker | |

Chamber aging treatment at 88° C., 20% relative humidity (RH), for 40 hours constitutes accelerated lifetime testing. Sample uptake was measured before and after such chamber aging treatment to see the drop of uptake upon aging.

In the Table 6 below, sorbent without PVA, chelator and antioxidant loses ˜80% of its performance after 40 hours of chamber aging treatment at 88° C., 20% RH. The rest of the samples with various types of antioxidants all lose about 45-60% of their performance at the same treatment. Thus, those antioxidants effectively improve the oxidation resistance.

TABLE 6

| | Initial uptake | After aging | Performance |
|---|---|---|---|
| 88° C.; 20RH %; 40 hours Chamber Aging Study | (mol/kg) | uptake (mol/kg) | Drop % |
| Sorbent without PVA, chelator and antioxidant | 1.25 | 0.26 | 79.20% |
| Sorbent + PVA + ETDA + Chimassorb 944 | 0.95 | 0.38 | 60.00% |
| Sorbent + PVA + ETDA + Rainox_412S | 1.01 | 0.46 | 54.46% |
| Sorbent + PVA + ETDA + Rainox DLTP | 1.02 | 0.56 | 45.10% |
| Sorbent + PVA + ETDA + Rainox 626 | 1.07 | 0.46 | 57.01% |
| Sorbent + PVA + ETDA + CeO₂ | 0.98 | 0.52 | 46.94% |

### CONCLUSION

Embodiments of the subject matter and the operations described in this specification (e.g., for any system herein, such as a DAC system, a fluidized bed reactor, a silo adsorber, a gravity fed desorption system, as well as combinations and subcombinations thereof) can be implemented, in part, by digital electronic circuitry, or in computer software, firmware, or hardware, including the structures disclosed in this specification and their structural equivalents, or in combinations of one or more of them, in additional to the structures described herein.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing.

The separation of various system modules and components in the embodiments described herein (e.g., for any system herein) should not be understood as requiring such separation in all embodiments, and it should be understood that the described program components and systems can generally be integrated together in a single software product or packaged into multiple software products. In certain circumstances, multitasking and parallel processing may be advantageous.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of implementations have been described. Nevertheless, it will be understood that various modifications may be made without departing from the spirit and scope of the invention. Accordingly, other implementations are within the scope of the following claims.

1. A method, comprising:
A) forming a plurality of coated particles by introducing a plurality of porous particles to a first reagent comprising a polymer; and
B) forming a plurality of functionalized coated particles by introducing a second reagent comprising at least one adsorbing moiety to at least a portion of a surface of each coated particle in at least a subset of the plurality of coated particles, wherein
the forming A) is in the presence of a chelating agent,
the forming B) is in the presence of an antioxidant that is incorporated into the plurality of functionalized coated particles, or
the forming B) is in the presence of a crosslinker that is incorporated into the plurality of functionalized coated particles.

2. (canceled)

3. A method, comprising:
A) forming a plurality of functionalized particles by introducing a plurality of porous particles to a second reagent comprising at least one adsorbing moiety to at least a portion of a surface of each porous particle in at least a subset of the plurality of coated particles; and
B) forming a plurality of functionalized coated particles by introducing a first reagent comprising a polymer to at least a portion of a surface of each functionalized particle in at least a subset of the plurality of functionalized particles, wherein
the forming B) is in the presence of a chelating agent,
the forming A) is in the presence of an antioxidant that is incorporated into the plurality of functionalized particles, or
the forming A) is in the presence of a crosslinker that is incorporated into the plurality of functionalized particles.

4. The method of claim 3, wherein the forming A) is in the presence of a third reagent comprising at least one interaction moiety that is incorporated into the plurality of functionalized particles.

5. The method of claim 3, wherein the at least one adsorbing moiety is a polyamine.

6. The method of claim 4, wherein the interaction moiety is an aminosilane or a silane.

7. (canceled)

8. The method of claim 3, wherein
the forming B) is in the presence of the chelating agent,
the chelating agent is introduced at a ratio in a range of up to 5% (wt/wt) of the chelating agent to the plurality of functionalized particles.

9.-12. (canceled)

13. The method of claim 3, wherein
the forming A) is in the presence of an antioxidant that is incorporated into the plurality of functionalized particles, and
the antioxidant is introduced at a ratio in a range of up to 5% (wt/wt) of the antioxidant to the plurality of porous particles.

14. (canceled)

15. The method of claim 3, wherein
the forming A) is in the presence of an antioxidant that is incorporated into the plurality of functionalized particles, and
the antioxidant is a cyclic antioxidant.

16. (canceled)

17. The method of claim 3, wherein
the forming A) is in the presence of an antioxidant that is incorporated into the plurality of functionalized particles, and
the antioxidant is a hindered amine light stabilizer.

18. (canceled)

19. The method of claim 3, wherein
the forming A) is in the presence of an antioxidant that is incorporated into the plurality of functionalized particles, and
the antioxidant is selected from the group consisting of 2,2-thiodiethanol, 2-hydroxyethyl disulfide, 3,3′-dithiodipropionic acid, poly[[6-[(1,1,3,3-tetramethylbutyl)amino]-1,3,5-triazine-2,4-diyl][imino(2,2,6,6-tetramethyl-4-piperidinyl)]-1,6-hexanediylimino(2,2,6,6-tetramethyl-4-piperidinyl) (Chimassorb 944 FDL (C944)), octadecyl-[3-(3,5-di-tert-butyl-4-hydroxyphenyl)propionate (Irganox 1076), tetrakis(3-(3,5-di-tert-butyl-4-hydroxyphenyl)propionate (Irganox 1010), 2,2,6,6-tetramethylpiperidine (TINUVIN 622 SF), 2-Methyl-4,6-[(octylthio)methyl]phenol (RIANOX 1520), 2,2-Thiodiethylene Bis[3-(3,5-di-tert-butyl-4-hydroxyphenyl)propionate](RIANOX 1035), bis(2,4-di-t-butylphenyl)pentaerythritol diphosphite (RIANOX 626), dilauryl 3,3′-thiodipropionate (R-DLTP), pentaerythrityl tetrakis (3-laurylthiopropionate) (R412S), and CeO₂ nanoparticles.

20. (canceled)

21. The method of claim 3, further comprising, before forming the plurality of functionalized coated particles, drying the plurality of functionalized particles in a vacuum oven at between 50° C. and 100° C. until a hydration threshold is reached, wherein the hydration threshold is less than 5% (wt/wt) of water to the plurality of coated particles.

22.-24. (canceled)

25. The method of claim 3, further comprising, before introducing the second reagent, raising a temperature of the plurality of porous particles to at least 300° C. for at least one hour.

26. The method of claim 3, wherein the first reagent comprises poly(vinyl alcohol).

27. The method of claim 3, wherein the plurality of porous particles is in a solvent at a ratio of between 1.5 wt/wt and 4:1 wt/wt of the solvent to the plurality of porous particles prior to or during the forming A).

28.-30. (canceled)

31. The method of claim 3, wherein the first reagent further comprises a first solvent at a ratio in a range between 10% (wt/wt) and 25% (wt/wt) of the first reagent to the plurality of functionalized particles.

32. (canceled)

33. The method of claim 4, wherein the third reagent further comprises a second solvent at a ratio that is between 20% and 80% (wt/wt) of the third reagent to the plurality of porous particles.

34. The method of claim 4, wherein the interaction moiety of the third reagent is an aminosilane or a silane.

35.-46. (canceled)

47. A composition comprising a plurality of functionalized, coated particles modified according to the method of claim 3.

48.-56. (canceled)

57. The composition of claim 47, wherein the plurality of porous particles have (i) a distribution of pore sizes from 10 nanometers to 200 nanometers and (ii) a distribution of sieve diameters from 0.4 millimeters to 4 millimeters, or wherein the plurality of porous particles have (i) a distribution of pore sizes from 50 Angstroms to 300 Angstroms and (ii) a distribution of sieve diameters from 0.4 millimeters to 4 millimeters.

58. (canceled)

59. A method, comprising using the composition of claim 47 to remove atmospheric CO₂ from air by direct air capture.

60.-88. (canceled)
